(19) United States
(12) Patent Application Publication
(10) Pub. No.: US 2024/0140970 A1
(43) Pub. Date: May 2, 2024

(54) A DEUTERATED COMPOUND, AND PREPARATION METHOD AND USE THEREOF

(71) Applicant: ASCENTAWITS PHARMACEUTICALS, LTD., Shenzhen (CN)

(72) Inventors: Meizhen Ruan, Shenzhen (CN); Xiaohong Cai, Shenzhen (CN); Jianxin Duan, Shenzhen (CN); Donald T Jung, Cupertino, CA (US); Anrong Li, Shenzhen (CN); Teng Meng, Shenzhen (CN); Lin Sun, Shenzhen (CN); Bing Li, Shenzhen (CN)

(21) Appl. No.: 18/003,402

(22) PCT Filed: Nov. 26, 2021
(86) PCT No.: PCT/CN2021/133645

§ 371 Date: Dec. 27, 2022

(30) Foreign Application Priority Data
Nov. 12, 2021 (CN) 202111346190.9

(51) Int. Cl. C07F 9/564; B01D 15/16; B01D 15/42; C07B 59/00; G01N 30/06; G01N 30/16; G01N 30/72

(52) U.S. Cl. CPC C07F 9/564; B01D 15/166; B01D 15/426; C07B 59/002; G01N 30/06; G01N 30/16; G01N 30/7233; C07B 2200/05; G01N 2030/027

(57) ABSTRACT

Described is a deuterated compound, and preparation method and use thereof The deuterated compound I has a structure as shown in Formula (I), wherein A is H or D, and at least one of eight As is D; M is H or an alkali metal, an alkaline earth metal, or an ammonium radical. The present invention provides use of the deuterated compound I as an internal standard for measuring the content of a metabolite II in a biological sample, wherein the metabolite II has a structure as shown in a Formula (II); wherein A is H; M is H or an alkali metal, an alkaline earth metal, or an ammonium radical. The present invention uses the deuterated compound I as an internal standard to quantitatively analysis the content of metabolite II at lower content in biological samples, which can not only meet the requirements for the lower limit of quantitation, but also meet the requirements for DMPK studies in clinical trials.

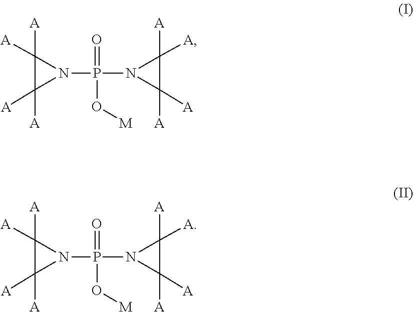

### TECHNICAL FIELD

The present invention relates to the field of assay technology, and in particular to a deuterated compound, and preparation method and use thereof.

### BACKGROUND

In human clinical trials, it is necessary to measure the contents of drugs and drug metabolites in biological samples (such as blood, urine and tissues) of a subject, and further conduct Drug Metabolism and Pharmacokinetics (DMPK) studies based on the measured contents of drugs and drug metabolites. Such studies are vital for developing new drugs.

Liquid chromatography, the most common method, can detect almost all types of drugs and drug metabolites, with the help of the ultra-high separation power of High Performance Liquid Chromatography (HPLC) or Ultra-High-Performance Liquid Chromatography (UHPLC), and the detection capacity of Ultraviolet Absorption Detector (UVD), Diode Array Detector (PDAD), Fluorescence Detector (FLD), Evaporative Light Scattering Detector (ELSD), Differential Refractometer (DR), or Mass Spectrometry Detector (MSD).

AST2660 (also known as AST-2660) is a metabolite of AST-3424 (also known as OBI-3424 or TH-3424) (Meng, F., Li, W F., Jung, D., Wang, C. C., Qi, T., Shia, C. S., Hsu, R. Y, Hsieh, Y. C., & Duan, J. (2021), A novel selective AKR1C3-activated prodrug AST-3424/OBI-3424 exhibits broad anti-tumor activity, American Journal of Cancer Research, 11(7), 3645-3659), and is a chemical ingredient that exerts the activity of prodrug AST-3424.

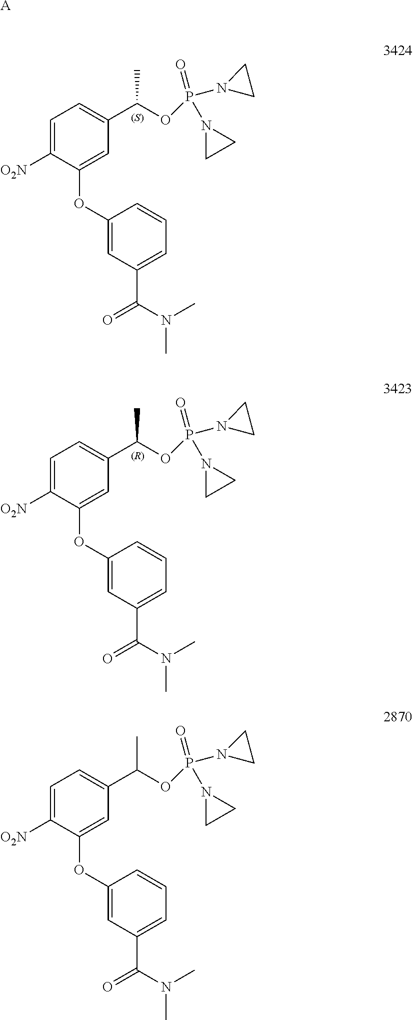

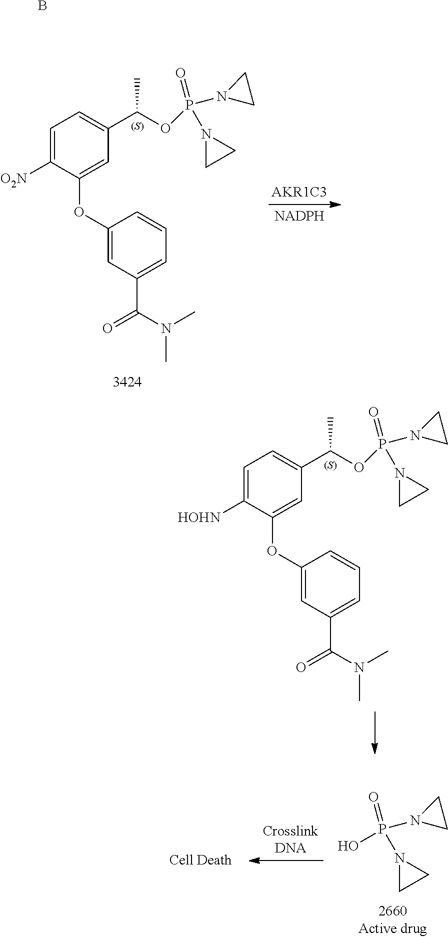

Chemical Scheme in which AST-3424 is metabolized into AST-2660 (i.e., 2660 shown in the figure)

In clinical trials (where OBI-3424 is under investigation in Phase II clinical trial NCT03592264 in the US (sponsored by OBI Pharma, Inc., a Taiwan-based biopharma company, in patients with castration-resistant prostate cancer (CRPC) and liver cancer), and in Phase II clinical trial NCT04315324 in the US (sponsored by the Southwest Oncology Group (SWOG), in patients with T-cell Acute Lymphoblastic Leukaemia (T-ALL)); and AST-3424 is under investigation in Phase II clinical trial CTR20191399 in China (sponsored by Ascentawits Pharmaceuticals, Ltd., in patients with solid tumors), and in Phase II clinical trial CTR20201915 in China (sponsored by Ascentawits Pharmaceuticals, Ltd., in patients with T-cell Acute Lymphoblastic Leukaemia (T-ALL) and B-cell Acute Lymphoblastic Lymphoma (B-ALL)), AST-3424 is used in an amount ranging from 1 mg to 100 mg.

The internal standard or external standard method used in conventional liquid chromatography cannot satisfy the requirements for quantitative analysis of drug metabolites in biological samples when a drug is dosed in lower amounts. Therefore, there is a need for developing an assay method which can not only meet the requirements for the lower limit of quantitation, but also meet the requirements for DMPK studies of the above drugs.

### SUMMARY OF THE INVENTION

To this end, the present invention provides a deuterated compound, and preparation method and use thereof. It has been tested and validated that deuterated compound I as an internal standard can be used for quantitative analysis of metabolite II in biological samples at the minimum detection limit of 0.5 ng/ml, which satisfies the requirements for DMPK studies.

The deuterated compound I provided by the present invention as the deuterated internal standard in DMPK analysis has adequate stability, can be stored for a longer time under experimental conditions (having stable quality and properties when stored at −20° C. and −70° C.), and can meet the requirements for long-term storage of samples and various operating temperatures (ambient temperatures for labs) in DMPK laboratories used in clinical trials.

Generally speaking, the present invention, which actually satisfies the requirements for DMPK studies of the above-mentioned metabolite II under the lower limit of quantitation (being present in low amounts, the sample having to be stored for a longer time as it needs to undergo centralized analysis, and satisfying the actual requirements of laboratory operations), provides a system for measuring low content levels of metabolite II in biological samples, comprising: a deuterated internal standard, LC-MS/MS instrument and method, curve-fitting algorithm for quantitation, and operating procedures.

According to the present invention, deuterated compound I is used for quantitative analysis of metabolite II in biological samples, which can meet the requirements for quantitative analysis under the lower limit of quantitation, and is also suitable for DMPK studies in clinical trials.

The present invention provides a deuterated compound I having a structure as shown in Formula (I):

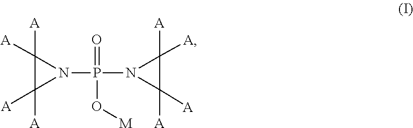

wherein A is H or D, and at least one of eight As is D;

M is H or an alkali metal, an alkaline earth metal, or an ammonium radical.

The deuterated compound I is a deuterated bis(aziridine-1-yl)phosphinic acid or a salt thereof the salt-forming cation is an alkali metal such as Na⁺, K⁺, or alkaline earth metal ion Ca²⁺, or ammonium ion NH₄⁺. Preferably, M is Na, K, Li, or an ammonium radical.

Depending on the biological samples and different reagents added in the subsequent operations, the deuterated compound may be present in the form of an acid or a salt; and correspondingly, the deuterated compound is an acid or a salt.

Preferably, at least three of the eight As in the deuterated compound I are D. As the deuterated internal standard, the corresponding mass-to-nucleus ratio m/z in the mass spectra should be distinguishable from non-deuterated compounds. In fact, the mass spectral peak is not a single value, but in the shape of a mountain that descends towards both sides around the main peak, and the abscissa value m/z of the main peak is the value of the compound, set as x; when a hydrogen atom (protium) in the compound is replaced by deuterium, the abscissa value m/z of its main peak is x+1. Apparently, since the main peak is in the shape of a mountain, x and x+1 will overlap with each other, and as a result they might be indistinguishable. According to the method for calculating the molecular weight of the compound (i.e., summing up the relative atomic masses of all the atoms in the compound), it can be concluded that the more the number of the atoms, the more the isotopic atom species with different relative atomic masses the corresponding atoms have, the shape of the main peak descending towards both sides will become more “robust”, and the broader the overlapping area with the main peak of another compound will be. One possible approach to narrow the overlapping area is to extend the distance between the two main peaks. For the deuterated compound, it is necessary to increase the number of its deuterium atoms. The present invention has found, based on the individualized situation of the deuterated compound I, and through experimental verification and calculation, that the non-deuterated compound (metabolite II) can be better distinguished from deuterated compound I when the deuterated compound I contains 3 D (deuterium) atoms. If there are fewer D (deuterium) atoms in the deuterated compound I, a mass spectrum with higher resolution is required to be provided.

Preferably, the number of D in the deuterated compound I is 4 or 8.

More preferably, the deuterated compound I is a compound having a structure as shown in Formula (I-1) or (I-2):

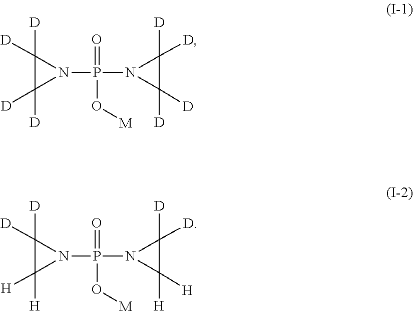

Particularly, the deuterated compound I is selected from compounds having the following structures:

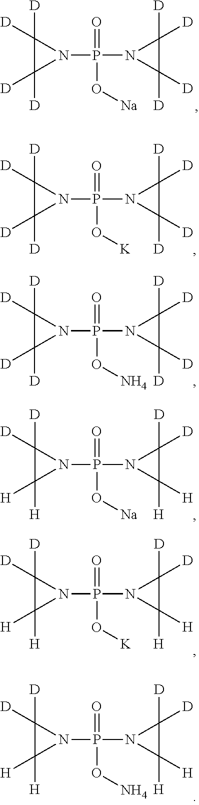

The present invention further provides a method for preparing a deuterated compound I, comprising the steps of:

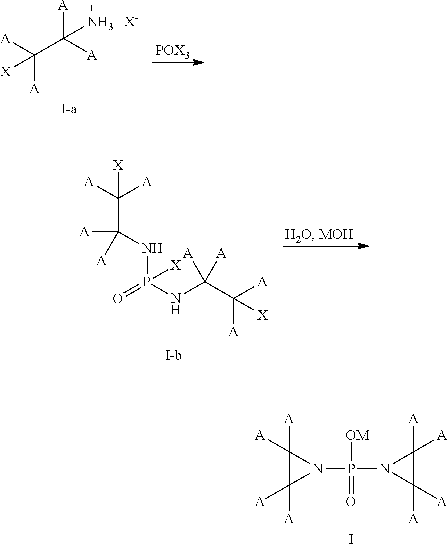

reacting compound I-a with phosphorus oxyhalide PDX3 to obtain compound I-b;

hydrolyzing compound I-b in an aqueous solution with or without a base to correspondingly obtain the deuterated compound I;

wherein compound I-a is deuterated 2-halogenated ethylamine or an inorganic acid salt, sulfate, phosphate thereof, or the like; A is H or D; and at least one of four As of compound I-a is D; and at least one of eight As of compounds I-b and compound I is D;

wherein the base in the hydrolysis reaction is selected from MOH, where M is an alkali metal, an alkaline earth metal or an ammonium radical; MH, where M is an alkali metal; MOR, where R is an alkyl group with 1-4 carbon atoms, and M is an alkali metal, carbonate or bicarbonate of alkali metal; and X is halogen.

In the first reaction, compound I-a (deuterated 2-haloethylamine or its hydrohalides) is reacted with phosphorus oxyhalide PDX₃ to obtain compound I-b. This reaction process may involve one or more reactions.

Deuterated 2-haloethylamine or 2-haloethylamine inorganic acid salts that can be used are determined based on the solvent used in the reaction.

Since this reaction is a violent exothermic reaction, 2-haloethylamine or 2-haloethylamine hydrohalide is dissolved in a solvent to lower the temperature. Subsequently, phosphorus oxyhalide PDX₃ or a solution of phosphorus oxyhalide is slowly added dropwise, and reacted under stirring (the temperature of the packed reaction system is −78 to −20° C.). The solvent used in the reaction is an organic solvent, for example, one or a mixture of two or more of dichloromethane, chloroform, chlorobenzene, 1,2-dichloroethane, ethyl acetate, n-hexane or cyclohexane.

The phosphorus oxyhalide PDX₃ comprises phosphorus oxybromide POBr3 and phosphorus oxychloride POCl₃. Deuterated 2-haloethylamine inorganic acid salts include deuterated 2-haloethylamine hydrohalic acids (hydrochloride, hydrobromide), inorganic oxo acid salts (such as sulfate and phosphate); preferably, the compound I-a is hydrochloride or hydrobromide of deuterated 2-haloethylamine.

As an acid is generated in the first reaction, a base is added to adjust the pH of the reaction. The bases added include inorganic bases and organic bases. Inorganic bases are selected from weak bases, such as alkaline earth metal hydroxides (calcium hydroxide), alkali metal carbonates, and bicarbonate salts (sodium carbonate, potassium carbonate, sodium bicarbonate, and potassium bicarbonate). Preferably, the organic base is one or a mixture of two or more of methylamine, ethylamine, propylamine, isopropylamine, N,N-diethylamine, triethylamine, n-butylamine, isobutylamine, 4-dimethylaminopyridine, N,N-diisopropylethylamine, 1,8-diazabicyclo[5.4.0]undec-7-ene, N,N,N′,N′ -tetramethyl ethyl enedi amine, tetramethylguanidine, pyridine, N-methyldicyclohexylamine or dicyclohexylamine.

The reaction procedures include: dissolving 2-haloethylamine or 2-haloethylamine hydrohalide in a solvent to lower the temperature, then slowly dropwise adding phosphorus oxyhalide PDX₃ or a solution of phosphorus oxyhalide PDX₃ to further lower the temperature, adding a base or a basic solution after lowering the temperature, and effecting the reaction under stirring.

Preferably, the organic solvent is one or a mixture of two or more of dichloromethane, chloroform, chlorobenzene, 1,2-dichloroethane, ethyl acetate, n-hexane or cyclohexane and tetrahydrofuran.

The reaction of compound I-a with phosphorus oxyhalide PDX3 is performed under an atmosphere, wherein the atmosphere is one of air, nitrogen or argon; preferably, the atmosphere is one of nitrogen or argon; more preferably, the atmosphere is nitrogen.

In the second step, compound I-b is hydrolyzed in an aqueous solution with or without a base to correspondingly obtain the deuterated compound I.

The hydrolysis reaction must take place with the addition of water. Thus, the reaction is carried out with the participation of water. If only water is added without adding a base, M in the deuterated compound I after the reaction is H, and the compound is correspondingly present in the form of an acid; if a base is added, a salt will be formed in the corresponding reaction. The base in the hydrolysis reaction is selected from MOH, where M is an alkali metal, an alkaline earth metal or an ammonium radical; MH, where M is an alkali metal; MOR, where R is an alkyl group with 1-4 carbon atoms, and M is an alkali metal, carbonate or bicarbonate of alkali metal. Preferably, the base is NaOH or KOH.

The present invention further provides a use of measuring the content of the deuterated compound I, i.e., measuring the content of the deuterated compound I by using a ³¹P-NMR method; preferably, measuring the content of the deuterated compound I in a solution containing the deuterated compound I by using a ³¹P-NMR method; or measuring the content of the deuterated compound I by using a liquid chromatography, wherein the liquid chromatography conditions are as follows:

a hydrogen acceptor type stationary phase chromatography column is used; mobile phase A is a methanol solution of ammonium acetate, and mobile phase B is acetonitrile;

mobile phases A and B are used for gradient elution, which gradually increased from 15% by volume ratio to 90% by volume ratio of mobile phase A, and then gradually decreased to 15% by volume ratio of mobile phase A.

The deuterated compound is quantitatively analyzed after it has been prepared and purified. Many methods are suitable for quantitative analysis. The deuterated compound can either be directly weighed after purification, or directly analyzed by HPLC.

As the finished product of the deuterated compound I prepared by this invention is present in an aqueous solution, it cannot be rapidly analyzed by typical HPLC or accurate weighing method. It was found by experimental verification that the ³¹P-NMR method can be used to measure the content with the required accuracy in a rapid and convenient manner.

The present invention further provides a method for measuring the content of the deuterated compound I, comprising the steps of:

detecting ³¹P-NMR of the deuterated compound I and the phosphorus-containing compound with known content to obtain their spectra; and substituting the content of the phosphorus-containing compound with known content to calculate and obtain the content of the deuterated compound I, based on the peak area ratio of the chemical shift characteristic peaks of the deuterated compound I to those of the phosphorus-containing compound in the ³¹P-NMR spectra.

The phosphorus-containing compound is preferably a compound containing one phosphorus atom, and more preferably is hexamethylphosphoric triamide.

Preferably, the deuterated compound I and the phosphorus-containing compound with known content are added to the solvent and tested for their ³¹P-NMR spectra.

Preferably, the deuterated compound I and the phosphorus-containing compound with known content are added to water and tested for their ³¹P-NMR spectra after they have been dissolved.

The deuterated compound I is quantitatively analyzed by using a phosphorus-containing compound as the internal standard of ³¹P-NMR. Evidently, the number of phosphorus atoms in the selected phosphorus-containing compound is preferably 1, so that the ³¹P-NMR spectra have relatively simple signal peaks, and thus are convenient for quantitation. Furthermore, the chemical shift of the ³¹P-NMR spectral signal peak of the phosphorus-containing compound should be spaced wide enough apart from the chemical shift of the ³¹P-NMR spectral signal peak of the deuterated compound I so that the two signal peaks are easily distinguishable.

When the spectra are assayed by ³¹P-NMR method, the number of scan times has certain impacts on the ³¹P-NMR spectral signal peak of the phosphorus-containing compound and also on the ³¹P-NMR spectral signal peak of the deuterated compound I. It has been verified by experiments that the number of scan times should be greater than 64 times.

The present invention further provides use of the deuterated compound I as an internal standard for detecting a metabolite II in a biological sample; preferably, the present invention provides use of the deuterated compound I as an internal standard for measuring a content of a metabolite of an DNA alkylating agent prodrug in a biological sample, wherein the metabolite II has a structure as shown in Formula (II):

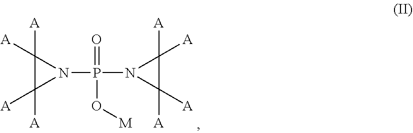

wherein A is H; M is H or an alkali metal, an alkaline earth metal, or an ammonium radical.

“Predrug” (also known as prodrug, drug precursor, precursor drug, etc.) refers to a compound that has pharmacological effects only after it has been converted in vivo. The prodrug itself is biologically inactive or less active, but becomes active after it has been metabolized within the body. The purpose of this process is to increase the bio-availability and targeting capacity of the drug while lowering its toxicity and side effects. Currently, prodrugs can be classified into two major families: carrier-prodrugs and bioprecursors.

The DNA alkylating agent prodrug of the present invention refers to a prodrug that releases a DNA alkylating agent (i.e., metabolite II) after metabolism.

The present invention further provides use of the deuterated compound I as an internal standard for measuring a content of a metabolite of an AKR1C3-activated DNA alkylating agent prodrug or a hypoxia-activated DNA alkylating agent prodrug in a biological sample by LC-MS/MS analysis, wherein the metabolite II has a structure as shown in Formula (II):

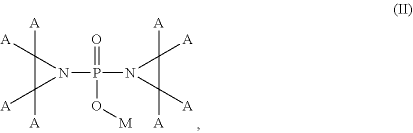

wherein A is H; M is H or an alkali metal, an alkaline earth metal, or an ammonium radical;

wherein the deuterated compound I is selected from

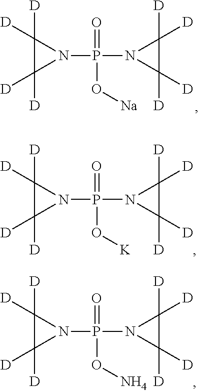

wherein the metabolite II is selected from

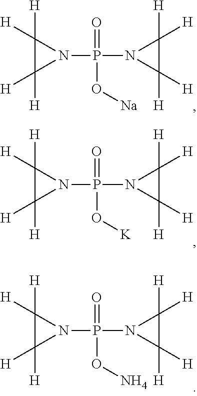

The AKR1C3-activated DNA alkylating agent prodrug is selected from the compounds having the following structures as shown in Formulae 1-5:

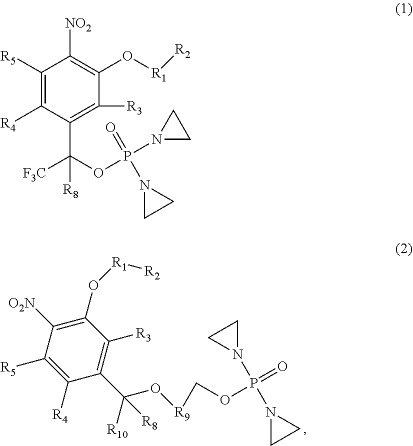

wherein the definitions of R₁, R₂, R₃, R₄, R₅, R₈, R₉, and R₁₀ are as described in the claims of Patent Application PCT/CN2020/089692 with Publication No. WO2020228685A1. Specifically, the groups are defined as follows:
R₁ is C₆-C₁₀ aryl or Z-substituted aryl, 4-15 membered heterocycle or Z-substituted heterocycle, 5-15 membered heteroaryl or Z-substituted heteroaryl, or a 7-15 membered fused ring or Z-substituted fused ring;
R₂ is hydrogen, a halogen atom, cyano or isocyano, hydroxy, sulfhydryl, amino, OTs, OMS, C₂-C₆ alkyl or Z-substituted alkyl, C₂-C₆ alkenyl or Z-substituted alkenyl, C₂-C₆ alkynyl or Z-substituted alkynyl, C₃-C₈ cycloalkyl or Z-substituted cycloalkyl, C₆-C₁₀ aryl or Z-substituted aryl, 4-15 membered heterocycle or Z-substituted heterocycle, 5-15 membered heteroaryl or Z-substituted heteroaryl, ether having from 1 to 6 carbon atoms or Z-substituted alkoxy having from 1 to 6 carbon atoms, —CONR⁶R⁷, —SO₂NR⁶R⁷, —SO₂R⁶, —OCOO—R⁶, —COOR⁶, —NR⁶COR⁷, —OCOR⁶, —NR⁶SO₂R⁷ or —NR⁶SO₂NR⁶R⁷, or R² together with the atom in the group R¹ to which it is bonded to form a 7-15 membered fused ring or Z-substituted fused ring;
R₃ is hydrogen, halogen, cyano or isocyano, hydroxy, sulfhydryl, amino, OTs, OLCMS, C₁-C₆ alkyl or Z-substituted alkyl, C₂-C₆ alkenyl or Z-substituted alkenyl, C₂-C₆ alkynyl or Z-substituted alkynyl, C₃-C₈ cycloalkyl or Z-substituted cycloalkyl, C₆-C₁₀ aryl or Z-substituted aryl, 4-15 membered heterocycle or Z-substituted heterocycle, 5-15 membered heteroaryl or Z-substituted heteroaryl, C₁-C₆ alkoxy or Z-substituted C₁-C₆ alkoxy, —CONR⁶R^{7, —SO}₂NR⁶R⁷, —SO₂R⁶, —OCO—R⁶, —OCOO—R⁶, —COOR⁶, —NR⁶COR⁷, —OCOR⁶, or —NR⁶SO₂R⁷;
R₄ and R₅ are each independently hydrogen, a halogen atom, cyano or isocyano, hydroxy, sulfhydryl, amino, OTs, OLCMS, C₁-C₆ alkyl or Z-substituted alkyl, C₂-C₆ alkenyl or Z-substituted alkenyl, C₂-C₆ alkynyl or Z-substituted alkynyl, C₃-C₈ cycloalkyl or Z-substituted cycloalkyl, C₆-C₁₀ aryl or Z-substituted aryl, 4-15 membered heterocycle or Z-substituted heterocycle, 5-15 membered heteroaryl or Z-substituted heteroaryl, C₁-C₆ alkoxy or Z-substituted C₁-C₆ alkoxy, —CONR⁶R⁷, —SO₂NR⁶R⁷, —SO₂R⁶, —OCOO—R⁶, —COOR⁶, —NR⁶COR⁶, —OCOR⁶ or —NR⁶SO₂R⁷, or R⁴ and R⁵ together with the atom in the benzene ring to which they are bonded to form a 7-15 membered fused ring or Z-substituted fused ring;
R₆ and R₇ are each independently hydrogen, cyano or isocyano, C₁-C₆ alkyl or Z-substituted alkyl, C₂-C₆ alkenyl or Z-substituted alkenyl, C₂-C₆ alkynyl or Z-substituted alkynyl, C₃-C₈ cycloalkyl or Z-substituted cycloalkyl, C₆-C₁₀ aryl or Z-substituted aryl, 4-15 membered heterocycle or Z-substituted heterocycle, 5-15 membered heteroaryl or Z-substituted heteroaryl, or C₁-C₆ alkoxy or Z-substituted C₁-C₆ alkoxy, or R⁶ and R⁷ together with the atom to which they are bonded to form 5-7 membered heterocyclyl or Z-substituted 5-7 membered heterocyclyl;
R₈ and R₁₀ are each independently hydrogen, deuterium, aryl or Z-substituted aryl, C₁-C₆ alkyl or Z-substituted alkyl, C₂-C₆ alkenyl or Z-substituted alkenyl, C₂-C₆ alkynyl or Z-substituted alkynyl, C₃-C₈ cycloalkyl or Z-substituted cycloalkyl, and at least one of R⁸ and R¹⁰ must be hydrogen or deuterium;

R₉ is substituted C₆-C₁₀ aryl which is substitued with at least one fluorine atom or nitro group, substituted 4-15 membered heterocycle which is substitued with at least one fluorine atom or nitro group, or substituted 5-15 membered heteroaryl which is substituted with at least one fluorine atom or nitro group;
the substituent Z is a halogen atom, cyano or isocyano, hydroxy, sulfhydryl, amino, OTs, OMS, C₁-C₃ alkyl or substituted alkyl, C₁-C₃ alkoxy or substituted alkoxy, C₂-C₃ alkenyl or substituted alkenyl, C₂-C₃ alkynyl or substituted alkynyl, C₃-C₈ cycloalkyl or substituted cycloalkyl, an aromatic ring, heterocycle, a heteroaromatic ring and fused ring or a substituted aromatic ring, heterocycle, or a heteroaromatic ring and fused ring, the pattern of substitution being mono- or di-substitution;
the substitution in the substituted C₆-C₁₀ aryl, substituted 4-15 membered heterocycle or substituted 5-15 membered heteroaryl in R₉ is a halogen atom, nitro, cyano or isocyano, hydroxy, amino, C₁-C₃ alkyl or alkoxy, alkenyl, alkynyl, cycloalkyl or benzene ring, substituted benzene ring, C₁-C₃ alkoxy or halogen atom-substituted alkoxy.

In particular, the compounds of Formulae (1) and (2) are selected from the group consisting of:

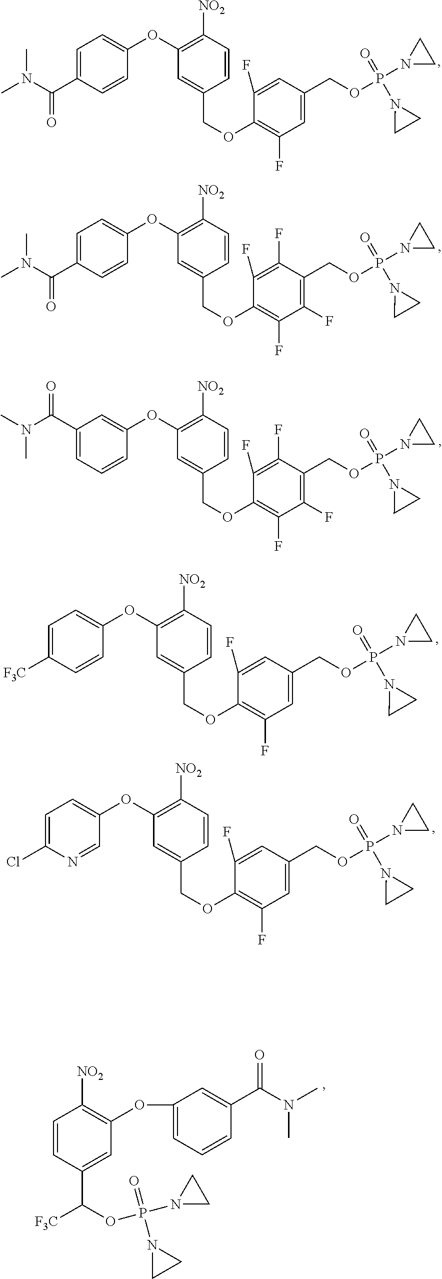 [SMILES: CN(C)C(=O)c1ccc(Oc2cc(COc3c(F)cc(COP(=O)(N4CC4)N4CC4)cc3F)ccc2[N+](=O)[O-])cc1 ; CN(C)C(=O)c1ccc(Oc2cc(COc3c(F)c(F)c(COP(=O)(N4CC4)N4CC4)c(F)c3F)ccc2[N+](=O)[O-])cc1 ; CN(C)C(=O)c1cccc(Oc2cc(COc3c(F)c(F)c(COP(=O)(N4CC4)N4CC4)c(F)c3F)ccc2[N+](=O)[O-])c1 ; O=[N+]([O-])c1ccc(COc2c(F)cc(COP(=O)(N3CC3)N3CC3)cc2F)cc1Oc1ccc(C(F)(F)F)cc1 ; O=[N+]([O-])c1ccc(COc2c(F)cc(COP(=O)(N3CC3)N3CC3)cc2F)cc1Oc1ccc(Cl)nc1 ; CN(C)C(=O)c1cccc(Oc2cc(C(OP(=O)(N3CC3)N3CC3)C(F)(F)F)ccc2[N+](=O)[O-])c1]

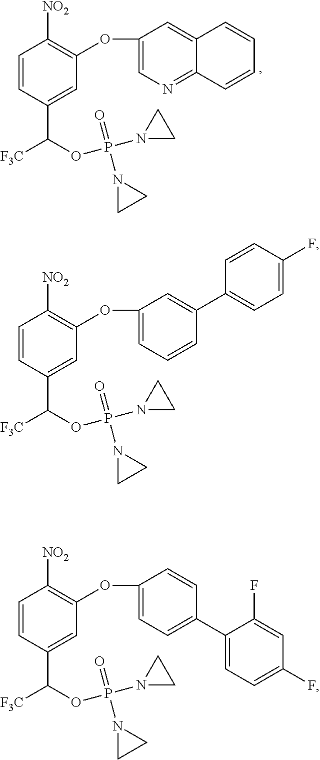 [SMILES: O=[N+]([O-])c1ccc(C(OP(=O)(N2CC2)N2CC2)C(F)(F)F)cc1Oc1cnc2ccccc2c1 ; O=[N+]([O-])c1ccc(C(OP(=O)(N2CC2)N2CC2)C(F)(F)F)cc1Oc1cccc(-c2ccc(F)cc2)c1 ; O=[N+]([O-])c1ccc(C(OP(=O)(N2CC2)N2CC2)C(F)(F)F)cc1Oc1ccc(-c2ccc(F)cc2F)cc1]

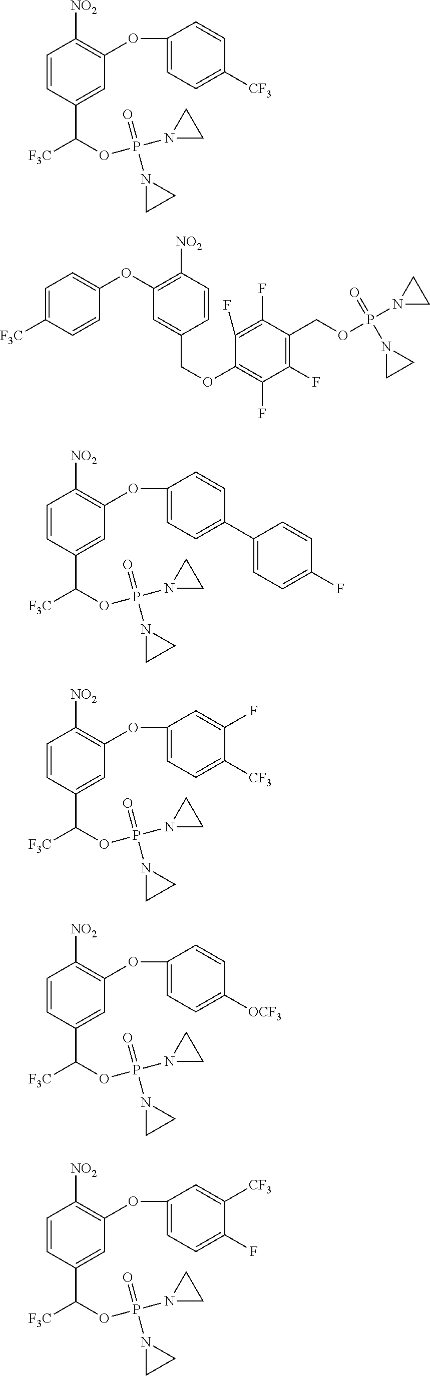

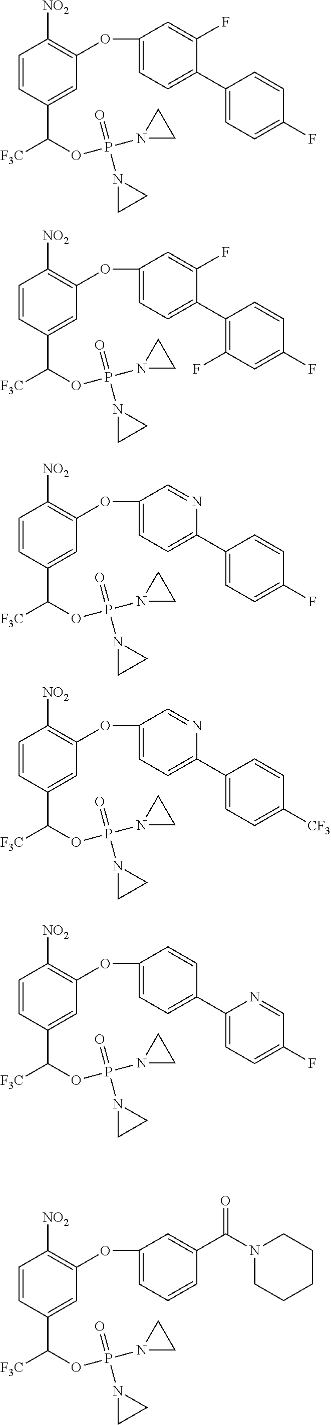 [SMILES: O=[N+]([O-])c1ccc(C(OP(=O)(N2CC2)N2CC2)C(F)(F)F)cc1Oc1ccc(-c2ccc(F)cc2)c(F)c1 ; O=[N+]([O-])c1ccc(C(OP(=O)(N2CC2)N2CC2)C(F)(F)F)cc1Oc1ccc(-c2ccc(F)cc2F)c(F)c1 ; O=[N+]([O-])c1ccc(C(OP(=O)(N2CC2)N2CC2)C(F)(F)F)cc1Oc1ccc(-c2ccc(F)cc2)nc1 ; O=[N+]([O-])c1ccc(C(OP(=O)(N2CC2)N2CC2)C(F)(F)F)cc1Oc1ccc(-c2ccc(C(F)(F)F)cc2)nc1 ; O=[N+]([O-])c1ccc(C(OP(=O)(N2CC2)N2CC2)C(F)(F)F)cc1Oc1ccc(-c2ccc(F)cn2)cc1 ; O=C(c1cccc(Oc2cc(C(OP(=O)(N3CC3)N3CC3)C(F)(F)F)ccc2[N+](=O)[O-])c1)N1CCCCC1]

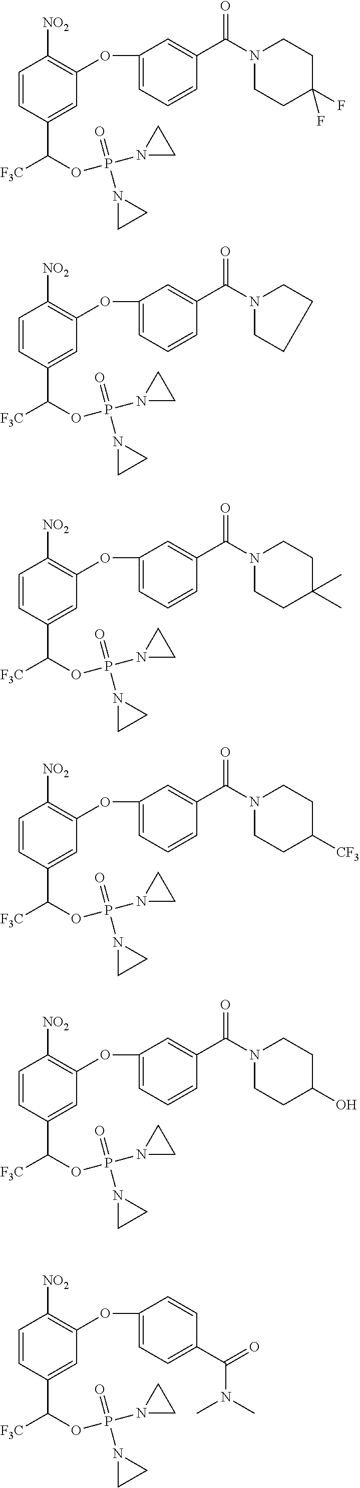 [SMILES: O=C(c1cccc(Oc2cc(C(OP(=O)(N3CC3)N3CC3)C(F)(F)F)ccc2[N+](=O)[O-])c1)N1CCC(F)(F)CC1 ; O=C(c1cccc(Oc2cc(C(OP(=O)(N3CC3)N3CC3)C(F)(F)F)ccc2[N+](=O)[O-])c1)N1CCCC1 ; CC1(C)CCN(C(=O)c2cccc(Oc3cc(C(OP(=O)(N4CC4)N4CC4)C(F)(F)F)ccc3[N+](=O)[O-])c2)CC1 ; O=C(c1cccc(Oc2cc(C(OP(=O)(N3CC3)N3CC3)C(F)(F)F)ccc2[N+](=O)[O-])c1)N1CCC(C(F)(F)F)CC1 ; O=C(c1cccc(Oc2cc(C(OP(=O)(N3CC3)N3CC3)C(F)(F)F)ccc2[N+](=O)[O-])c1)N1CCC(O)CC1 ; CN(C)C(=O)c1ccc(Oc2cc(C(OP(=O)(N3CC3)N3CC3)C(F)(F)F)ccc2[N+](=O)[O-])cc1]

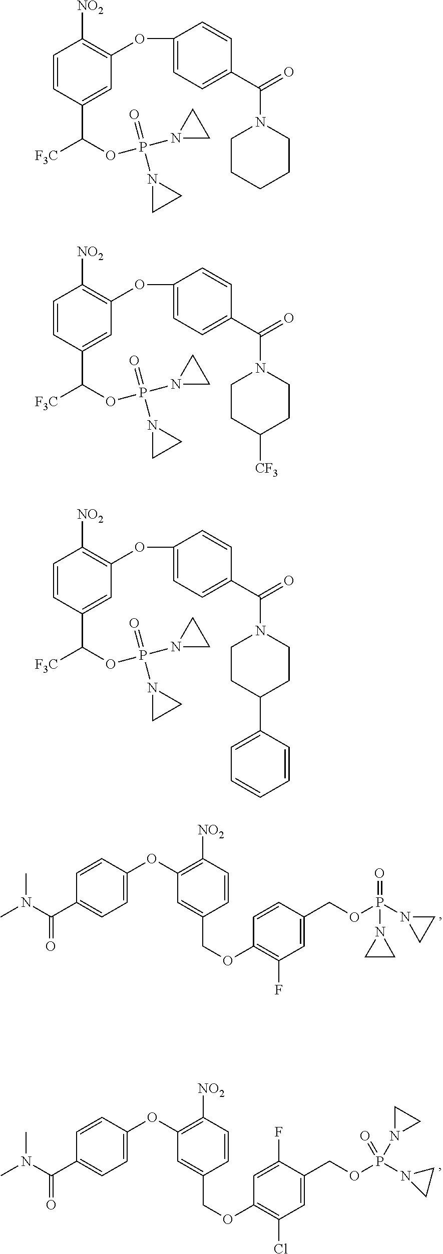 [SMILES: O=C(c1ccc(Oc2cc(C(OP(=O)(N3CC3)N3CC3)C(F)(F)F)ccc2[N+](=O)[O-])cc1)N1CCCCC1 ; O=C(c1ccc(Oc2cc(C(OP(=O)(N3CC3)N3CC3)C(F)(F)F)ccc2[N+](=O)[O-])cc1)N1CCC(C(F)(F)F)CC1 ; O=C(c1ccc(Oc2cc(C(OP(=O)(N3CC3)N3CC3)C(F)(F)F)ccc2[N+](=O)[O-])cc1)N1CCC(c2ccccc2)CC1 ; CN(C)C(=O)c1ccc(Oc2cc(COc3ccc(COP(=O)(N4CC4)N4CC4)cc3F)ccc2[N+](=O)[O-])cc1 ; CN(C)C(=O)c1ccc(Oc2cc(COc3cc(F)c(COP(=O)(N4CC4)N4CC4)cc3Cl)ccc2[N+](=O)[O-])cc1]

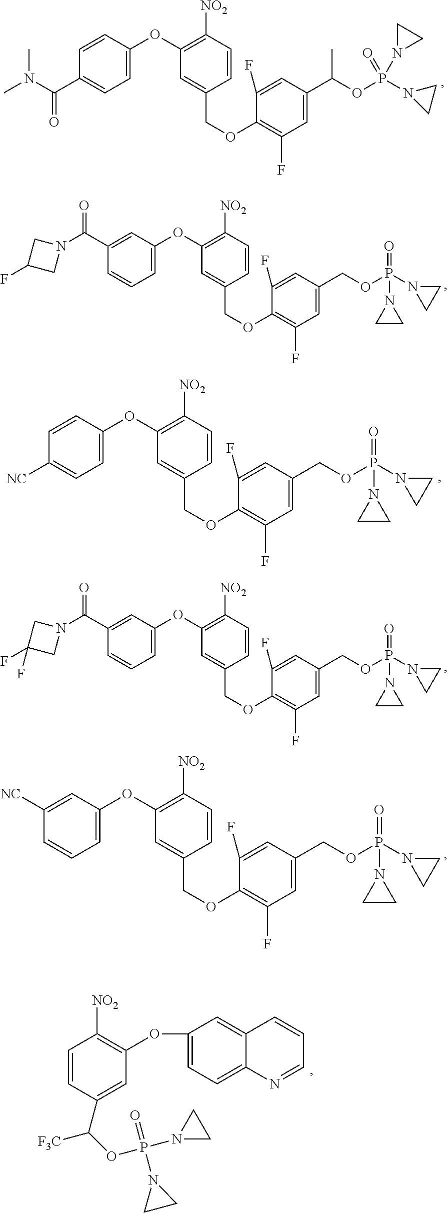 [SMILES: CC(OP(=O)(N1CC1)N1CC1)c1cc(F)c(OCc2ccc([N+](=O)[O-])c(Oc3ccc(C(=O)N(C)C)cc3)c2)c(F)c1 ; O=C(c1cccc(Oc2cc(COc3c(F)cc(COP(=O)(N4CC4)N4CC4)cc3F)ccc2[N+](=O)[O-])c1)N1CC(F)C1 ; N#Cc1ccc(Oc2cc(COc3c(F)cc(COP(=O)(N4CC4)N4CC4)cc3F)ccc2[N+](=O)[O-])cc1 ; O=C(c1cccc(Oc2cc(COc3c(F)cc(COP(=O)(N4CC4)N4CC4)cc3F)ccc2[N+](=O)[O-])c1)N1CC(F)(F)C1 ; N#Cc1cccc(Oc2cc(COc3c(F)cc(COP(=O)(N4CC4)N4CC4)cc3F)ccc2[N+](=O)[O-])c1 ; O=[N+]([O-])c1ccc(C(OP(=O)(N2CC2)N2CC2)C(F)(F)F)cc1Oc1ccc2ncccc2c1]

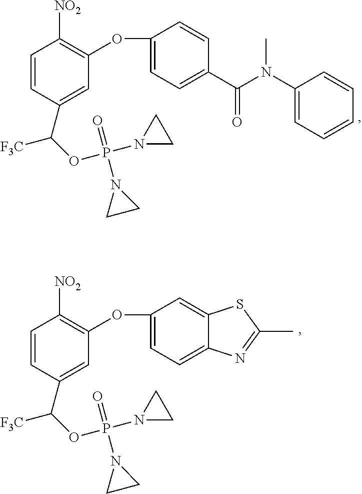 [SMILES: CN(C(=O)c1ccc(Oc2cc(C(OP(=O)(N3CC3)N3CC3)C(F)(F)F)ccc2[N+](=O)[O-])cc1)c1ccccc1 ; Cc1nc2ccc(Oc3cc(C(OP(=O)(N4CC4)N4CC4)C(F)(F)F)ccc3[N+](=O)[O-])cc2s1]

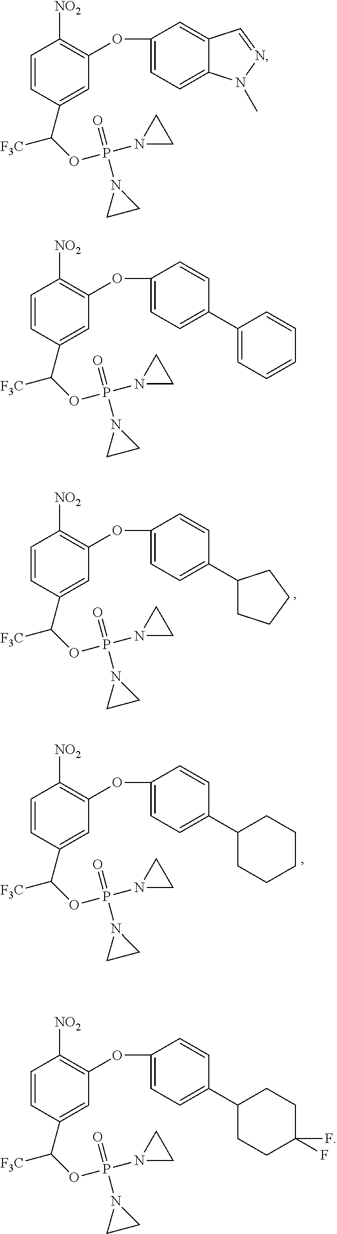 [SMILES: Cn1ncc2cc(Oc3cc(C(OP(=O)(N4CC4)N4CC4)C(F)(F)F)ccc3[N+](=O)[O-])ccc21 ; O=[N+]([O-])c1ccc(C(OP(=O)(N2CC2)N2CC2)C(F)(F)F)cc1Oc1ccc(-c2ccccc2)cc1 ; O=[N+]([O-])c1ccc(C(OP(=O)(N2CC2)N2CC2)C(F)(F)F)cc1Oc1ccc(C2CCCC2)cc1 ; O=[N+]([O-])c1ccc(C(OP(=O)(N2CC2)N2CC2)C(F)(F)F)cc1Oc1ccc(C2CCCCC2)cc1 ; O=[N+]([O-])c1ccc(C(OP(=O)(N2CC2)N2CC2)C(F)(F)F)cc1Oc1ccc(C2CCC(F)(F)CC2)cc1]

The definitions and meanings of the groups, and the preparation methods and spectral data of the compounds have been described in Patent Application PCT/CN2020/089692 with Publication No. WO2020228685A1, which is incorporated herein by reference in its entirety.

Evidently, the compounds of structural Formula 1 or 2, similar to AST-342, are prodrugs of AST-2660 (in acid form), and can be activated by the AKR1C3 enzyme to form AST-2660 to exhibit its anti-cancer efficacy.

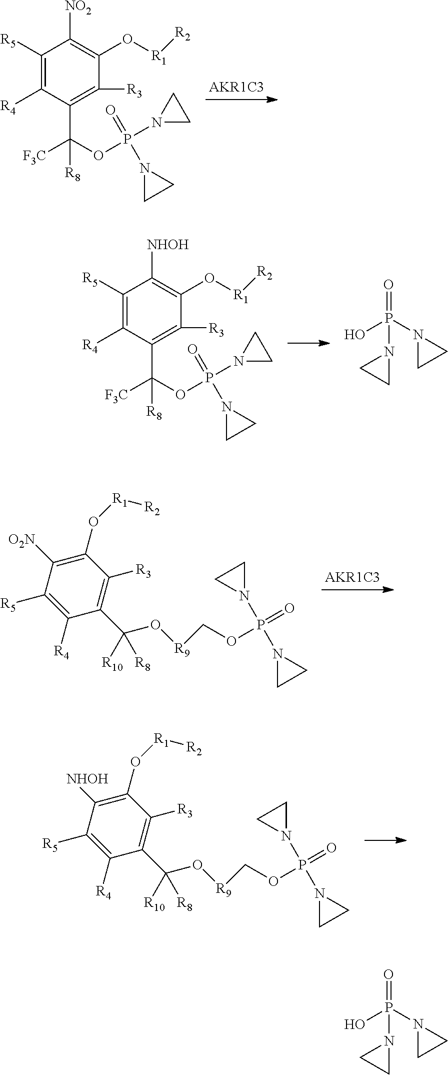

Evidently, the compounds include those of structural Formula 1 or 2 and salts, esters, solvates, isotopic isomers thereof.

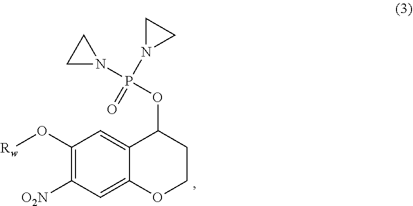

wherein the definition of Rw has been described in the claims of Patent Application PCT/CN2020/120281 with Publication No. WO2021068952A1. Specifically, the groups are defined as follows:

Rw is

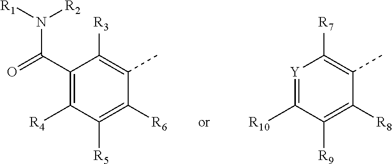

R₁ is H, C₁₋₆ alkyl, C₃₋₆ cycloalkyl, 4-6 membered heterocycloalkyl, 5-6 membered heteroaryl or phenyl, wherein the C₁₋₆ alkyl, C₃₋₆ cycloalkyl, 4-6 membered heterocycloalkyl, 5-6 membered heteroaryl and phenyl are optionally substituted with 1, 2 or 3 R^{a};
each R^{a} is independently H, F, Cl, Br, I, —CN, —OH, C₁₋₃ alkoxy or C₁₋₃ alkyl;
R₂ is H or C₁₋₆ alkyl;
or R₁ and R₂, together with the N atom to which they are attached, to form a 4-6 membered heterocycloalkyl, wherein the 4-6 membered heterocycloalkyl is optionally substituted with 1, 2 or 3 R^{b};
each R^{b} is independently H, F, Cl, Br, I, —CN, —OH, —NH₂, —OCH₃, —OCH₂CH₃, —CH₃ or —CH₂CH₃;
R₃ is H, F, Cl, Br, I, —OH, —NH₂, C₁₋₃ alkoxy or C₁₋₃ alkyl;
or R₂ and R₃ are attached together to make the structural unit

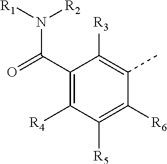

to be

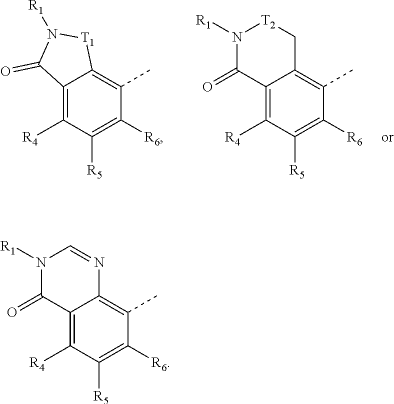

T₁ is —(CR^{c}R^{d})ₘ— or —(CR^{c}R^{d})ₙ—O—;
m is 1, 2 or 3;
n is 1 or 2;
T₂ is N or CH;
R^{c} and R^{d} are each independently H, F, C₁₋₃ alkyl or C₁₋₃ alkoxy;
R₄, R₅ and R₆ are each independently H, F, Cl, Br, I, C₁₋₃ alkyl or C₁₋₃ alkoxy;
T is N or CH;
R₇ and R₈ are each independently H, F, Cl, Br or I;
R₉ and R₁₀ are each independently H, F, Cl, Br, I, —CN or
the 4-6 membered heterocycloalkyl and 5-6 membered heteroaryl each contain 1, 2, 3 or 4 heteroatoms independently selected from N, —O— and —S—.

Specifically, the compound of Formula (3) is selected from:

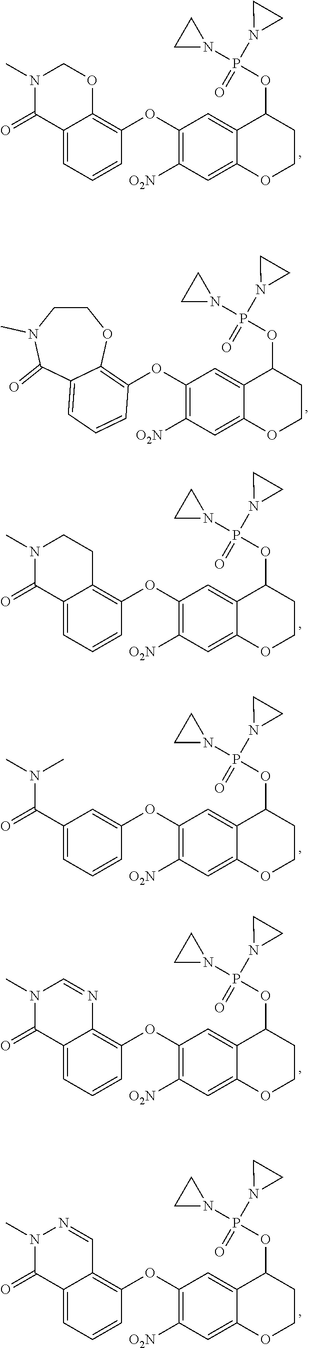

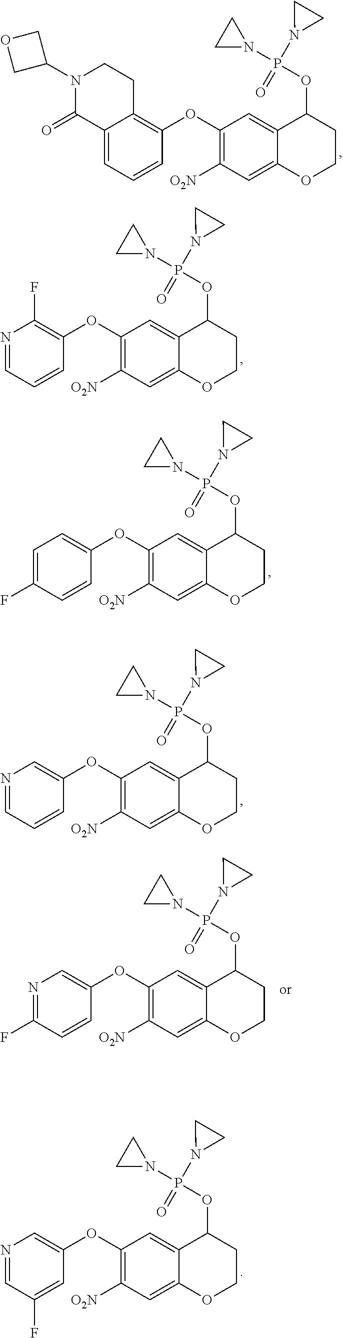

The definitions and meanings of the groups, and the preparation methods and spectral data of the compounds have been described in Patent Application PCT/CN2020/120281 with Publication No. WO2021068952A1, which is incorporated herein by reference in its entirety.

Evidently, the compounds of structural Formula 3, similar to AST-342, are prodrugs of AST-2660 (in acid form), and can be activated by the AKR1C3 enzyme to form AST-2660 to exhibit its anti-cancer efficacy:

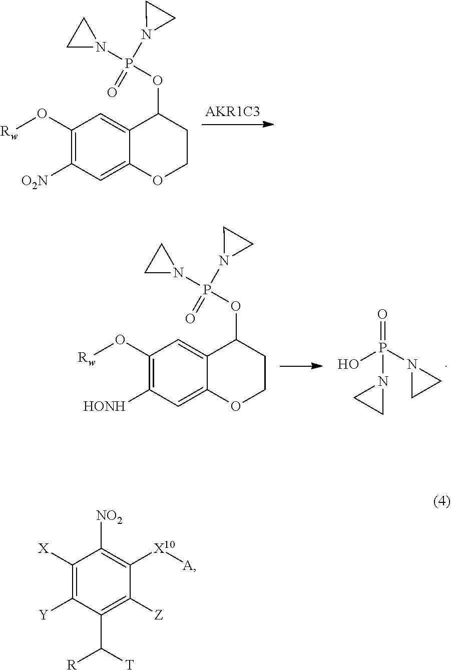

wherein the definitions of X, Y, Z, R, A and X¹⁰ have been described in the claims of Patent Application PCT/US2016/021581 with Publication No. WO2016145092A1 (corresponding to Chinese Patent Application No. 2016800150788 with Publication No. CN107530556A), and T is

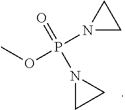

Specifically, the groups are defined as follows:
X¹⁰ is O, S, SO or SO₂;
A is C₆-C₁₀ aryl, 5-15 membered heteroaryl, or —N═CR¹R²;
each R¹ and R² independently is hydrogen, C₁-C₆ alkyl, C₃-C₈ cycloalkyl, C₆-C₁₀ aryl, 4-15 membered heterocycle, ether, —CONR¹³R¹⁴, or —NR¹³COR¹⁴;
each X, Y, and Z independently is hydrogen, CN, halogen, C₁-C₆ alkyl, C₂-C₆ alkenyl, C₂-C₆ alkynyl, C₃-C₈ cycloalkyl, C₆-C₁₀ aryl, 4-15 membered heterocycle, ether, —CONR¹³R¹⁴, or —NR¹³COR¹⁴;
R is hydrogen, C₁-C₆ alkyl, C₂-C₆ alkenyl, C₂-C₆ alkynyl, C₃-C₈ cycloalkyl, C₆-C₁₀ aryl, 4-15 membered heterocycle, ether, —CONR¹³R¹⁴, or —NR¹³COR¹⁴;
each R¹³ and R¹⁴ independently is hydrogen, C₁-C₆ alkyl, C₃-C₈ cycloalkyl, C₆-C₁₀ aryl, 4-15 membered heterocycle, or ether;
T is

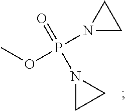

and
wherein the alkyl, alkenyl, alkynyl, cycloalkyl, aryl, heterocycle, heteroaryl, and ether groups are optionally substituted.

Specifically, the compound of Formula (5) is selected from the group consisting of:

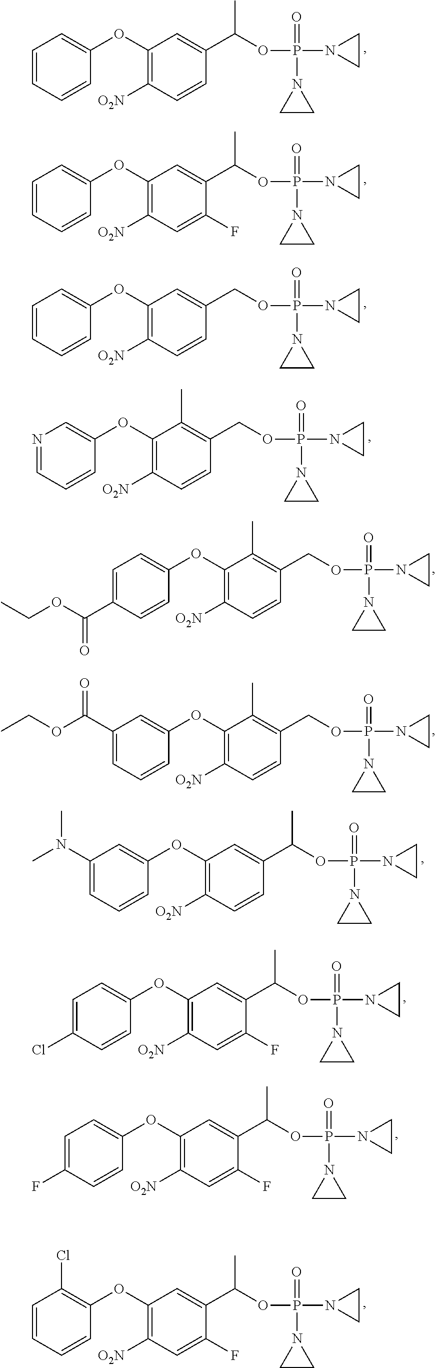

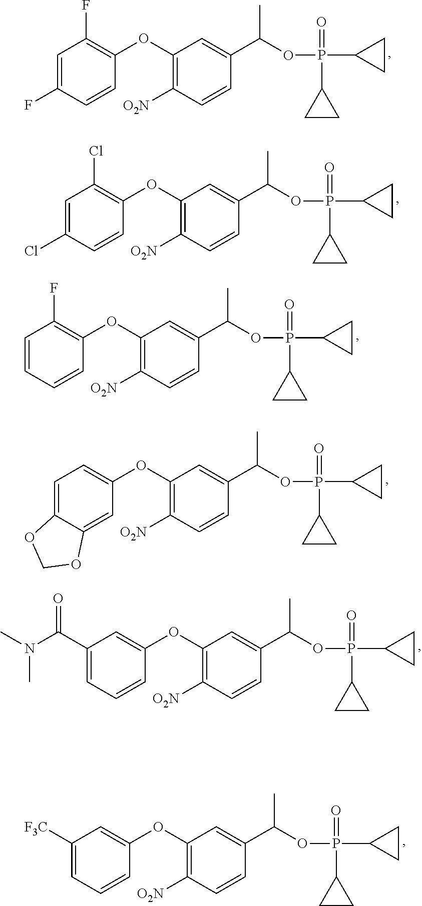

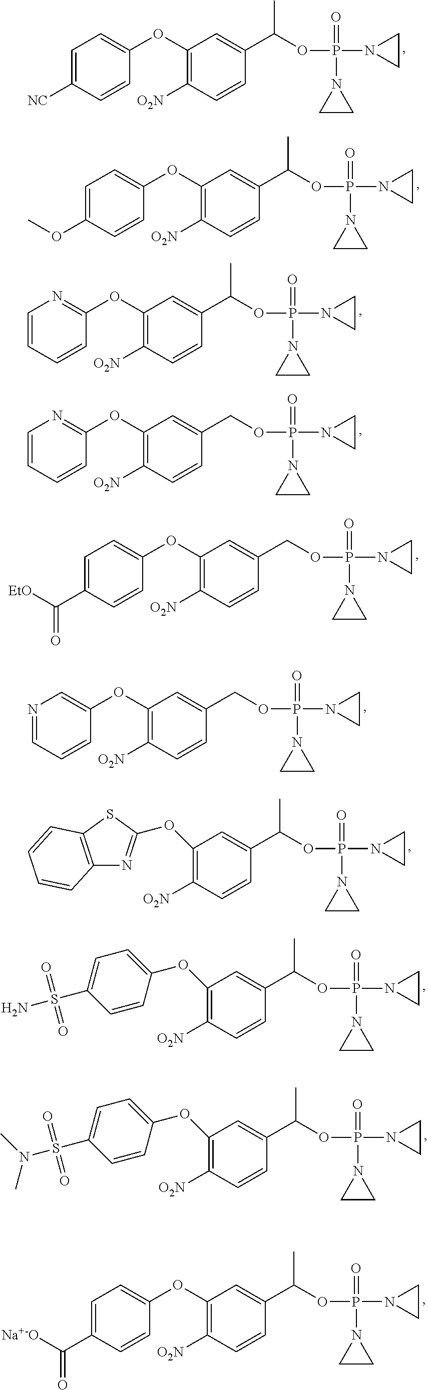

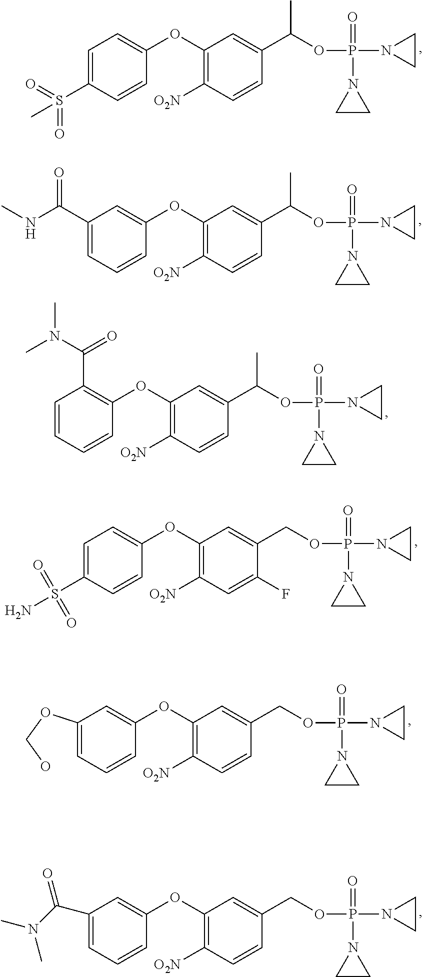

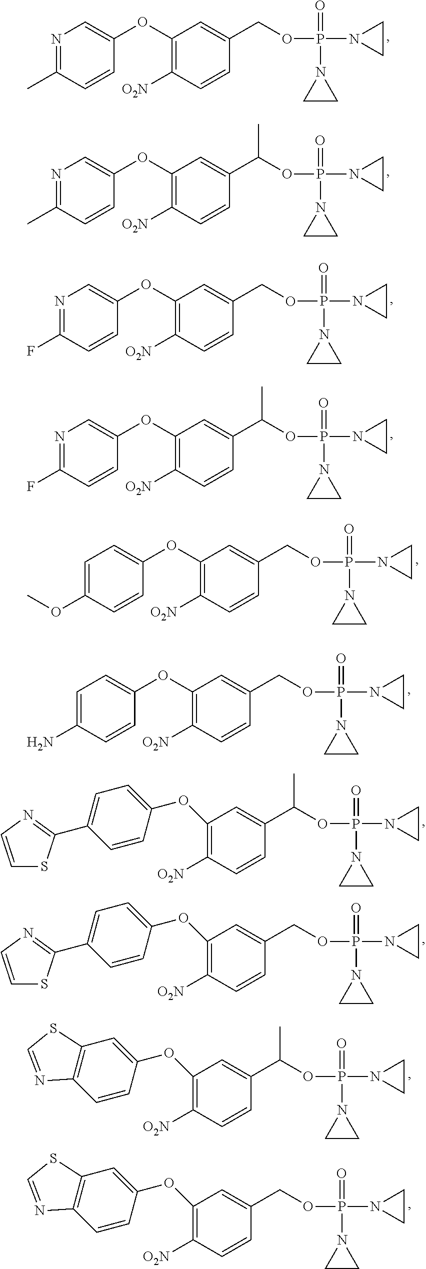

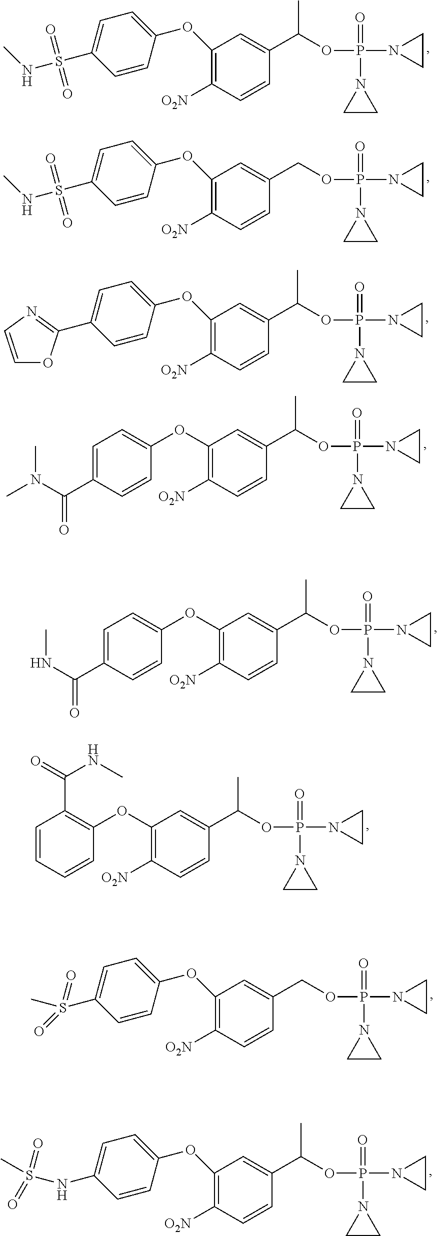

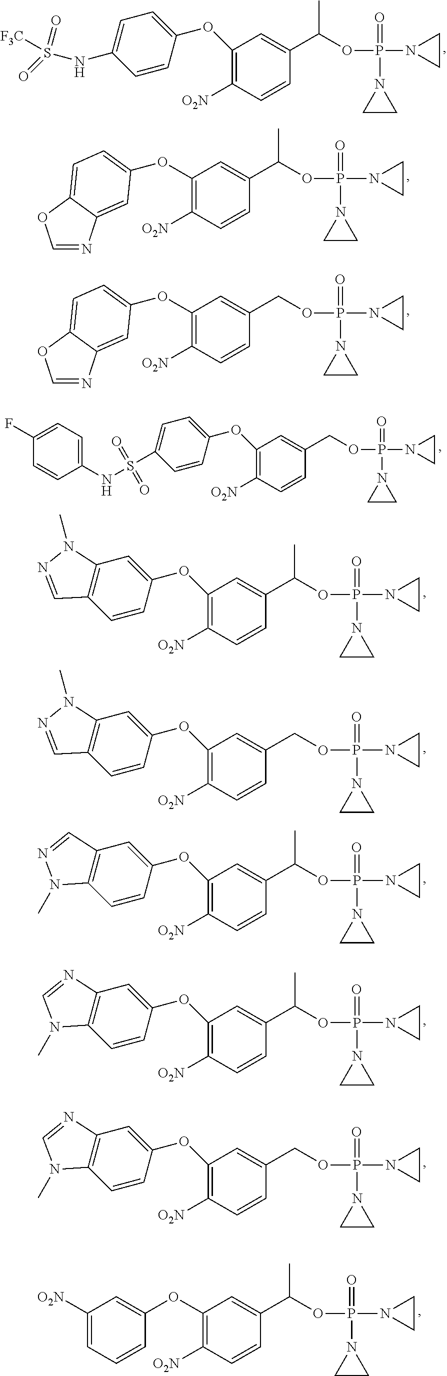

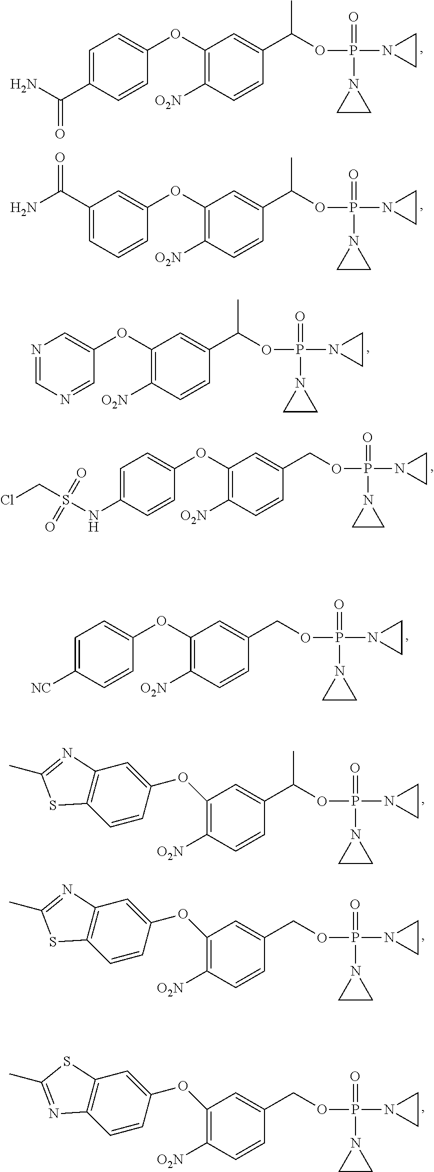

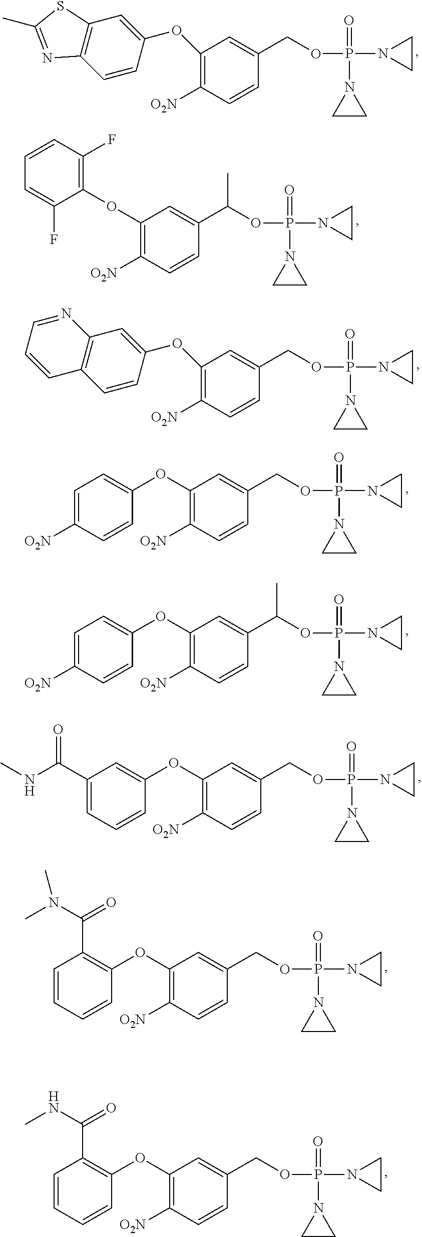

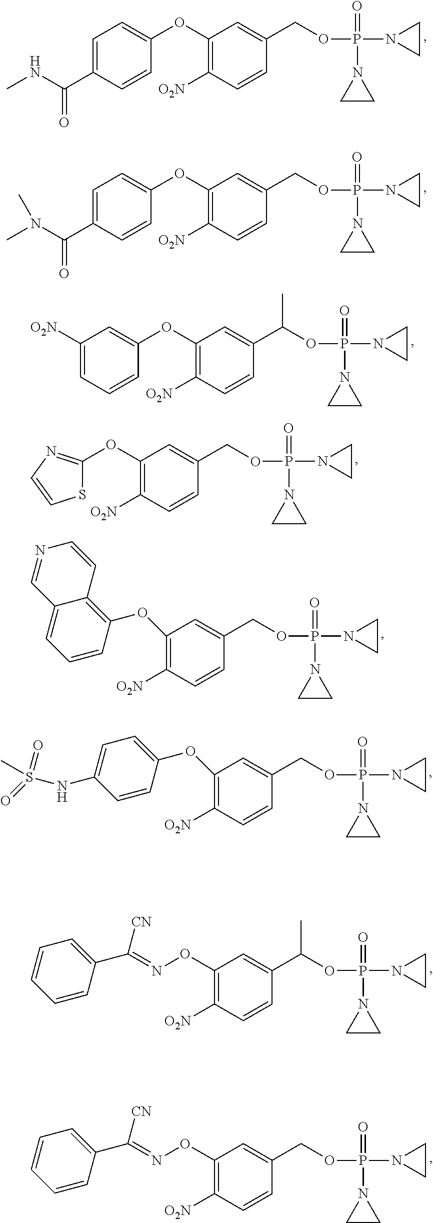

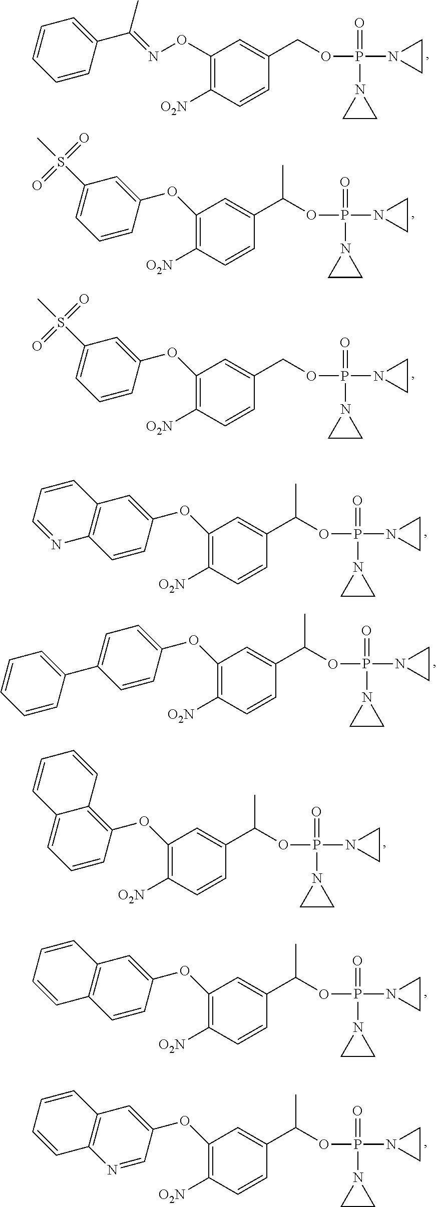

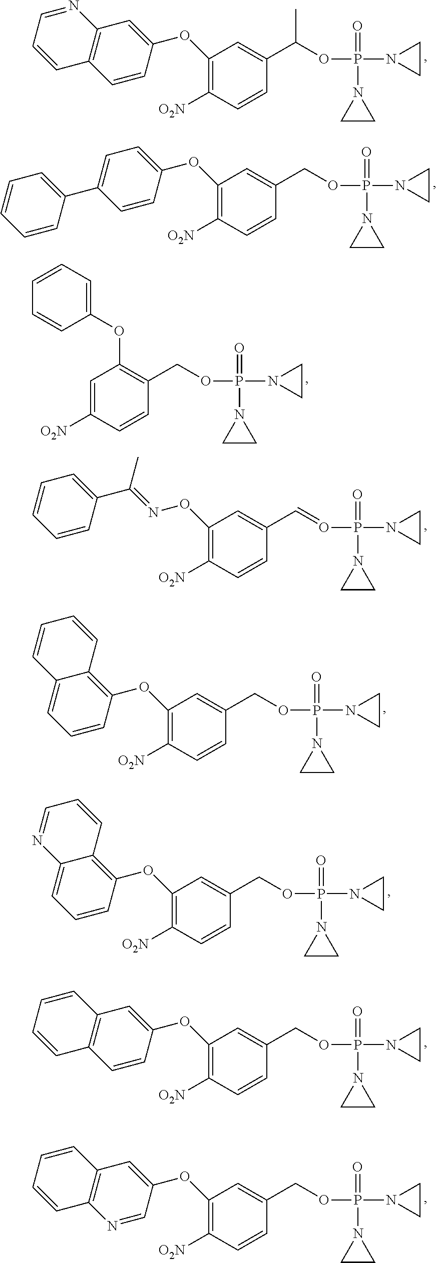

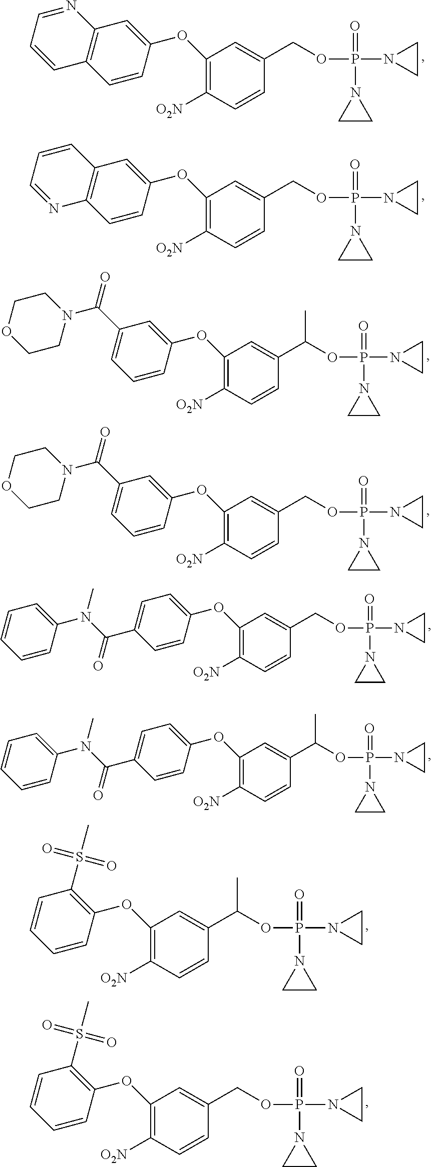

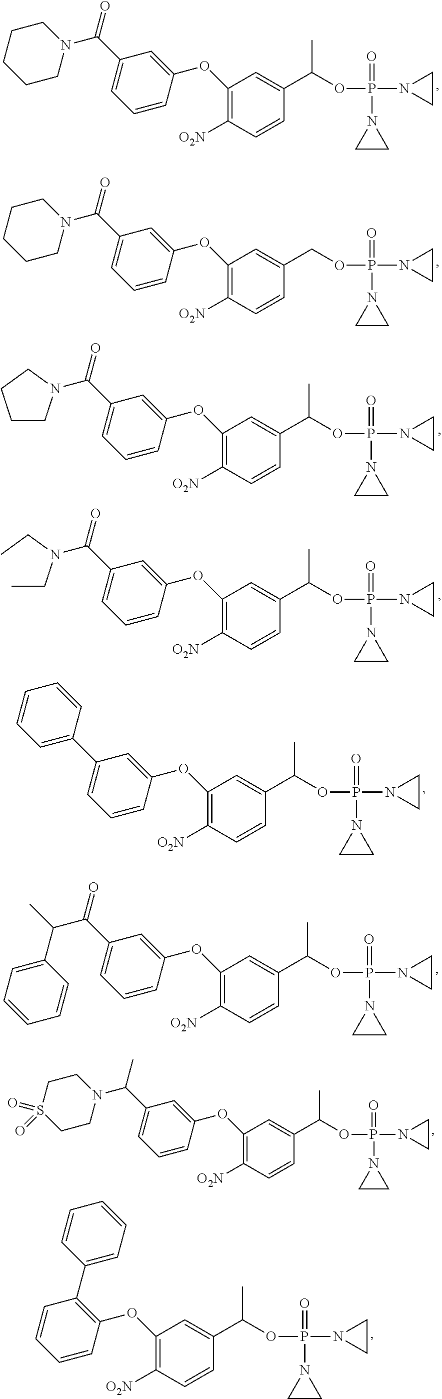

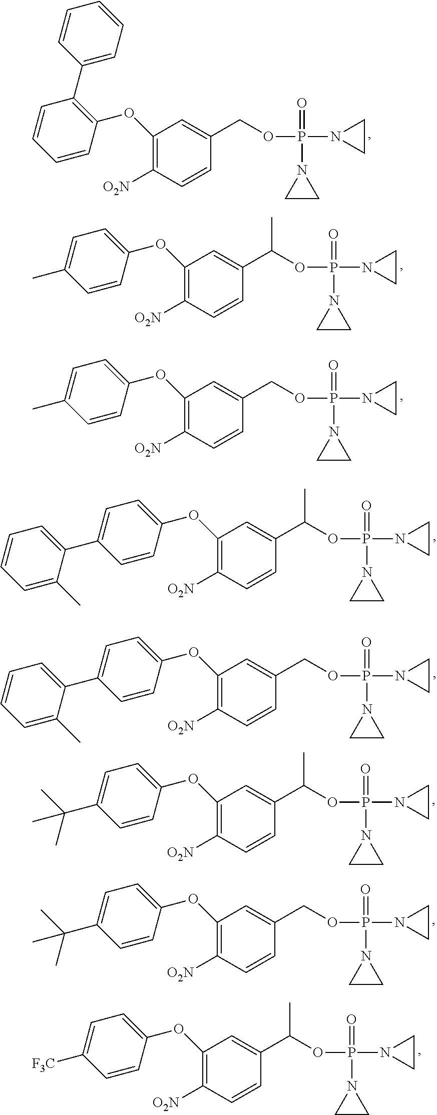

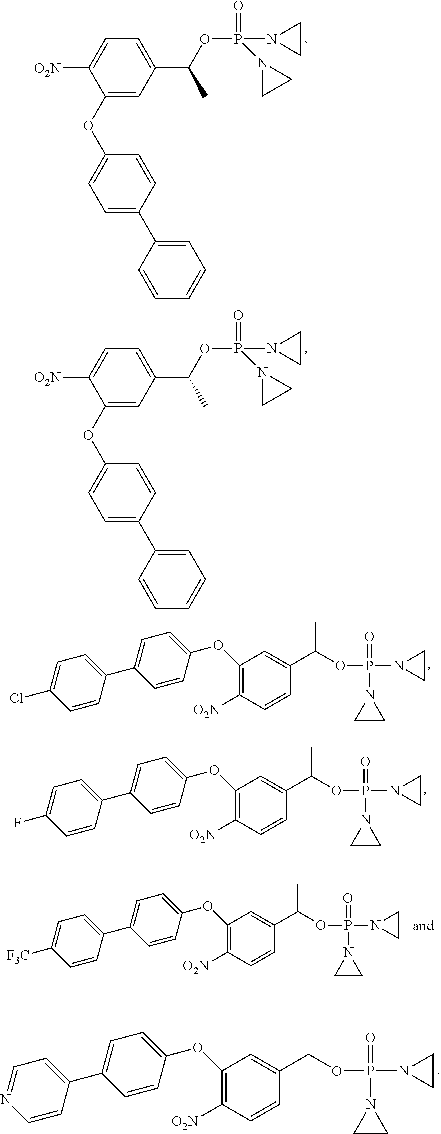

Specific definitions and meanings of the groups, and the preparation methods and spectral data of the compounds, have been described in the claims of the patent application PCT/US2016/021581 with Publication No. WO2016145092A1 (corresponding to Chinese application No. 2016800150788 with Publication No. CN107530556A), which is incorporated herein by reference in its entirety.

Evidently, the compounds of Formula 4, similar to AST-3424T, are prodrugs of a phosphoramidate alkylating agent, and can be activated by the AKR1C3 enzyme to form AST-2660 (in acid form) to exert its anti-cancer efficacy:

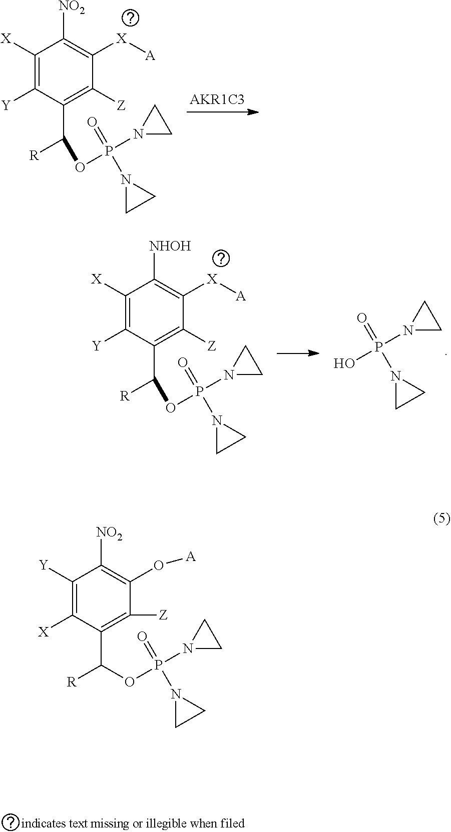

wherein:
A is substituted or unsubstituted C₆-C₁₀ aryl, biaryl or substituted biaryl, 5-15 membered heteroaryl, or —N═CR¹R²; wherein the substituents are selected from the group consisting of halogeno, —CN, —NO₂, —O—(CH₂)—O—, —CO₂H and salt thereof, —OR¹⁰⁰, —CO₂R¹⁰⁰, —CONR¹⁰¹R¹⁰², —NR¹⁰¹R¹⁰², —NR¹⁰⁰SO₂R¹⁰⁰, —SO₂R¹⁰⁰, —SO₂NR¹⁰¹R¹⁰², C₁-C₆ alkyl, and C₃-C₁₀ heterocyclyl;
wherein R¹⁰⁰, R¹⁰¹ and R¹⁰² are each independently hydrogen, C₁-C₈ alkyl, or C₆-C₁₂ aryl; or R¹⁰¹ and R¹⁰² together with the nitrogen atom to which they are attached to form a 5-7 membered heterocycle;
wherein the alkyl group and the aryl group are each substituted by 1-3 halogen groups or 1-3 C₁-C₆ alkyl groups;
R¹ and R² are each independently phenyl or methyl;
X, Y and Z are each independently hydrogen or halogeno; and
R is hydrogen or C₁-C₆ alkyl or halogen-substituted alkyl.

“Cx-Cy” or “Cx-y” before a group refers to a range of the number of carbon atoms that are present in that group. For example, C₁-C₆ alkyl refers to an alkyl group having at least 1 and up to 6 carbon atoms.

“Alkyl” refers to monovalent saturated aliphatic hydrocarbyl groups having from 1 to 10 carbon atoms and, in some embodiments, from 1 to 6 carbon atoms. “Cx-y alkyl” refers to alkyl groups having from x to y carbon atoms. This term includes (by way of example) linear and branched hydrocarbyl groups such as methyl (CH₃—), ethyl (CH₃CH₂—), n-propyl (CH₃CH₂CH₂—), isopropyl ((CH₃)₂CH—), n-butyl (CH₃CH₂CH₂CH₂—), isobutyl((CH₃)₂CHCH₂—), sec-butyl ((CH₃)(CH₃CH₂)CH—), t-butyl ((CH₃)₃C—), n-pentyl (CH₃CH₂CH₂CH₂CH₂—), and neopentyl ((CH₃)₃CCH₂—).

“Aryl” refers to an aromatic group having from 6 to 14 carbon atoms and no ring heteroatoms and having a single ring (e.g., phenyl) or multiple condensed (fused) rings (e.g., naphthyl or anthryl). For multiple ring systems, including fused, bridged, and spiro ring systems having aromatic and non-aromatic rings that have no ring heteroatoms, the term “Aryl” or “Ar” applies when the point of attachment is at an aromatic carbon atom (e.g., 5,6,7,8 tetrahydronaphthalene-2-yl is an aryl group as its point of attachment is at the 2-position of the aromatic phenyl ring). “Arylene” refers to a divalent aryl radical having the appropriate hydrogen content.

“Cycloalkyl” refers to a saturated or partially saturated cyclic group having from 3 to 14 carbon atoms and no ring heteroatoms and having a single ring or multiple rings including fused, bridged, and spiro ring systems. For multiple ring systems having aromatic and non- aromatic rings that have no ring heteroatoms, the term “cycloalkyl” applies when the point of attachment is at a non-aromatic carbon atom (e.g., 5,6,7,8,-tetrahydronaphthalene-5-yl). The term “cycloalkyl” includes cycloalkenyl groups. Examples of cycloalkyl groups include, for instance, adamantyl, cyclopropyl, cyclobutyl, cyclopentyl, cyclooctyl, and cyclohexenyl. “Cycloalkylene” refers to a divalent cycloalkyl radical having the appropriate hydrogen content.

“Halogen” refers to one or more of fluoro, chloro, bromo, and iodo.

“Heteroaryl” refers to an aromatic group having from 1 to 14 carbon atoms and 1 to 6 heteroatoms selected from the group consisting of oxygen, nitrogen, and sulfur and includes single ring (e.g. imidazolyl-2-yl and imidazole-5-yl) and multiple ring systems (e.g. imidazopyridyl, benzotriazolyl, benzimidazol-2-yl and benzimidazol-6-yl). For multiple ring systems, including fused, bridged, and spiro ring systems having aromatic and non-aromatic rings, the term “heteroaryl” applies if there is at least one ring heteroatom, and the point of attachment is at an atom of an aromatic ring (e.g., 1,2,3,4-tetrahydroquinolin-6-yl and 5,6,7,8-tetrahydroquinolin-3-yl). In some embodiments, the nitrogen and/or the sulfur ring atom(s) of the heteroaryl group are optionally oxidized to provide N-oxide (N→O), sulfinyl, or sulfonyl moieties. The term heteroaryl includes, but is not limited to, acridinyl, azocinyl, benzimidazolyl, benzofuranyl, benzothiofuranyl, benzothiophenyl, benzoxazolyl, benzothiazolyl, benzotriazolyl, benzotetrazolyl, benzisoxazolyl, benzisothiazolyl, benzothienyl, benzimidazolinyl, carbazolyl, NH-carbazolyl, carbolinyl, chromanyl, chromenyl, cinnolinyl, dithiazinyl, furanyl, furazanyl, imidazolidinyl, imidazolinyl, imidazopyridyl, imidazolyl, indazolyl, indolenyl, indolinyl, indolizinyl, indolyl, isobenzofuranyl, isochromanyl, isoindazolyl, isoindolinyl, isoindolyl, isoquinolinyl, isoquinolyl, isothiazolyl, isoxazolyl, naphthyridinyl, octahydroisoquinolinyl, oxadiazolyl, oxazolidinyl, oxazolyl, pyrimidinyl, phenanthridinyl, phenanthrolinyl, phenazinyl, phenothiazinyl, phenoxathiinyl, phenoxazinyl, phthalazinyl, piperazinyl, pteridinyl, purinyl, pyranyl, pyrazinyl, pyrazolidinyl, pyrazolinyl, pyrazolyl, pyridazinyl, pyridooxazolyl, pyridoimidazolyl, pyridothiazole, pyridinyl, pyridyl, pyrimidinyl, pyrrolyl, quinazolinyl, quinolinyl, quinoxalinyl, quinuclidinyl, tetrahydroisoquinolinyl, tetrahydroquinolinyl, tetrazolyl, thiadiazinyl, thiadiazolyl, thianthrenyl, thiazolyl, thienyl, thienothiazolyl, thienooxazolyl, thienoimidazolyl, thiophenyl, triazinyl and xanthenyl. “Heteroarylene” refers to a divalent heteroaryl radical having the appropriate hydrogen content.

“Heterocyclic” or “heterocycle” or “heterocycloalkyl” or “heterocyclyl” refers to a saturated or partially saturated cyclic group having from 1 to 14 carbon atoms and from 1 to 6 heteroatoms selected from the group consisting of nitrogen, sulfur, or oxygen and includes single ring and multiple ring systems including fused, bridged, and spiro ring systems. For multiple ring systems having aromatic and/or non-aromatic rings, the terms “heterocycle”, “heterocycle”, “heterocycloalkyl” or “heterocyclyl” apply when there is at least one ring heteroatom, and the point of attachment is at an atom of a non-aromatic ring (e.g. 1,2,3,4-tetrahydroquinoline-3-yl, 5,6,7,8-tetrahydroquinoline-6-yl, and decahydroquinolin-6-yl). In some embodiment, the heterocyclic groups herein are 3-15 membered, 4-14 membered, 5-13 membered, 7-12, or 5-7 membered heterocycles. In some other embodiment, the heterocycles contain 4 heteroatoms. In some other embodiment, the heterocycles contain 3 heteroatoms. In another embodiment, the heterocycles contain up to 2 heteroatoms. In some embodiments, the nitrogen and/or sulfur atom(s) of the heterocyclic group are optionally oxidized to provide the N-oxide, sulfmyl, sulfonyl moieties. Heterocyclyl includes, but is not limited to, tetrahydropyranyl, piperidinyl, N-methylpiperidin-3-yl, piperazinyl, N-methylpyrrolidin-3-yl, 3-pyrrolidinyl, 2-pyrrolidon-1-yl, morpholinyl, and pyrrolidinyl. A prefix indicating the number of carbon atoms (e.g., C₃₋₁₀) refers to the total number of carbon atoms in the portion of the heterocyclyl group exclusive of the number of heteroatoms. A divalent heterocyclic radical will have the appropriately adjusted hydrogen content.

“Biaryl” refers to a structure in which two aromatic rings are linked by a C—C single bond, such as biphenyl, bipyridine, and the like.

The term “optionally substituted” refers to a substituted or unsubstituted group. The group may be substituted with one or more substituents, such as e.g., 1, 2, 3, 4 or 5 substituents. Preferably, the substituents are selected from the group consisting of oxo, halogen, —CN, NO₂, —N₂+, —CO₂R¹⁰⁰, OR¹⁰⁰, —SR¹⁰⁰, —SOR¹⁰⁰, —SO₂R¹⁰⁰, —NR¹⁰⁰SO₂R¹⁰⁰, —NR¹⁰¹R¹⁰², —CONR¹⁰¹R¹⁰², —SO₂NR¹⁰¹R¹⁰², C₁-C₆ alkyl, C₁-C₆ alkoxy, —CR¹⁰⁰═C(R¹⁰⁰)₂, —CCR¹⁰⁰, C₃-C₁₀ cycloalkyl, C₃-C₁₀ heterocyclyl, C₆-C₁₂ aryl and C₂-C₁₂ heteroaryl, or a divalent substituent such as —O—(CH₂)—O—, —O—(CH₂)₂—O—, and, 1-4 methyl substituted version thereof, wherein each R¹⁰⁰, R¹⁰¹, and R¹⁰² independently is hydrogen or C₁-C₈ alkyl; C₃-C₁₂ cycloalkyl; C₃-C₁₀ heterocyclyl; C₆-C₁₂ aryl; or C₂-C₁₂ heteroaryl; or R¹⁰⁰ and R¹⁰² together with the nitrogen atom to which they are attached to form a 5-7 membered heterocycle; wherein each alkyl, cycloalkyl, heterocyclyl, aryl, or heteroaryl is optionally substituted with 1-3 halogen, 1-3 C₁-C₆ alkyl, 1-3 C₁-C₆ haloalkyl or 1-3 C₁-C₆ alkoxy groups. Preferably, the substituents are selected from the group consisting of chloro, fluoro, —OCH₃, methyl, ethyl, iso-propyl, cyclopropyl, —CO₂H and salts and C₁-C₆ alkyl esters thereof, CONMe₂, CONHMe, CONH₂, —SO₂Me, —SO₂NH₂, —SO₂NMe₂, —SO₂NHMe, —NHSO₂Me, —NHSO₂CF₃, —NHSO₂CH₂Cl, —NH₂, —OCF₃, —CF₃ and —OCHF₂.

Specifically, the compound of Formula (5) is selected from the group consisting of:

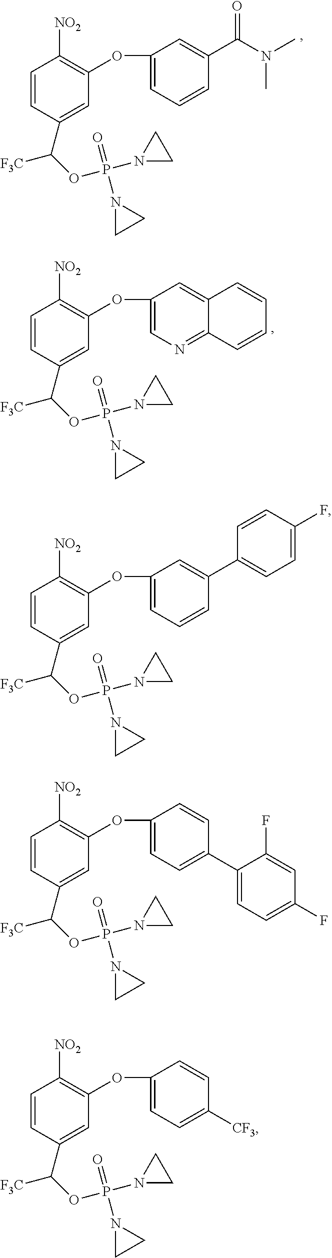 [SMILES: CN(C)C(=O)c1cccc(Oc2cc(C(OP(=O)(N3CC3)N3CC3)C(F)(F)F)ccc2[N+](=O)[O-])c1 ; O=[N+]([O-])c1ccc(C(OP(=O)(N2CC2)N2CC2)C(F)(F)F)cc1Oc1cnc2ccccc2c1 ; O=[N+]([O-])c1ccc(C(OP(=O)(N2CC2)N2CC2)C(F)(F)F)cc1Oc1cccc(-c2ccc(F)cc2)c1 ; O=[N+]([O-])c1ccc(C(OP(=O)(N2CC2)N2CC2)C(F)(F)F)cc1Oc1ccc(-c2ccc(F)cc2F)cc1 ; O=[N+]([O-])c1ccc(C(OP(=O)(N2CC2)N2CC2)C(F)(F)F)cc1Oc1ccc(C(F)(F)F)cc1]

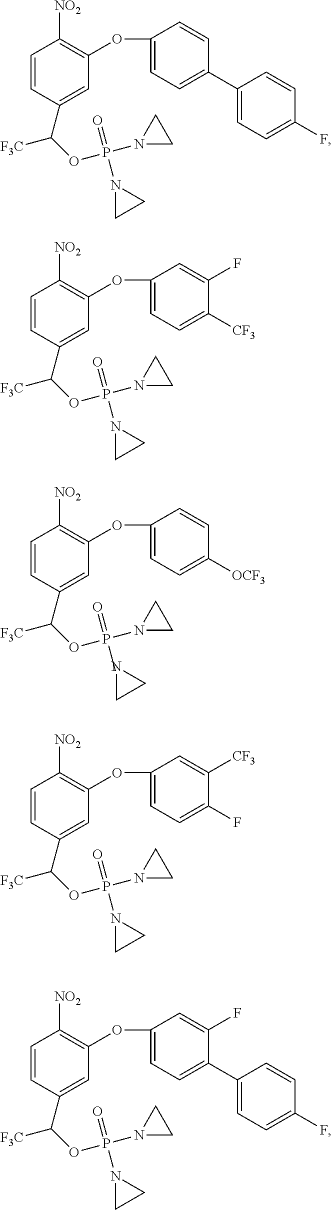

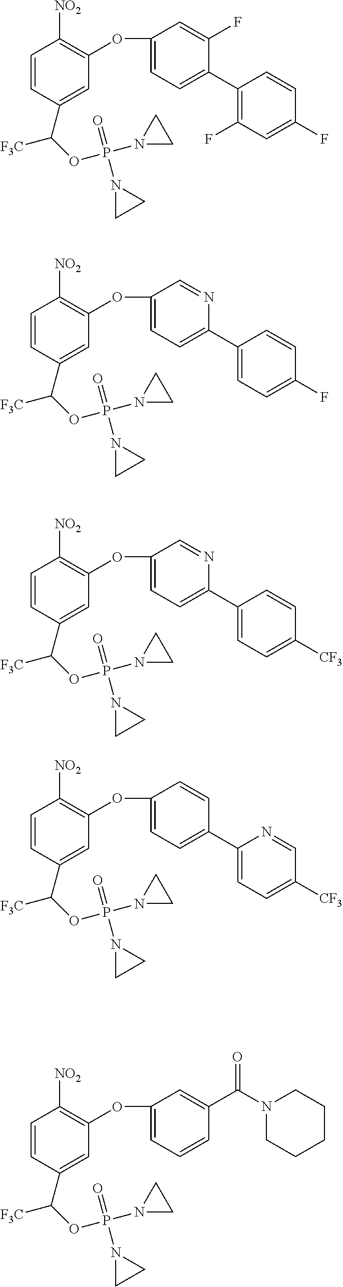 [SMILES: O=[N+]([O-])c1ccc(C(OP(=O)(N2CC2)N2CC2)C(F)(F)F)cc1Oc1ccc(-c2ccc(F)cc2F)c(F)c1 ; O=[N+]([O-])c1ccc(C(OP(=O)(N2CC2)N2CC2)C(F)(F)F)cc1Oc1ccc(-c2ccc(F)cc2)nc1 ; O=[N+]([O-])c1ccc(C(OP(=O)(N2CC2)N2CC2)C(F)(F)F)cc1Oc1ccc(-c2ccc(C(F)(F)F)cc2)nc1 ; O=[N+]([O-])c1ccc(C(OP(=O)(N2CC2)N2CC2)C(F)(F)F)cc1Oc1ccc(-c2ccc(C(F)(F)F)cn2)cc1 ; O=C(c1cccc(Oc2cc(C(OP(=O)(N3CC3)N3CC3)C(F)(F)F)ccc2[N+](=O)[O-])c1)N1CCCCC1]

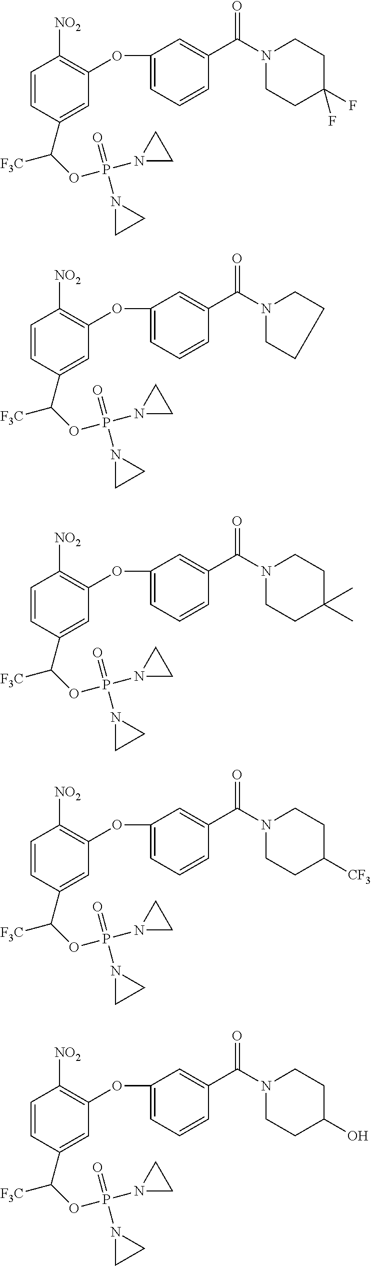 [SMILES: O=C(c1cccc(Oc2cc(C(OP(=O)(N3CC3)N3CC3)C(F)(F)F)ccc2[N+](=O)[O-])c1)N1CCC(F)(F)CC1 ; O=C(c1cccc(Oc2cc(C(OP(=O)(N3CC3)N3CC3)C(F)(F)F)ccc2[N+](=O)[O-])c1)N1CCCC1 ; CC1(C)CCN(C(=O)c2cccc(Oc3cc(C(OP(=O)(N4CC4)N4CC4)C(F)(F)F)ccc3[N+](=O)[O-])c2)CC1 ; O=C(c1cccc(Oc2cc(C(OP(=O)(N3CC3)N3CC3)C(F)(F)F)ccc2[N+](=O)[O-])c1)N1CCC(C(F)(F)F)CC1 ; O=C(c1cccc(Oc2cc(C(OP(=O)(N3CC3)N3CC3)C(F)(F)F)ccc2[N+](=O)[O-])c1)N1CCC(O)CC1]

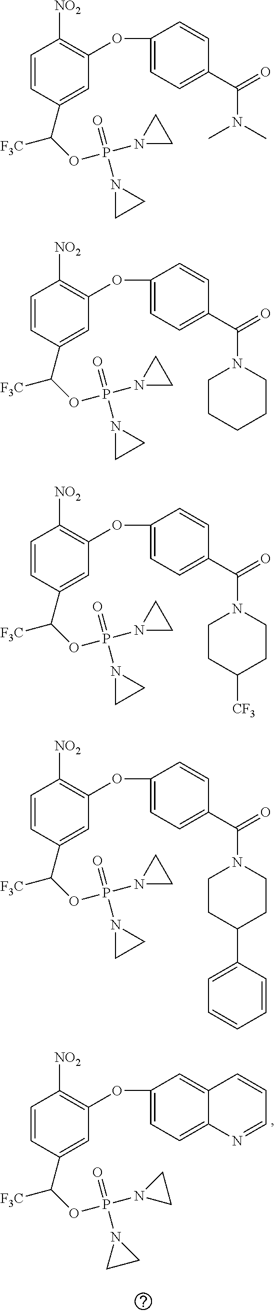

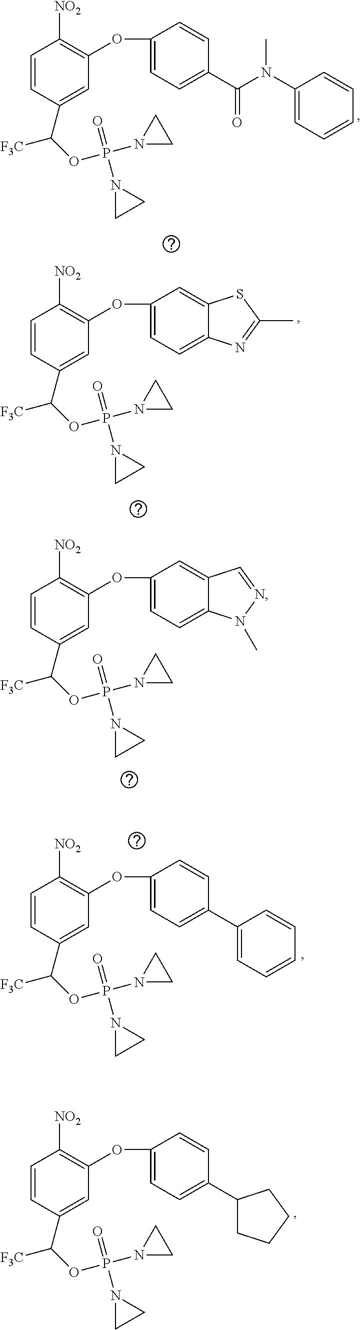 [SMILES: CN(C(=O)c1ccc(Oc2cc(C(OP(=O)(N3CC3)N3CC3)C(F)(F)F)ccc2[N+](=O)[O-])cc1)c1ccccc1 ; Cc1nc2ccc(Oc3cc(C(OP(=O)(N4CC4)N4CC4)C(F)(F)F)ccc3[N+](=O)[O-])cc2s1 ; Cn1ncc2cc(Oc3cc(C(OP(=O)(N4CC4)N4CC4)C(F)(F)F)ccc3[N+](=O)[O-])ccc21 ; O=[N+]([O-])c1ccc(C(OP(=O)(N2CC2)N2CC2)C(F)(F)F)cc1Oc1ccc(-c2ccccc2)cc1 ; O=[N+]([O-])c1ccc(C(OP(=O)(N2CC2)N2CC2)C(F)(F)F)cc1Oc1ccc(C2CCCC2)cc1]

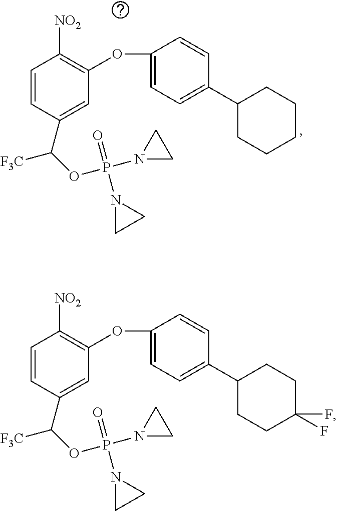 [SMILES: O=[N+]([O-])c1ccc(C(OP(=O)(N2CC2)N2CC2)C(F)(F)F)cc1Oc1ccc(C2CCCCC2)cc1 ; O=[N+]([O-])c1ccc(C(OP(=O)(N2CC2)N2CC2)C(F)(F)F)cc1Oc1ccc(C2CCC(F)(F)CC2)cc1]

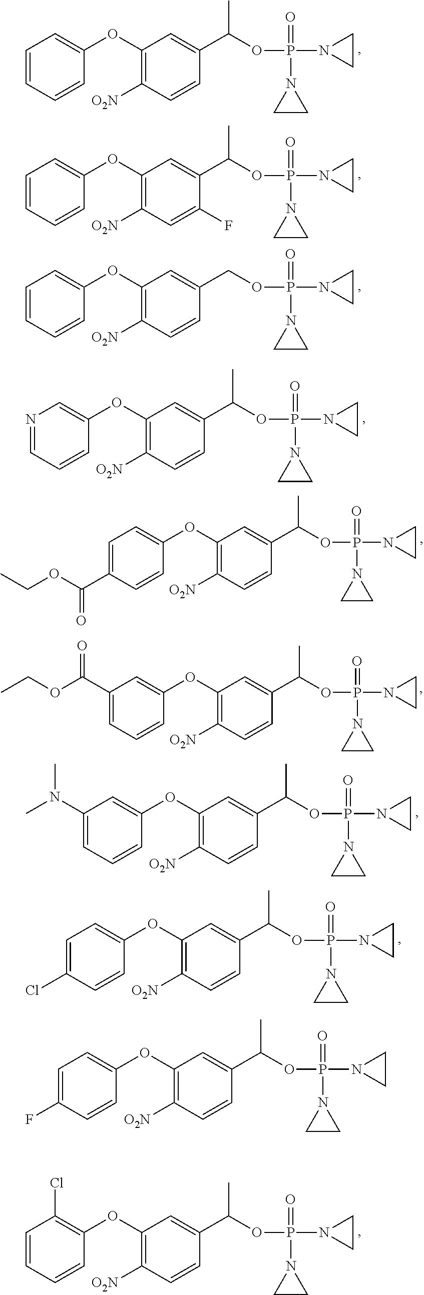

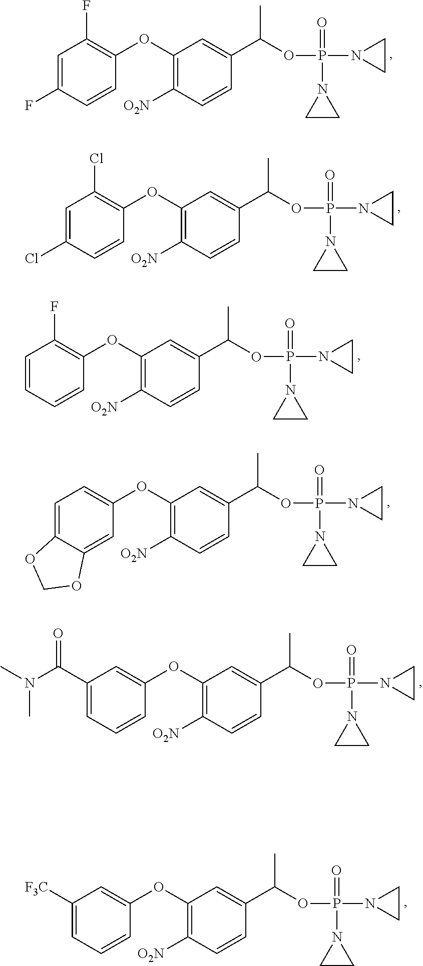

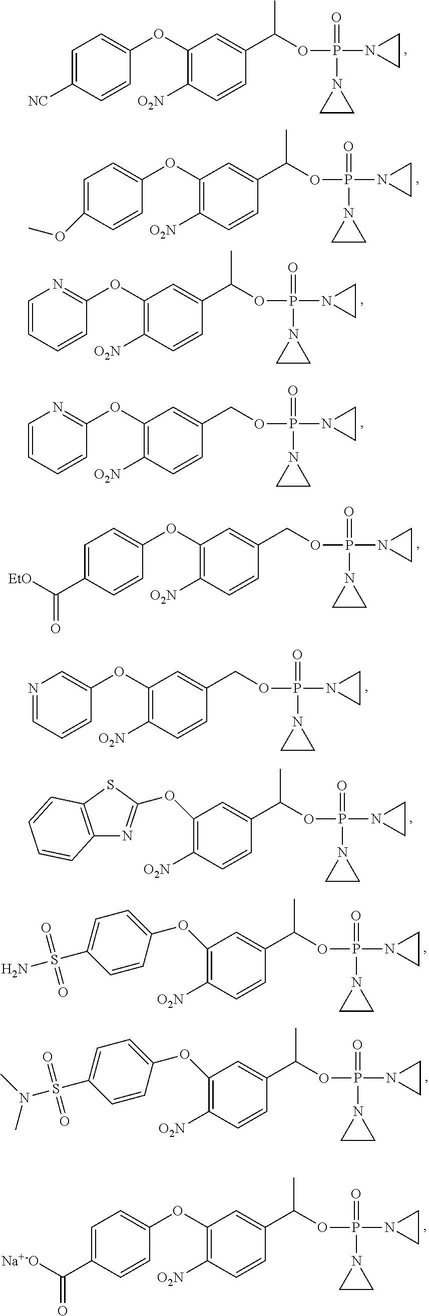

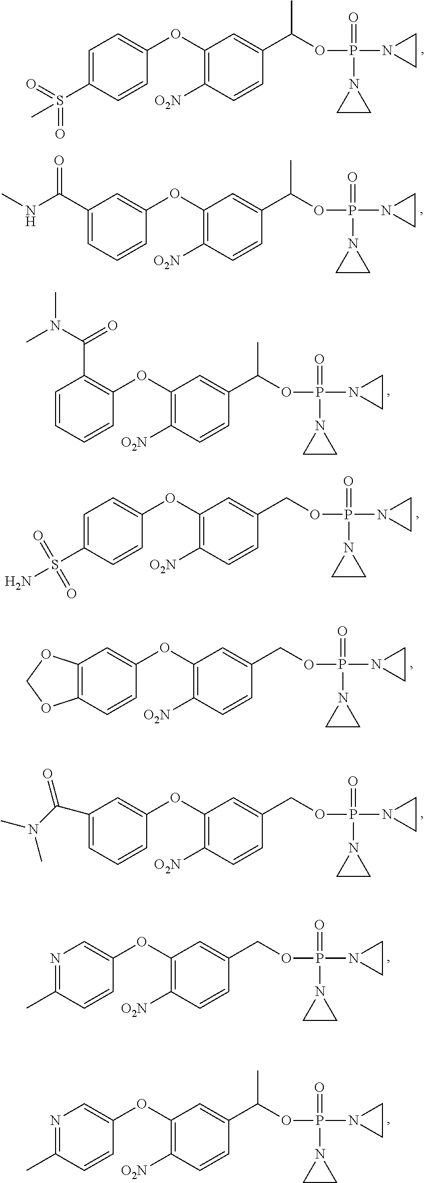

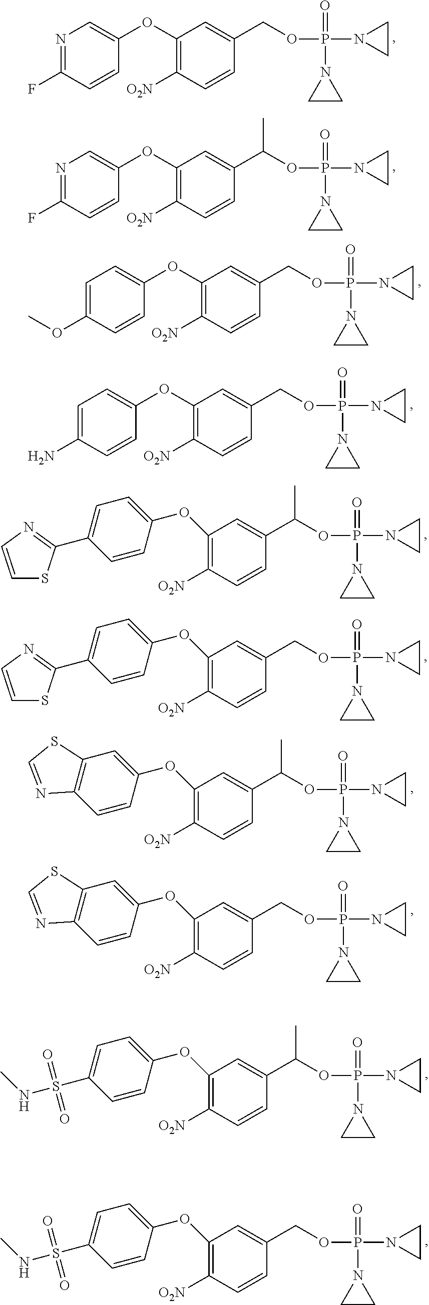

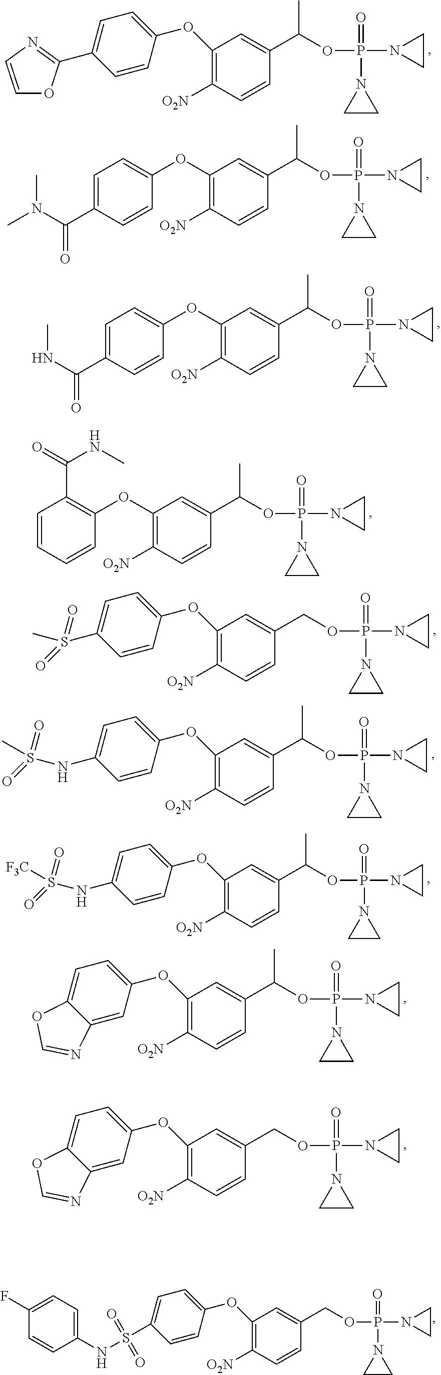

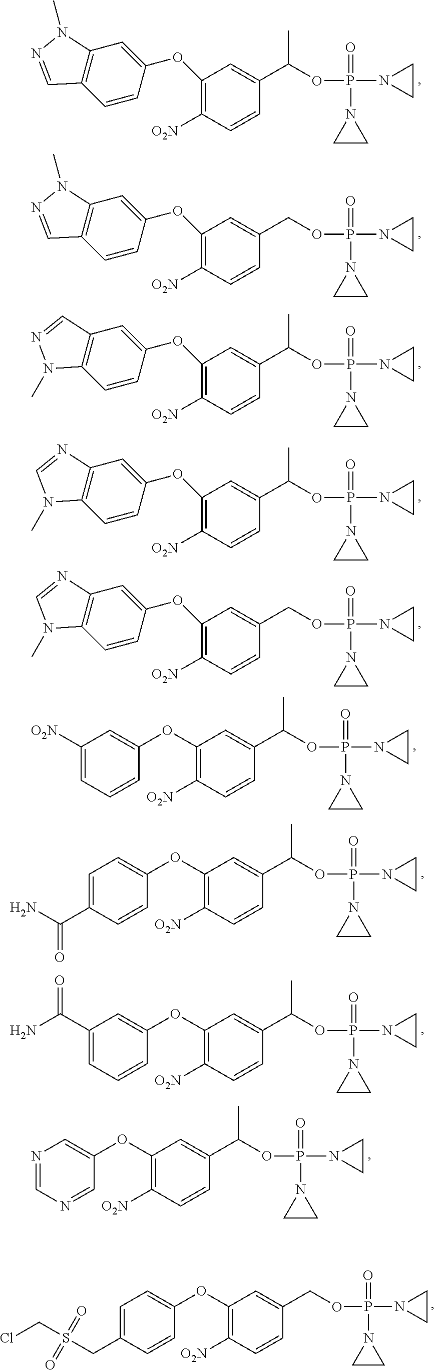

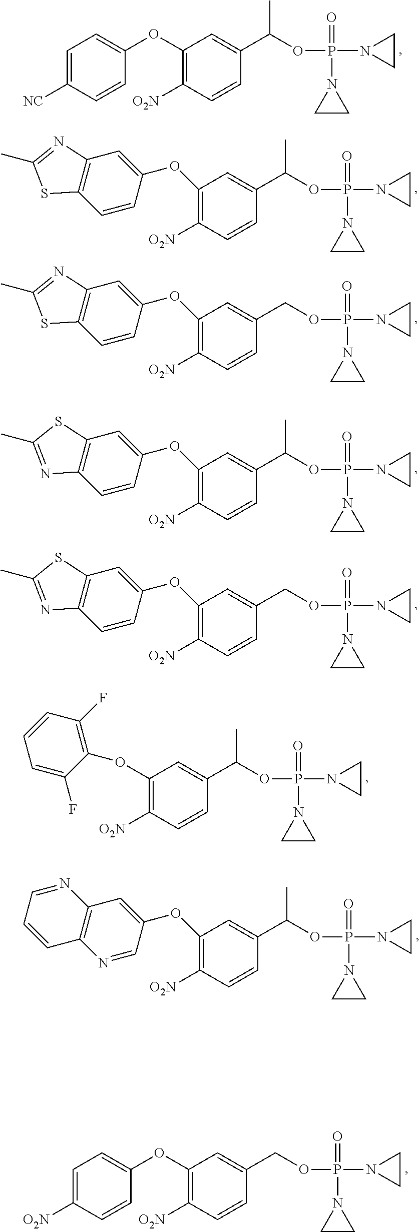

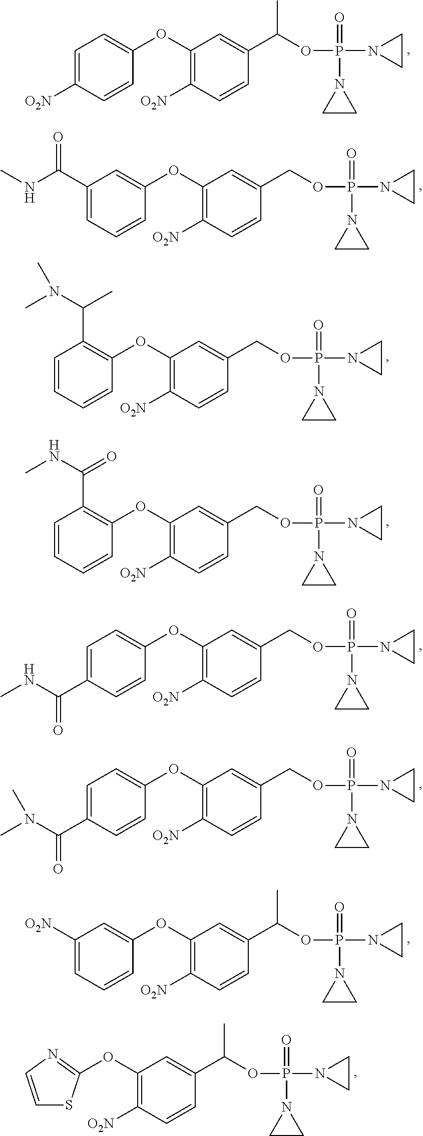

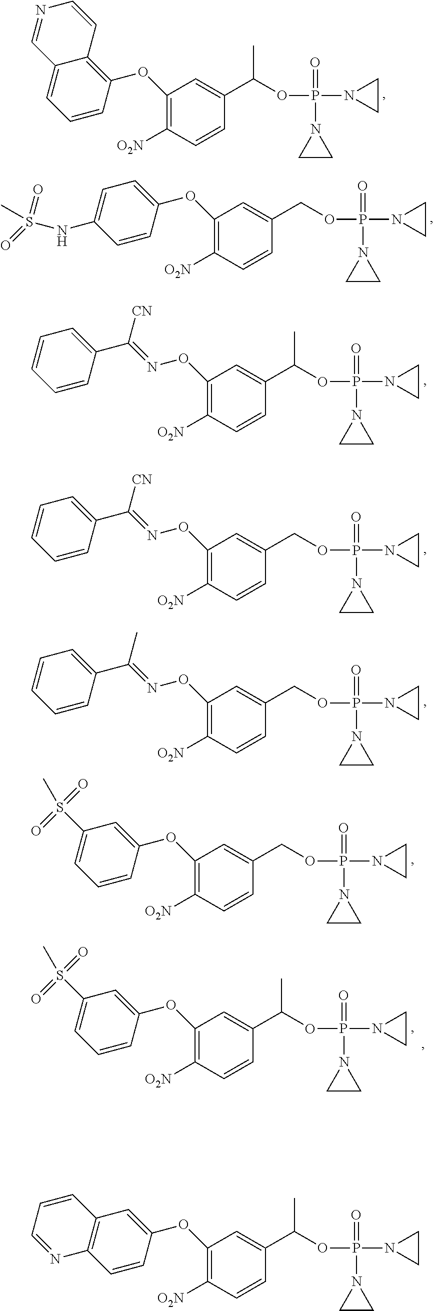

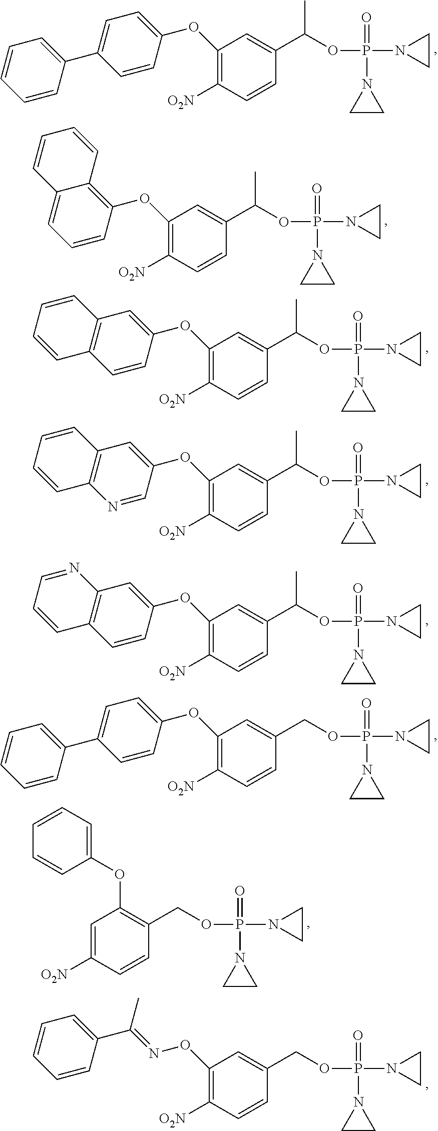

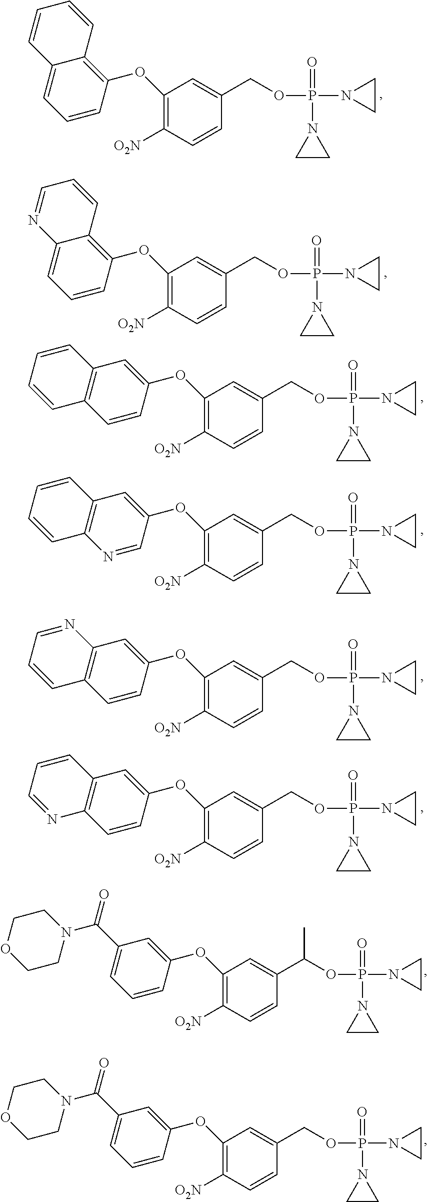

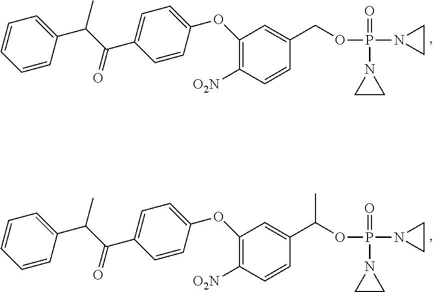 [SMILES: CC(C(=O)c1ccc(Oc2cc(COP(=O)(N3CC3)N3CC3)ccc2[N+](=O)[O-])cc1)c1ccccc1 ; CC(OP(=O)(N1CC1)N1CC1)c1ccc([N+](=O)[O-])c(Oc2ccc(C(=O)C(C)c3ccccc3)cc2)c1]

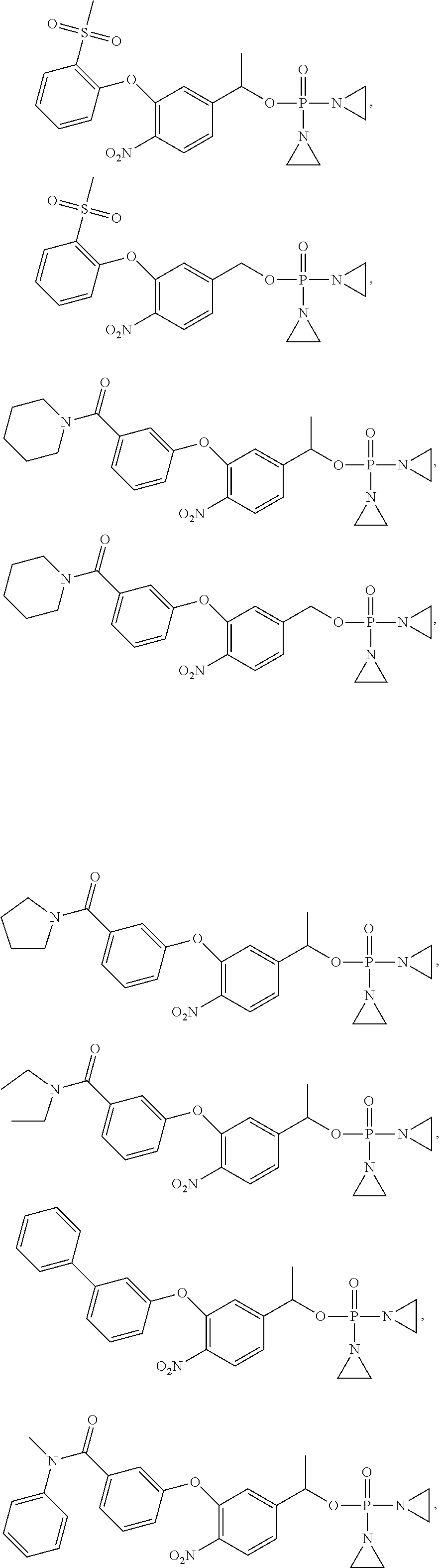

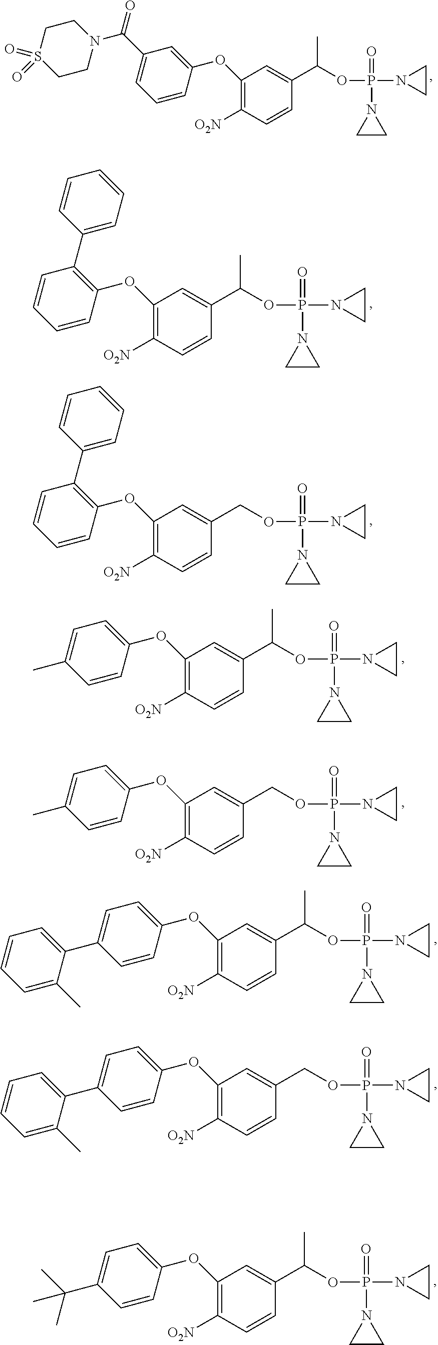

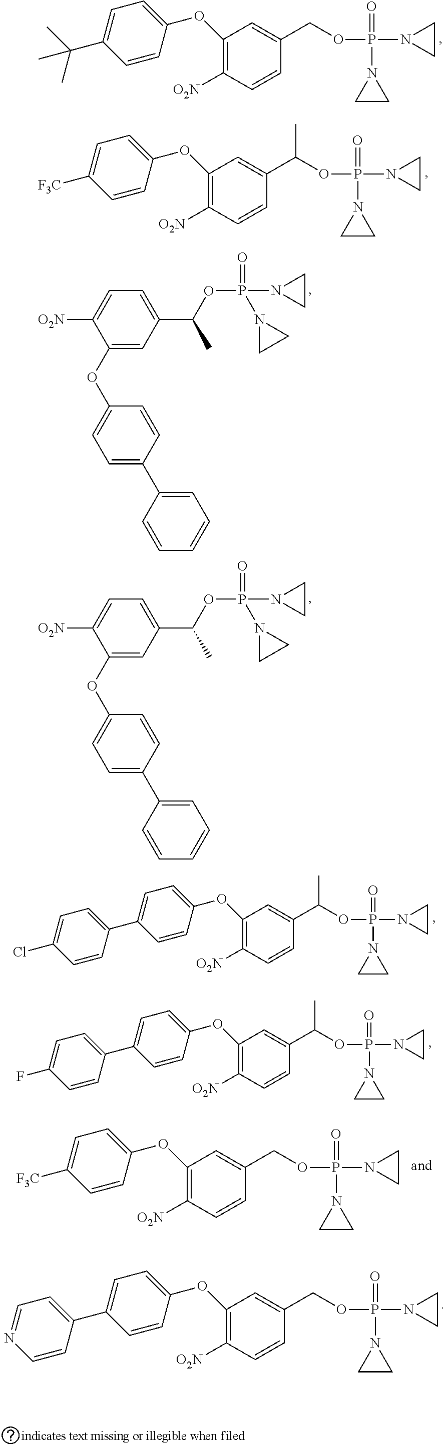

Specific definitions and meanings of the groups, and the preparation methods and spectral data of the compounds, have been disclosed in PCT/US2016/021581 with Publication No. WO2016145092A1 (corresponding to Chinese application No. 2016800150788 with Publication No. CN107530556A); PCT/US2020/120281 with Publication No. WO2021068952A1; and PCT/CN2020/089692 with Publication No. WO2020228686, which are incorporated herein by reference in its entirety.

Evidently, the compounds of Formula 6, similar to AST-3424, are prodrugs of AST-2660, and can be activated by the AKR1C3 enzyme to form AST-2660 to exert its anticancer efficacy:

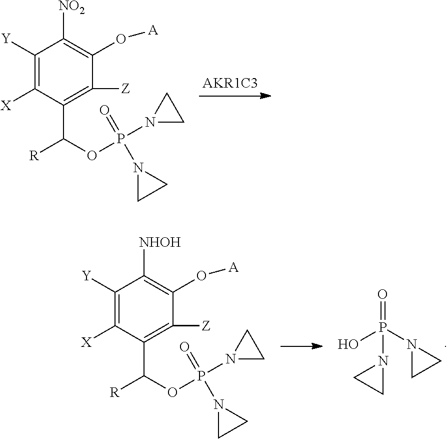

The hypoxia-activated DNA alkylating agent prodrug is selected from the group consisting of compounds having a structure as shown in the following Formulae 6-12:

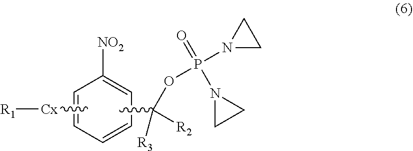

wherein the definitions of R₁, R₂, R₃ and Cx are as described in the claims of Patent Application PCT/CN2020/114519 with Publication No. WO2021120717A1; Specifically, the groups are defined as follows:
Cx is a 5-10 membered aromatic ring or aromatic heterocyclic ring, alicyclic heterocyclic ring or cycloalkane, which shares two carbon atoms with the nitrobenzene ring to form a fused ring structure;
R₁, which is attached to any skeleton atom of the Cx ring, is selected from hydrogen, halogen atom, cyano or isocyano, hydroxyl, mercapto, amine, OTs, C₁-C₆ alkyl or Z-substituted alkyl, C₂-C₆ alkenyl or Z-substituted alkenyl, C₂-C₆ alkynyl or Z-substituted alkynyl, C₃-C₈ cycloalkyl or Z-substituted cycloalkyl, C₆-C₁₀ aryl or Z-substituted aryl, 4-15-membered heterocycle or Z-substituted heterocycle, 5-15 membered heteroaryl or Z-substituted heteroaryl, alkoxy of 1-6 carbon atoms or Z-substituted alkoxy of 1-6 carbon atoms, —CONR⁶R⁷, —SO₂NR⁶R⁷, —SO₂R⁶, —OCOO—R⁶, —COOR⁶, —NR⁶COR⁷, —OCOR⁶, —NR⁶SO₂R⁷, and —NR⁶SO₂NR⁶R⁷;
R₂ and R₃ are each independently hydrogen, C₁-C₆ alkyl or Z-substituted alkyl, C₂-C₆ alkenyl or Z-substituted alkenyl, C₂-C₆ alkynyl or Z-substituted alkynyl, C₃-C₈ cycloalkyl or Z-substituted cycloalkyl, C₆-C₁₀ aryl or Z-substituted aryl, 4-15-membered heterocycle or Z-substituted heterocycle, 5-15-membered heteroaryl or Z-substituted heteroaryl, or R₂ and R₃, together with the carbon atom of benzyl to which they are bound, to form a 3-6 membered ring;

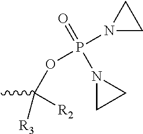

group can substitute the hydrogen atom at any position on the carbon atom of the fused ring, and the number of substitution is 1.
Z substituent is a halogen atom, cyano group or isocyano group, hydroxyl group, mercapto group, amino group, C₁-C₃ alkyl group or substituted alkyl group, C₁-C₃ alkoxy group or substituted alkoxy group, C₂-C₃ alkenyl group or substituted alkenyl group, C₂-C₃ alkynyl or substituted alkynyl, C₃-C₈ cycloalkyl or substituted cycloalkyl;
R⁶ and R⁷ are each independently hydrogen, C₁-C₆ alkyl or Z-substituted C₁-C₆ alkyl, C₂-C₆ alkenyl or Z-substituted C₂-C₆ alkenyl, C₂-C₆ alkynyl or Z-substituted C₂-C₆ alkynyl, C₃-C₈ cycloalkyl or Z-substituted C₃-C₈ cycloalkyl, C₆-C₁₀ aryl or Z-substituted C₆-C₁₀ aryl, 4-15 membered heterocyclyl or Z-substituted 4-15 membered heterocyclyl, 5-15 membered heteroaryl or Z-substituted 5-15 membered heteroaryl, or R⁶ and R⁷, together with the atom to which they are bound to form a 5-7 membered heterocyclyl or Z-substituted 5-7 membered heterocyclyl.

Specific definitions and meanings of the groups, and the preparation methods and spectral data of the compounds have been described in Patent Application PCT/CN2020/114519 with Publication No. WO2021120717A1, which is incorporated herein by reference in its entirety.

Specifically, the compound of Formula (6) is selected from the group consisting of:

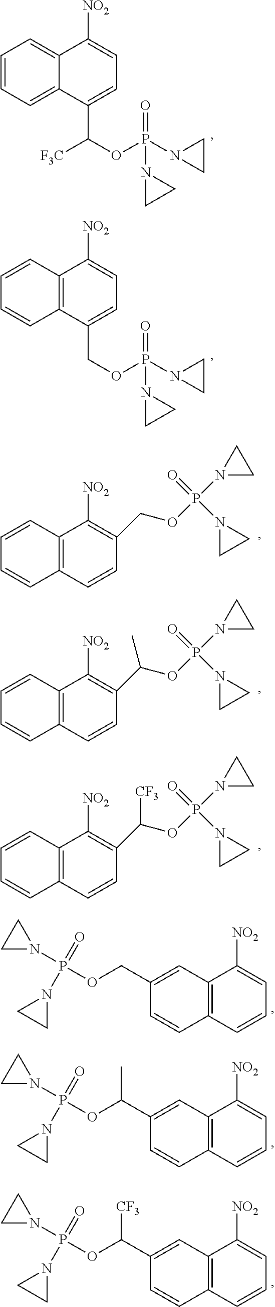

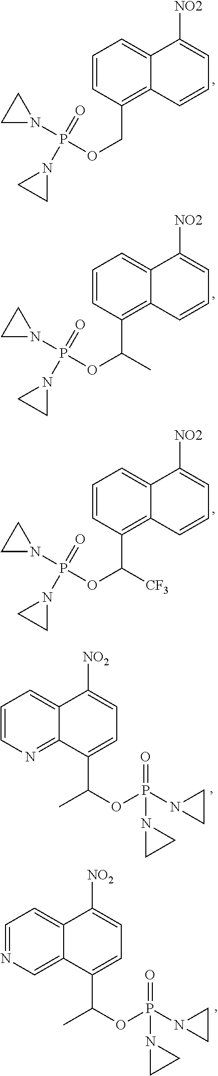

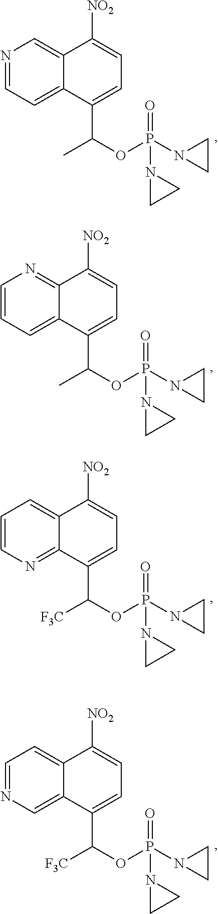

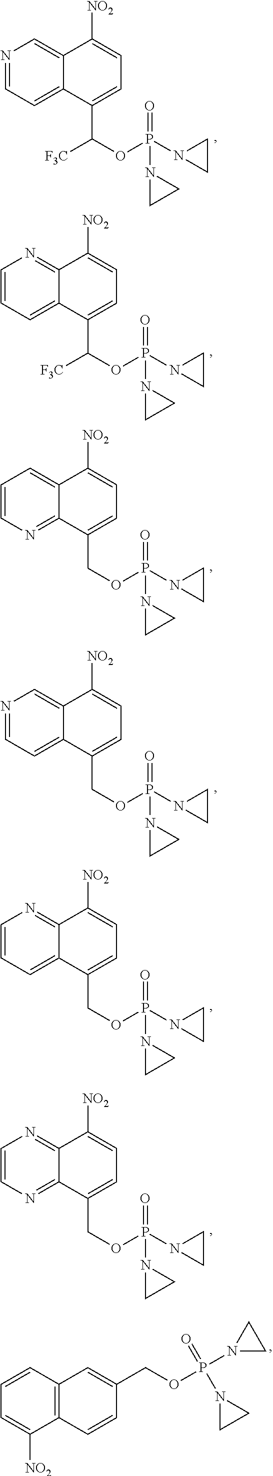

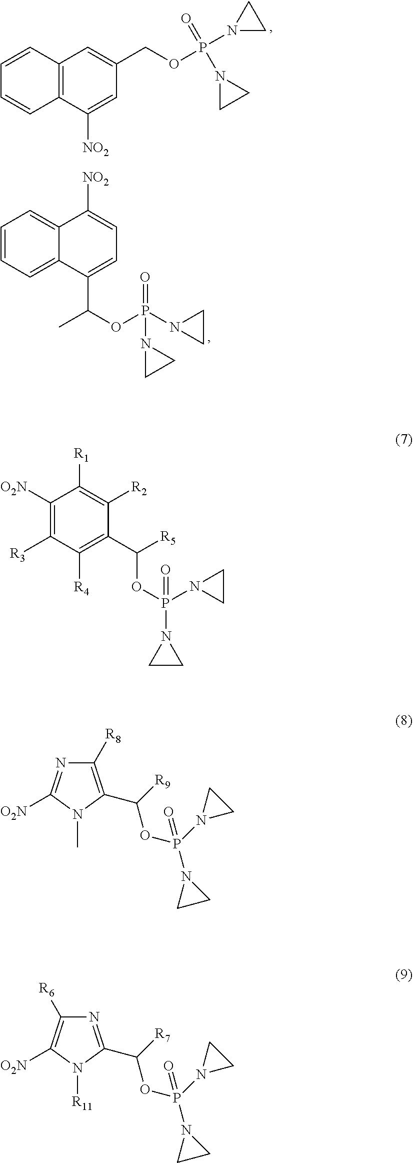

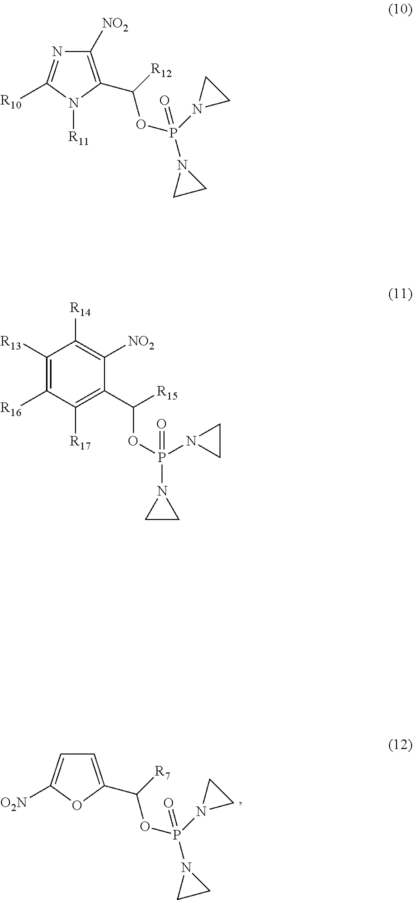

wherein, the definitions of R₁, R₂, R₃, R₄, R₅, R₆, R₇, R₈, R₉, R₁₀, R₁₁, R₁₂, R₁₃, R₁₄, R₁₅, R₁₆, and R₁₇ are as described in the claims of the patent application PCT/US2016/039092 with Publication No. WO2016210175A1 (corresponding to the Chinese application No. 2016800368985 with Publication No. CN108024974A). Specifically, the groups are defined as follows:
R₁ is hydrogen, —N₃, CN, halogen, NR²¹R²², —OR²³ , —SO₂(C₁-C₆ alkyl), C₁-C₆ alkyl, C₂-C₆ alkenyl, C₂-C₆ alkynyl, C₃-C₈ cycloalkyl, C₆-C₁₀ aryl, 4-15 membered heterocycle, 5-15 membered heteroaryl, or ether;
   each R²¹ and R²² independently is hydrogen, hydroxy, C₁-C₆ alkyl, C₂-C₆ alkenyl, C₂-C₆ alkynyl, C₃-C₈ cycloalkyl, C₆-C₁₀ aryl, 4-15 membered heterocycle, 5-15 membered heteroaryl, or —SO₂(C₁-C₆ alkyl); or R²¹ and R²² together with the nitrogen atom they are bonded to form a 4-15 membered heterocycle or a 5-15 membered heteroaryl;
R²³ is hydrogen, C₁-C₆ alkyl, or C₆-C₁₀ aryl;
R₂ and R₃ are independently hydrogen or halogen;
R₄ is hydrogen, halogen, C₁-C₆ alkoxy, C₁-C₆ alkyl, or C₆-C₁₀ aryl,
R₅, R₇, R₉, R₁₂, and R₁₅ independently are hydrogen, C₁-C₆ alkyl, C₂-C₆ alkenyl, C₂-C₆ alkynyl, C₃-C₈ cycloalkyl, C₆-C₁₀ aryl, 4-15 membered heterocycle, 5-15 membered heteroaryl; or R₄ and R₅ together with the intervening carbon atoms between them to form a C₅-C₆ cycloalkyl ring;
R₆ and R₁₀ are independently hydrogen or halogen;
R₈ is hydrogen, C₁-C₆ alkyl, C₂-C₆ alkenyl, C₂-C₆ alkynyl, or 5-15 membered heteroaryl;
each R₁₁ independently is C₁-C₆ alkyl, C₂-C₆ alkenyl, C₂-C₆ alkynyl, C₃-C₈ cycloalkyl, or C₆-C₁₀ aryl;
R₁₃, R₁₄, R₁₆, and R₁₇ are independently hydrogen, halogen, C₁-C₆ alkyl, C₂-C₆ alkenyl, C₂-C₆ alkynyl, or C₁-C₆ alkoxy;
   wherein the alkyl, alkenyl, alkynyl, cycloalkyl, aryl, heterocycle, heteroaryl, alkoxy and ether groups are optionally substituted.

Specific definitions and meanings of the groups, and the preparation methods and spectral data of the compounds, have been described in the patent application PCT/US2016/039092 with Publication No. WO2016210175A1 (corresponding to Chinese application No. 2016800368985 with Publication No. CN108024974A), which is incorporated herein by reference in its entirety.

In particular, the compounds of Formulae (7)-(12) are selected from the compounds as specifically disclosed in the above-mentioned patent applications.

Evidently, the “compound” in the above-mentioned Chemical Formulae 1-12 as disclosed herein also includes the compound itself as well as solvate, salt, ester or isotopic isomer thereof.

The present invention further provides a method for measuring the content of a metabolite in a biological sample, comprising the steps of:

preparing a solution to be tested containing an internal standard compound with known concentration for injection analysis by LC-MS/MS;

preparation of a standard working solution: preparing a series of standard working solutions containing an internal standard compound with known concentration and a metabolite II with known concentration, wherein the concentration of the internal standard compound in the series of standard working solutions is consistent and the same as the concentration of the internal standard compound in the solution to be tested, and the concentration of the metabolite II in the series of standard working solutions is different;

determining a relationship function by liquid chromatography-tandem mass spectrometry (LC-MS/MS): absorbing the prepared standard working solutions of metabolite II with different concentrations, and injecting them into the LC-MS/MS system for detection to obtain the relationship function y=f (x), wherein y represents the ratio of the peak area of the metabolite II to that of the internal standard compound, and x represents the concentration of the metabolite II in the standard working solutions;

determining and calculating the concentration of the metabolite II in the solution to be tested with unknown concentration by using the relationship function: absorbing the solution to be tested added with the internal standard compound with known concentration, injecting it into the LC-MS/MS system for detection to obtain the ratio y of the peak area of the metabolite II to that of the internal standard compound, substituting it into the function y=f (x) to obtain the concentration x of the metabolite II in the solution to be tested;

wherein the solution to be tested is prepared from the biological sample with or without treatment;

wherein the internal standard compound is a deuterated compound I, which has a structure as shown in Formula (I):

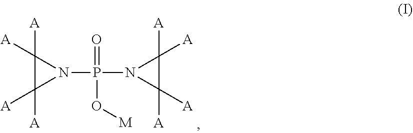

A is H or D, and at least one of eight As is D;

M is H or an alkali metal, an alkaline earth metal, or an ammonium radical;

wherein the metabolite II has a structure as shown in Formula (II):

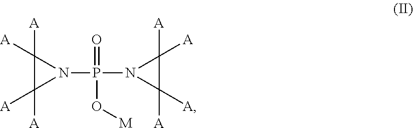

A is H;

M is H or an alkali metal, an alkaline earth metal, or an ammonium radical.

This invention further provides a method for measuring the content of the metabolite in a biological sample, comprising the steps of:

adding a quantitative internal standard compound to a biological sample solution to be tested and taking it as a solution to be tested after extraction treatment;

diluting a metabolite II reference substance to obtain a series of solutions of metabolite II with different concentrations, adding the quantitative internal standard compound and taking it as a standard working solution after extraction treatment, absorbing the series of standard working solutions, respectively injecting them into an LC-MS/MS system for detection to obtain the peak area of the metabolite II and the internal standard compounds, taking the ratio of the peak area of the metabolite II to that of the internal standard compounds as an ordinate and taking the concentration of the metabolite II as an abscissa to draw a standard curve and calculate a regression equation;

absorbing the solution to be tested, injecting it into the LC-MS/MS system for detection to obtain the ratio of the peak area of the metabolite II to that of the deuterated compound I in the solution to be tested, substituting it into the regression equation to obtain the content of the metabolite II in the solution to be tested;

wherein the internal standard is a deuterated compound I, which has a structure as shown in Formula (I):

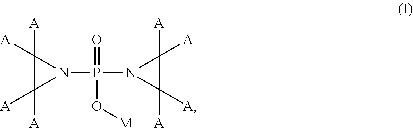

A is H or D, and at least one of eight As is D;

M is H or an alkali metal, an alkaline earth metal, or an ammonium radical;

wherein the metabolite II has a structure as shown in Formula (II):

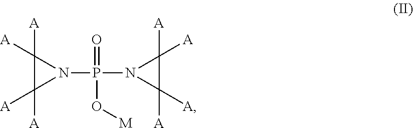

A is H;

M is H or an alkali metal, an alkaline earth metal, or an ammonium radical.

Preferably, the conditions for liquid chromatography in liquid chromatography-tandem mass spectrometry are as follows:

a hydrogen acceptor type stationary phase chromatography column is used; mobile phase A is methanol solution of ammonium acetate, and mobile phase B is acetonitrile;

mobile phases A and B are used for gradient elution: gradually increasing from 15% by volume ratio to 90% by volume ratio of mobile phase A, and then gradually decreasing to 15% by volume ratio of mobile phase A;

the mass spectrometry conditions: electrospray ion source;

in negative ion scanning mode

the monitoring ion pair of the metabolite II is: m/z 147.0→m/z 62.9;

the monitoring ion pair of the deuterated compound I is: m/z (147.0+number of deuteration)→m/z 62.9; or

in positive ion scanning mode

the monitoring ion pair of the metabolite II is: m/z 149.0→m/z 64.9;

the monitoring ion pair of the deuterated compound I is: m/z (149.0+number of deuteration)→m/z 64.9.

If positive ion scanning mode is used, it is recommended to add an acid (such as formic acid) in the corresponding mobile phase.

Preferably, in the preparation of the solution to be tested containing the deuterated compound I (the internal standard compound) with known concentration, the deuterated compound I is firstly added into the biological sample solution and then the extraction operation is performed;

Correspondingly, in the preparation of the standard working solution, the deuterated compound I is firstly added into a matrix solution containing metabolites II with known different concentrations and then the extraction operation is performed.

Preferably, the biological sample is a urine sample or a plasma sample, and correspondingly, when the urine sample is measured, the corresponding matrix solution is the urine of a patient with an additive and without administration; when the blood sample is measured, the corresponding matrix solution is the plasma of a patient with an anticoagulant and without administration.

The operation process for the addition of the deuterated compound and extraction is as follows: the solution to be tested and the standard work solution are added into the solution of the deuterated compound I, methanol is added and mixed uniformly, and a supernatant is obtained by centrifugation.

The additive is Na₂HPO₄ or K₂HPO₄; and the anticoagulant is K₂EDTA or Na₂EDTA.

For the blood samples, they should be stored in an environment below −20° C., preferably in an environment at −70° C. within 4 hours after collection and can be stored for 28 days at −70° C.; if treated, they should be refrigerated at 4° C. or below and an injection detection should be completed within 54 hours.

For the urine samples, they should be stored at −70° C. within 24 hours, preferably within 4 hours, after collection and can be stored for 32 days at −70° C.; if treated, the injection detection should be completed within 94 hours at room temperature or below.

### BRIEF DESCRIPTION OF THE DRAWINGS

FIG. 1 is a ³¹P-NMR spectrum of AST-2660-D8-sodium salt.

FIG. 2 is ³¹P-NMR spectra of the first portion of an aqueous solution of AST-2660-D8-sodium salt, which were scanned for 64, 128, 256, and 512 times, respectively, as shown in Figures a, b, c, and d, respectively.

FIG. 3 is ³¹P-NMR spectra at time zero, which are AST-2660-D8 sodium salt solution at −20° C. (Figure a) and AST-2660-D8 sodium salt solution at −78° C. (Figure b), respectively.

FIG. 4 is ³¹P-NMR spectra after 48 hours, which are AST-2660-D8 sodium salt solution at −20° C. (Figure a), and AST-2660-D8 sodium salt solution at −78° C. (Figure b), respectively.

FIG. 5 is a ³¹P-NMR spectrum of an aqueous solution of AST-2660-D8 sodium salt after storage at −20° C. for 6 months.

FIG. 6 is a ³¹P-NMR spectrum of an aqueous solution of AST-2660-D8 sodium salt after storage at −78° C. for 6 months.

FIG. 7 is typical LC-MS/MS spectra of AST-2660 (Figure a) and the internal standard AST-2660-D8 (Figure b) in blank human plasma extracts.

FIG. 8 is typical LC-MS/MS spectra of AST-2660 (Figure a) and the internal standard AST-2660-D8 (Figure b) in zero concentration of plasma sample extracts.

FIG. 9 is typical LC-MS/MS spectra of AST-2660 (Figure a) and the internal standard AST-2660-D8 (Figure b) in standard sample solution of human plasma extracts (0.50 ng/ml).

FIG. 10 is typical LC-MS/MS spectra of AST-2660 (Figure a) and the internal standard AST-2660-D8 (Figure b) in standard sample solution of human plasma extracts (200 ng/ml).

FIG. 11 is typical LC-MS/MS spectra of AST-2660 and the internal standard AST-2660-D8 in blank human urine extracts.

FIG. 12 is typical LC-MS/MS spectra of AST-2660 and the internal standard AST-2660-D8 in zero concentration of urine sample extracts.

FIG. 13 is typical LC-MS/MS spectra of AST-2660 and the internal standard AST-2660-D8 in standard working solution of human urine extracts (0.50 ng/ml).

FIG. 14 is typical LC-MS/MS spectra of AST-2660 and the internal standard AST-2660-D8 in standard working solution of human urine extracts (200 ng/ml).

In the graphs of FIGS. 8 to 14, the abscissa is the time, the ordinate is the mass spectrum ion intensity of LC-MS/MS, and the mass spectrum ion is the selected ion.

### DETAILED DESCRIPTION OF THE INVENTION

It should be noted that, unless defined otherwise, all technical or scientific terms used in one or more embodiments of the present specification shall have the meaning commonly understood by a person skilled in the art to which the invention belongs.

The experimental methods in the following examples are conventional methods unless specified otherwise. The medicinal raw materials, reagent materials, etc. used in the following examples are all commercially available products unless specified otherwise.

The AST-3424 drug developed by the applicant is a prodrug of the DNA alkylating agent AST-2660, which is specifically activated by the AKR1C3 enzyme that is highly expressed in cancer cells and metabolized to AST-2660 to exert its medicinal effect. As shown in the background section, in human clinical trials, it is necessary to measure the contents of drugs and drug metabolites in biological samples (such as blood, urine and tissues) of a subject, and further conduct Drug Metabolism and Pharmacokinetics (DMPK) studies based on the measured contents of drugs and drug metabolites. However, AST-3424 is used in the clinic trails in relatively low amount, from 1 mg to 100 mg. The internal standard or external standard method used in conventional liquid chromatography cannot satisfy the requirements for quantitative analysis under the lower limit of quantitation. Therefore, there is a need for developing an assay method which can meet the requirements for the lower limit of quantitation.

In order to solve the technical problem as described above, the applicant attempts to quantify the low content of AST-2660 in biological samples using internal standard quantification method. The internal standard method is a rather accurate quantitative method in chromatographic analysis. The internal standard method is to add a certain amount of pure substance to a certain amount of the sample mixture to be analyzed, analyze the sample containing the internal standard substance using chromatography, then determine the peak area of the internal standard and the component to be measured, respectively, and calculate the percentage of the component to be measured in the sample. It is very important for the selection of the internal standard. Ideally, the internal standard should be a known compound that can be obtained in pure form so that it can be added to the sample in an accurate and known amount; and it should have substantially the same or as close as possible chemical and physical properties (such as chemical structure, polarity, volatility and solubility in solvents, etc.), chromatographic behavior, and response characteristic as those of the analyte, preferably, a homologue of the analyte. Certainly, the internal standard must be sufficiently separated from the each component in the sample under the chromatographic conditions. For the quantitative analysis of internal standard method, it is very important for the selection of internal standard. It must meet the following requirements:
1. The internal standard should have similar physical and chemical properties (such as boiling point, polarity, and chemical structure, etc.) to those of the analyte;
2. The internal standard should be a pure substance which is not present in the test sample;
3. The internal standard must be completely dissolved in the test sample (or solvent), and does not chemically react with the test sample; and the peak of the internal standard can be completely separated from that of each component in the test sample;
4. The possible amount of the internal standard added is close to that of the measured component;
5. The position of the chromatographic peak of the internal standard should be close to that of the measured component, or in the middle of the positions of the chromatographic peaks of the several measured component without co-overflow. The purpose is to avoid the difference in sensitivity caused by the instability of the instrument; and
6. The suitable amount of the internal standard added is selected such that the matching of the peak area between the internal standard and the analyte is greater than 75% so as to avoid sensitivity deviations owing to their being in different response value regions.

In this application, many similar compounds of AST-2660 were screened, and the deuterated compound I was finally screened as the internal standard for the detection of metabolite II. The liquid chromatography-tandem mass spectrometry (LC-MS/MS) method which is established using deuterated compound I has a lower detection limit: as low as 0.5 ng/ml. Moreover, the liquid chromatography-tandem mass spectrometry (LC-MS/MS) method which is established using deuterated compound I according to the present application can be used to measure the content of the metabolite AST-2660 in human plasma and urine. The method meets the analysis requirements of biological sample: the sample processing method is simple and convenient; and this method has high sensitivity, precision, and accuracy.

The technical solutions provided by the present invention will be further described below with reference to specific embodiments. The following examples are only used to illustrate the present invention, and do not limit the protection scope of the present invention.

| | |
|---|---|
| Acq. | Acquisition |
| Amu | Atomic mass unit |
| ° C. | Degree Celsius (the reported temperature |
| | is a normal value) |
| Cat # | Catalog number |
| CID | Collision-Induced Dissociation |
| cm | centimeter |
| Conc. | Concentration |
| cps | counts per second |
| CV | Coefficient of Variation |
| % Dev | Deviation percentage |
| dil. | Dilution |
| DilQC | Dilution of quality control sample |
| eV | Electron volt |
| FDA | U.S. Food and Drug Administration |
| g | gram |
| GMQC | Geometric mean of QC sample |
| h or hr | hour |
| HPLC | High Performance Liquid Chromatography |
| Int. | Integral |
| IS | Internal Standard |
| ISWS | Internal standard working solution |
| LC/MS/MS | Liquid chromatography (method) and |
| | tandem mass spectrometry (method) |
| LIMS | Laboratory Information Management System |
| LLOQ | Lower limit of quantification |
| μL | Microliter |
| μm | Micrometer |
| M | Mole |
| Max. | Maximum |
| mg | Milligram |
| min | Minute |
| Min. | Minimum |
| ml | Milliliter |
| mm | Millimeter |
| mm | Millimole |
| ms | Millisecond |
| NA or N/A | Not available |
| PSS | Processed Sample Stability |
| QC | Quality Control sample |
| r² | coefficient of determination |
| RCF | Relative centrifugal force |
| RE | Relative error |
| rpm | Revolution per minute |
| RT | Retention time |
| SD | Standard Deviation |
| SOP | Standard Operation Process |
| SRM | Selected Reaction Monitoring (SRM) |
| STD | Standard sample calibration |
| t | Time |
| TBD | To be determined |
| temp. | temperature |
| UHP | Ultra-high purity |
| ULOQ | Upper limited of quantification |
| v | version |
| V | Volt |
| WBS | Whole Blood Stability |
| WS | Working solution |
| 5° C. | Temperature in the range from 2 to 8° C. |
| −20° C. | Temperature in the range from −30 to −10° C. |
| −70° C. | Temperature in the range from −90 to −60° C. |
| v | version |
| V | Volt |
| WS | Working solution |
| 5° C. | Temperature in the range from 2 to 8° C. |
| −20° C. | Temperature in the range from −30 to −10° C. |
| −80° C. | Temperature in the range from −90 to −60° C. |
| PSAE | Pre-study assay evaluation |
| WS | Working solution |
| −5° C. | Temperature in the range from 2 to 8° C. |
| −20° C. | Temperature in the range from −30 to −10° C. |
| −80° C. | Temperature in the range from −90 to −60° C. |
| m/z | mass-to-nucleus ratio |
| ng | Nanogram |

### General List of Acronyms

### Example 1 Synthesis of AST-2660-D8-Sodium Salt

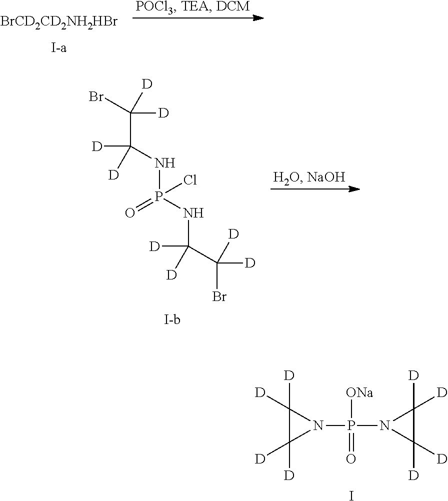

Deuterated 2-bromoethylamine hydrobromide (360 mg, 1.72 mmol) and phosphorous oxychloride (132 mg, 0.86 mmol) were added to anhydrous dichloromethane (4 mL) (firstly deuterated 2-bromoethylamine hydrobromide was added, then phosphorus oxychloride was added) under the protection of nitrogen. When the temperature of the reaction mixture was lowered to −78° C., triethylamine (348 mg, 3.44 mmol) in dichloromethane solution (2 mL) was added dropwise. The reaction mixture was kept at −78° C. for 30 min, the temperature of the reaction mixture was naturally raised to 0° C., and then the reaction mixture was kept at 0° C. for 4 hours. Then the solid was quickly filtered off with suction. The mother liquor was concentrated at a low temperature and was directly used in the next step.

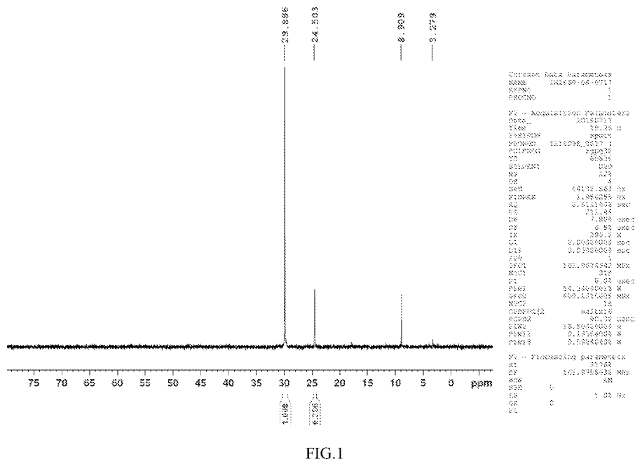

The crude product obtained in the above steps was dissolved in water (30.8 mL), and a solid sodium hydroxide (275 mg, 6.88 mmol) was slowly added in portions. The reaction was stirred at room temperature overnight. Then the mixture was stored at −20° C. The ³¹P-NMR characterization is shown in FIG. 1: the nuclear magnetic peak of HMPA as the internal standard is 29.886 ppm, and the nuclear magnetic peak of AST-2660-D8-sodium salt is 24.503 ppm.

FIG. 1 is the ³¹P-NMR spectrum of AST-2660-D8-sodium salt.

Obviously, in the above operations, different intermediates I-b can be synthesized by selecting different deuterated raw material compounds I-a (deuterated 2-bromoethylamine), and then different bases (NaOH, KOH, LiOH or Ammonia water) were added in the hydrolysis reaction to obtain different deuterated bis (aziridine-1-yl) phosphinic acids or salts thereof.

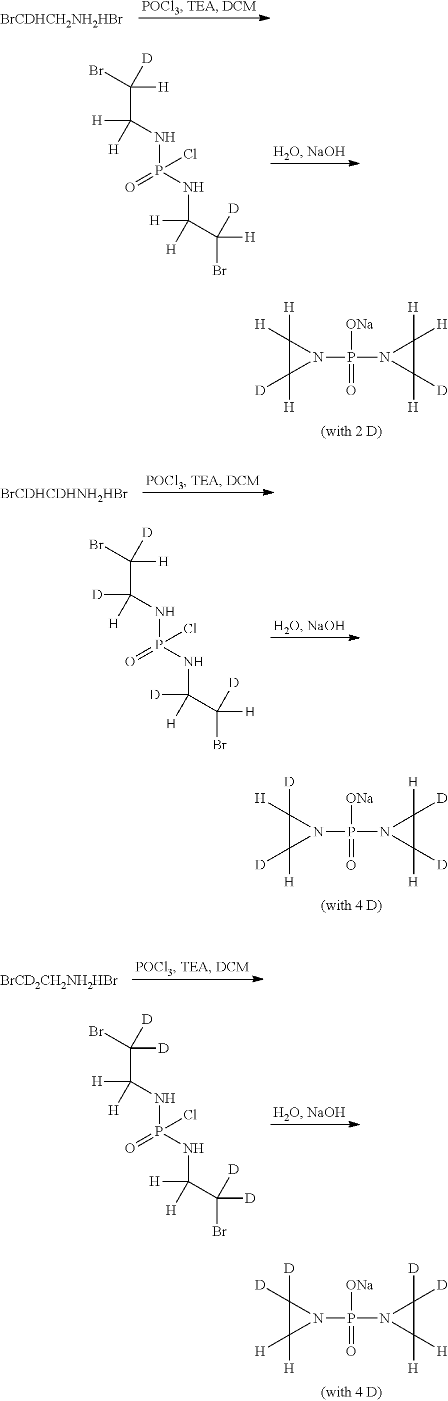

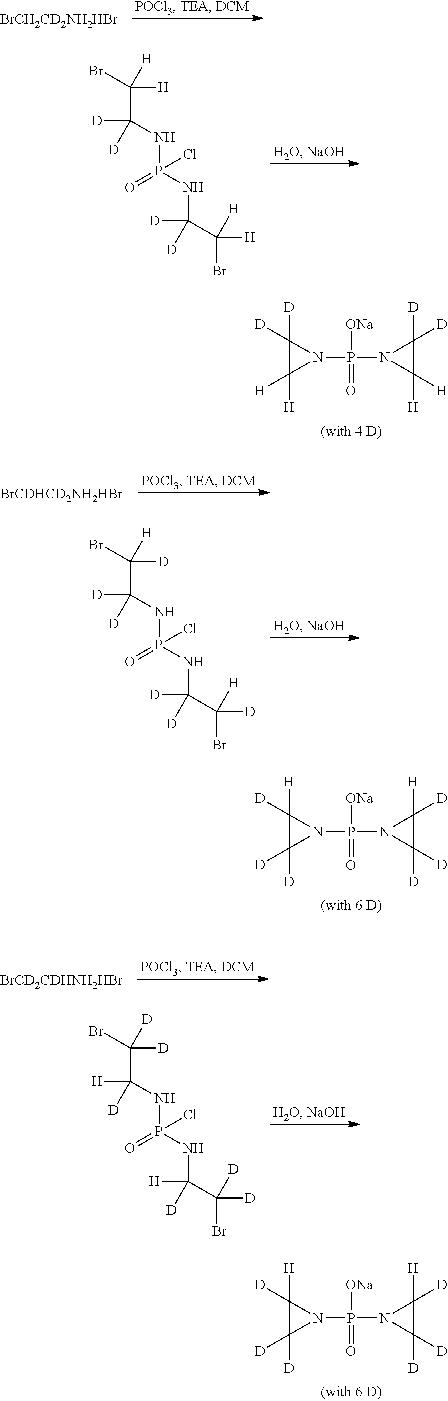

The above reaction from compound I-a to compound I-b was completed in one step. In fact, it is also can be completed in separate (two) steps, and the feeding order and the amount of the reactants can be changed. Obviously, such operation is equivalent to the operation that the above reaction from compound I-a to compound I-b was completed in one step, namely:

Under the protection of nitrogen, deuterated 2-bromoethylamine hydrobromide and phosphorous oxychloride were added to anhydrous dichloromethane (firstly phosphorus oxychloride was added, then a first deuterated 2-bromoethylamine hydrobromide was added, wherein the molar ratio of phosphorous oxychloride to the deuterated 2-bromoethylamine hydrobromide was greater than 1). The temperature of the reaction mixture was lowered to −78° C., and triethylamine in dichloromethane solution was added dropwise. After the reaction mixture was kept at −78° C. for 30 min, a second deuterated 2-bromoethylamine hydrobromide was added. Triethylamine in dichloromethane solution was added dropwise. The reaction mixture was kept at −78° C. for 30 min, the temperature of the reaction mixture was naturally raised to 0° C., and then the reaction mixture was kept at 0° C. for 4 hours. Then the solid was quickly filtered off with suction. The mother liquor was concentrated at a low temperature and was directly used in the next step.

The crude product obtained in the above steps was dissolved in water, and a solid sodium hydroxide was slowly added in portions. The reaction was stirred at room temperature overnight. Then the reaction mixture was stored at −20° C., wherein the reaction occurred as follows:

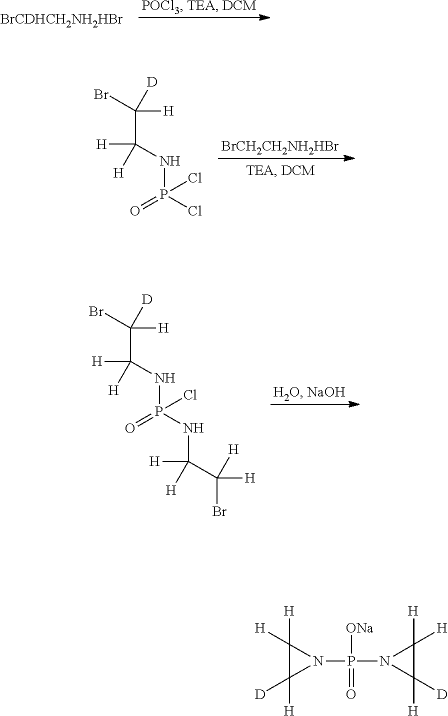

Different deuterated compounds I and salts thereof can be prepared by selecting the first and the second deuterated 2-bromoethylamine hydrobromide with different deuteration positions and deuteration numbers.

The quantitative detection method is specifically described below by means of taking the AST-2660-D8-sodium salt prepared in Example 1 as an example.

### Example 2 The method for Detecting AST-2660-D8-Sodium Salt

In this example, HMPA (hexamethylphosphoric triamide) was used as the internal standard of phosphorus spectrum for measuring the content of AST-2660-D8-sodium salt prepared in Example 1.

HMPA (33.0 mg, 0.1840 mmol) was dissolved in water (2.2 mL), wherein the total mass was 2612 mg, and the concentration of HMPA was 7.050×10⁻⁵ (mmol/mg, the nuclear magnetic shift of 31 P-NMR was 29.890 ppm)

The aqueous solution of HMPA was used as the internal standard to determine the phosphorus spectrum, and the content of AST-2660-D8-sodium salt was determined.

### 1. Detection of the First Portion of the Sample

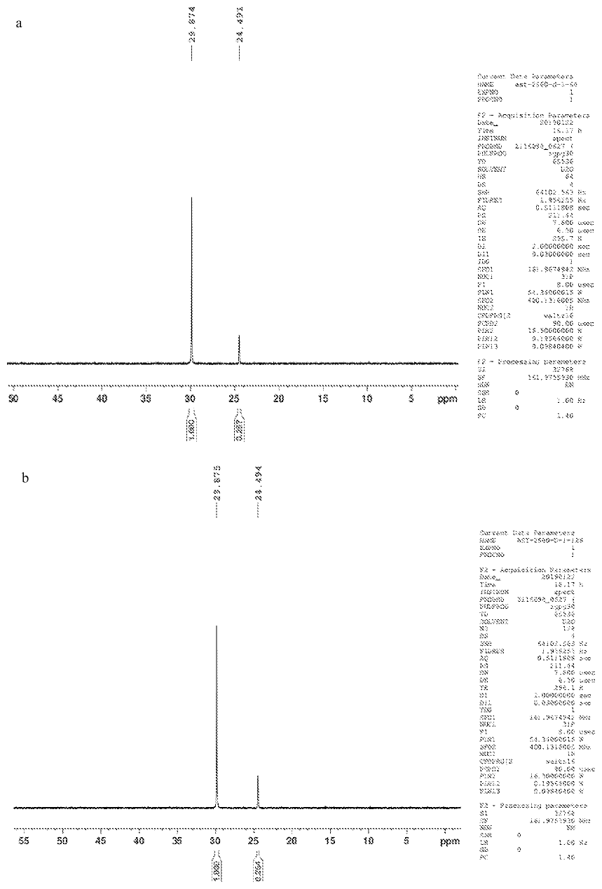

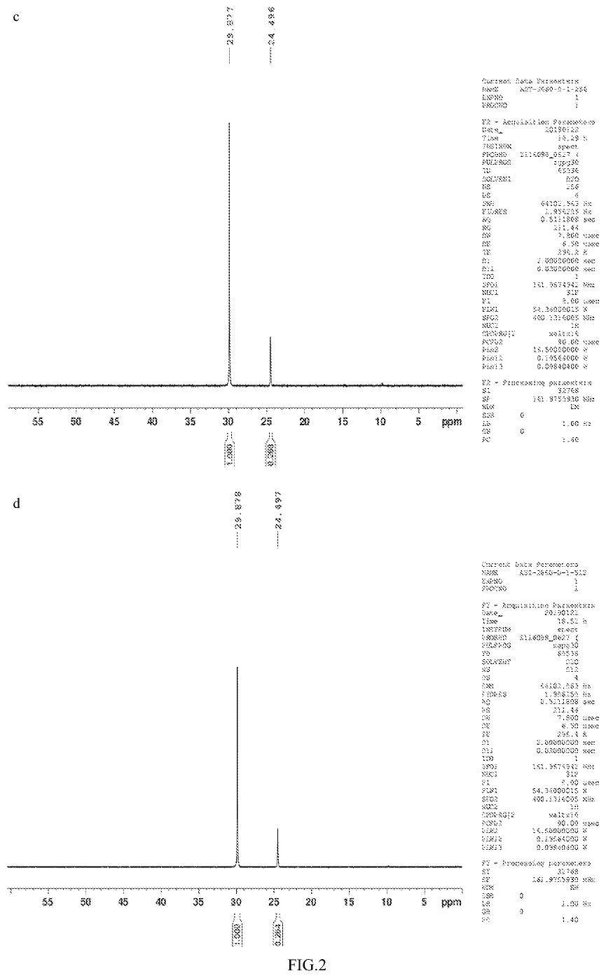

About 0.5 mL (488 mg) of the aqueous solution of AST-2660-D8-sodium salt prepared in Example 1 and the aqueous solution of HMPA (317 mg), which has been precisely weighed and formulated, were scanned for 64 times to determine the phosphorus spectrum (as shown in FIG. 2): the integrated peak area ratio of the nuclear magnetic peak 29.874 ppm for the corresponding HMPA to the nuclear magnetic peak 24.491 for AST-2660-D8-sodium salt=1:0.257 in the nuclear magnetic spectrum.

FIG. 2 is ³¹P-NMR spectra of the first portion of an aqueous solution of AST-2660-D8-sodium salt, from top to bottom, from left to right, which was scanned for 64, 128, 256, and 512 times, respectively.

The amount of HMPA was known to be 0.02235 mmol, and thus the amount of AST-2660-D8-sodium salt should be 0.005743 mmol which was calculated and obtained according to the integrated peak area ratio in the nuclear magnetic spectrum, and the concentration should be 1.177×10⁻⁵ mmol/mg, that is 1.177×10⁻² mmol/g, and the corresponding mass content was 2.10 mg/g. Likewise, when the scanning was performed for 128, 256, and 512 times, the phosphorus spectra were shown in FIG. 2, wherein the integrated peak area ratios were calculated to be 1:0.264, 1:0.268 and 1:0.264, respectively. Thus, the concentrations of the same samples were 1.209×10⁻⁵ mmol/mg, 1.227×10⁻⁵ mmol/mg and 1.209×10⁻⁵ mmol/mg, respectively, namely 2.15 mg/g, 2.18 mg/g and 2.15 mg/g, and the average of the four results was 2.1 mg/g.

The nuclear magnetic quantitative method in this example is relatively quick and simple, has acceptable accuracy within a certain range, and can replace the HPLC yield analysis method. If it is necessary to further improve the accuracy of quantification, the HPLC method should be used. The external standard method should be used for quantification, and the absolute content should be accurately quantified through the standard curve.

The LC-MS/MS methods of Example 5 and Example 7 are suitable for the detection of the low content of AST-2660-D8 and AST-2660, and their corresponding LC liquid phase methods (the corresponding MS/MS detectors are replaced with conventional Differential Detector, Electrospray Detector, Evaporative Light Scattering Detector) are also suitable for the detection of the constant content (mg/ml) of AST-2660 and AST-2660-D8.

### Example 3 Stability Study of AST-2660-D8-Sodium Salt

This example is to study the stability of the sample solution by detecting the content of the aqueous solution of AST-2660-D8-sodium salt: ³¹P-NMR was used for detection, and the content of the aqueous solution of AST-2660-D8-sodium salt was characterized by comparing the area ratio of ³¹peak of HMPA as an internal standard to that of ³¹P peak of AST-2660-D8 sodium salt within 48 hours, thereby determining whether the mass of the sample solution was reduced as a result of degradation.

### 1. Analysis Method

³¹P-NMR of the samples was run on an NMR instrument.

HMPA (21.8 mg, 0.1217 mmol) was dissolved in water (2.20 mL), wherein the total mass was 2127 mg, and the concentration of HMPA was 5.72×10⁻⁵ mmol/mg. A solution of AST-2660-D8-sodium salt (588 mg, about 0.5 mL) and a solution of HMPA (293 mg, 1.676×10⁻² mmol) were mixed together as samples for 31 P-NMR analysis under −20° C. storage conditions at different times. The ratio of integrated peak area of the nuclear magnetic peak (about 29.874 ppm) for the corresponding HMPA to that of the nuclear magnetic peak (about 24.491 ppm) for AST-2660-D8-sodium salt in the nuclear magnetic spectrum was calculated, and the integrated peak of the nuclear magnetic peak for HMPA was set as 1.

According to the same operation, a sample with another concentration was formulated for detection, and ³¹P-NMR analysis was performed under −78° C. storage conditions at different times.

2. Stability Results During Storage at −20 to −78° C. for 48 hours

The samples were stored at −20, −78° C. for 48 hours, detected and recorded at 0 h, 2 h, 4 h, 6 h, 8 h, 16 h, 24 h, 36 h, and 48 h, respectively. The results were shown in table 1 below.

TABLE 1
Stability data of AST-2660-D8 sodium
salt stored at −20, −78° C. for 48 hours

| Time | AST-2660-D8 sodium | AST-2660-D8 sodium |
|---|---|---|
| Samples | salt solution −20° C. | salt solution −78° C. |
| 0 h | 1:0.449 | 1:0.232 |
| 2 h | 1:0.463 | 1:0.225 |
| 4 h | 1:0.428 | 1:0.221 |
| 6 h | 1:0.460 | 1:0.213 |
| 8 h | 1:0.448 | 1:0.234 |
| 16 h | 1:0.447 | 1:0.225 |
| 24 h | 1:0.468 | 1:0.241 |
| 36 h | 1:0.444 | 1:0.234 |
| 48 h | 1:0.444 | 1:0.230 |

Under −20° C. storage condition, the ratio of the peak area of ³¹P-NMR peak for HMPA to that of ³¹P-NMR peak for AST-2660-D8-sodium salt solution at 8/16/24/36/48 hours was stable in the range of 1:0.431:0.47. While under −78° C. storage condition, the ratio was stable in the range of 1:0.211:0.24. It can be considered therefore that: AST-2660-D8-sodium salt solution was stable when it was stored at −20 to −78° C. for 48 hours.

Representative spectra are shown in FIG. 3 and FIG. 4.

FIG. 3 is a ³¹P-NMR spectrum at time zero, which are AST-2660-D8 sodium salt solution at −20° C. and AST-2660-D8 sodium salt solution at −78° C. from left to right.

FIG. 4 is a ³¹P-NMR spectrum after 48 hours; which are AST-2660-D8 sodium salt solution −20° C. and AST-2660-D8 sodium salt solution at −78° C. from left to right.

### 3. Stability During Storage at −20° C. for 6 Months

The concentration of AST-2660-D8 sodium salt was determined to be 1.89 mg/mL at day 0 and 1.37 mg/mL after storage at −20° C. for 6 months using the method as described above. The concentration of AST-2660-D8 sodium salt was decreased by 27.5% within 6 months of storage.

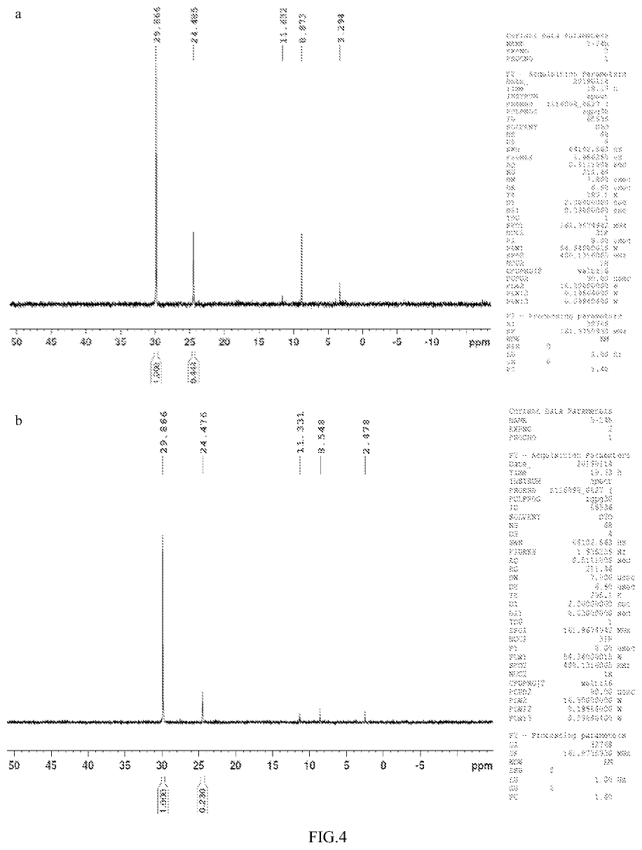

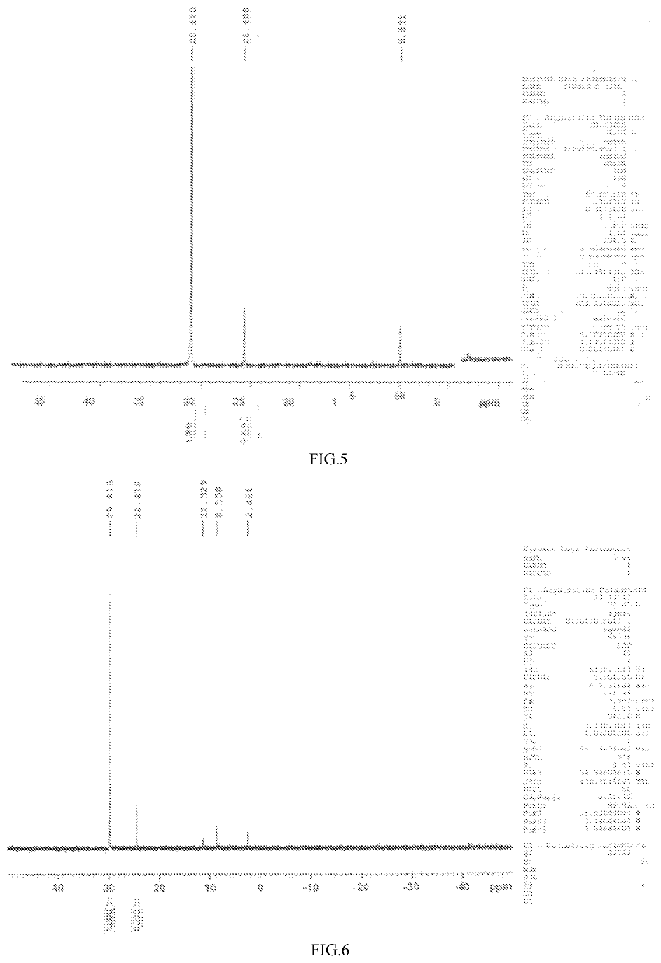

The ³¹P-NMR spectrum after 6 months is shown in FIG. 6.

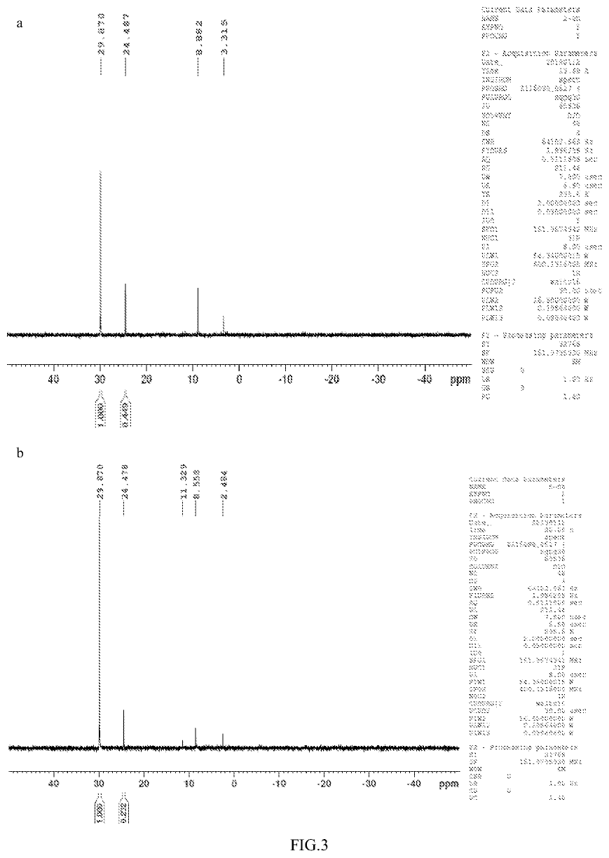

FIG. 5 is a ³¹P-NMR spectrum of an aqueous solution of AST-2660-D8 sodium salt after storage at −20° C. for 6 months.

### 4. Stability of Samples Stored at −78° C. for 6 Months

The concentration of AST-2660-D8 sodium salt was determined to be 1.89 mg/mL at day 0 and 1.71 mg/mL after storage at −78° C. for 6 months using the method as described above. The concentration of AST-2660-D8 sodium salt was decreased by 9.5% within 6 months of storage. Comparatively speaking, the sample storage at −78° C. was more stable than storage at −20° C., and the degradation change was slower.

The ³¹P-NMR spectrum after 6 months is shown in FIG. 7.

FIG. 6 is a ³¹P-NMR spectrum of an aqueous solution of AST-2660-D8 sodium salt after storage at −78° C. for 6 months.

From the above stability test results, it can be seen that the sample solution for detecting the content of aqueous solution of AST-2660-D8 sodium salt was stable after storage at −20 to −78° C. for 2 days. When the aqueous solutions of AST-2660-D8 sodium salt were stored at −20° C. and −78° C. for 6 months, the concentrations thereof were decreased by 27.5% and 9.5%, respectively.

### Example 4 Establishment and Verification of the Detection Method of AST-2660 in Human Plasma

This example used deuterated internal standard (IS) AST-2660-D8 (prepared in Example 1) to quantitatively detect the metabolite AST-2660 (present in the form of sodium salt) comprising K2EDTA anticoagulant in human plasma, wherein the structural formula of AST-2660 is as follows:

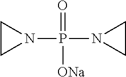

AST-2660 sodium salt
molecular formula: C₄H₈N₂O₂PNa
molecular weight:170.08

The structure of the deuterated compound AST-2660-D8 sodium salt used is shown as below:

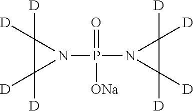

AST-2660-D8 sodium salt
molecular formula: C₄D₈N₂O₂PNa
molecular weight:178.13

The following AST-2660 each refers to its sodium salt, and AST-2660-D8 also refers to its sodium salt.

### 1. LC-MS/MS Experimental Method

The relevant parameters of the LC-MS/MS experimental method are provided.

TABLE 2
The instrument parameters of chromatography analysis

| LC System: | Waters Acquity UPLC System |
|---|---|
| Mobile phase: | A: Methanol solution of ammonium acetate |
| | (the amount of ammonium |
| | acetate within 0.01-1.5% by weight) |
| | B: Acetonitrile |
| HPLC | SHARC 1, 3 μm, 2.1 * 50 mm (a typical |
| Chromatography | hydrogen acceptor type stationary phase |
| Column: | chromatography column, with trade name |
| | SHARC 1, which is a brand name of the |
| | chromatography column commercially sold by |
| | American SIELC Technologies company) |
| LC Procedure: | Gradient elution, the initial volume ratio of |
| | gradient elution of mobile phase A is 5-20%, |
| | and the end point is 75-95%, based on the |
| | content of ammonium acetate in mobile phase |
| | A, and it needs to be explored; the specific |
| | climbing time and flow rate should be |
| | converted in accordance with the column |
| | length and its inner diameter, and the |
| | value provided herein is 2.1 * 50 mm (a |
| | chromatography column with an inner diameter |
| | of 2.1 mm and a length of 50 mm). |
| Autosampler | Acquity sample manager/4° C. |
| temperature: | |
| Injection volume: | 5 μl |

TABLE 3
The experimental parameters of mass spectrometer MS/MS

| | |
|---|---|
| Mass Spectrometer: | AB Sciex Triple Quad 5500 |
| Q1/Q3 Resolution: | Unit/Unit |
| Ionization: | TURBO Ion spray ™ |
| Ionization mode: | Negative |
| MS acquisition | Determined according to liquid phase gradient |
| time: | |

| Analyte/Internal | Mass-to-nucleus ratio (amu, | Retention | | | | CXP |
|---|---|---|---|---|---|---|
| standard | for each m/z ± 0.2) | time (ms) | DP (V) | EP (V) | CE (eV) | (V) |
| AST-2660 | m/z 147.0 → m/z 62.9 | 100 | −55 | −10 | −22 | −16 |
| AST-2660-D8 (IS) | m/z 155.0 → m/z 62.9 | 100 | −55 | −10 | −22 | −16 |

TABLE 4
The adjustable experimental parameters of mass
spectrometer MS/MS (typical value)

| | |
|---|---|
| Time: | 500° C. |
| Ion spray voltage: | −4500 V |

### 2. Preparation of Samples

### 2.1 Preparation of Standard Working Solutions

AST-2660 (prepared by referring to Example 1 and selecting non-deuterated raw materials) standard stock solution (methanol solution with a concentration of 1.0 mg/ml): an appropriate amount of AST-2660 was taken, added with an appropriate amount of methanol, diluted and mixed thoroughly to obtain 1.0 mg/ml of solution.

A 100 μL standard stock solution of AST-2660 was taken, added with 9900 μL of methanol, diluted and mixed thoroughly to obtain 10.0 μg/ml of calibration standard working solution.

### 2.2 Preparation of Standard Curve

The standard working solution (SWS) and the blank matrix (diluent) were left to room temperature. The standard working solution was vortexed prior to use, in which the normal pooled human plasma comprising anticoagulant (K₂EDTA) was used as diluent and blank matrix to prepare standard sample solutions with different concentrations for standard curve according to the table below.

TABLE 5
The dilution data of standard working solution (SWS)
and blank matrix (diluent)

| | | | | Standard curve | |
|---|---|---|---|---|---|
| Source | | | | for standard sample | |
| | Concen- | Taken | Diluent | Concen- | |
| | tration, | volume | volume | tration, | Calibration |
| Source ID | ng/ml | μL | μL | ng/ml | standard ID |
| Standard Sample | 10000 | 100 | 4900 | 200 | Standard |
| Working Solution | | | | | Sample 8 |
| Standard Sample | 200 | 800 | 200 | 160 | Standard |
| 8 | | | | | Sample 7 |
| Standard Sample | 200 | 500 | 500 | 100 | Standard |
| 8 | | | | | Sample 6 |
| Standard Sample | 200 | 300 | 900 | 50 | Standard |
| 8 | | | | | Sample 5 |
| Standard Sample | 50 | 200 | 800 | 10 | Standard |
| 5 | | | | | Sample 4 |
| Standard Sample | 10 | 200 | 800 | 2.0 | Standard |
| 4 | | | | | Sample 3 |
| Standard Sample | 2.0 | 500 | 500 | 1.0 | Standard |
| 3 | | | | | Sample 2 |
| Standard Sample | 1.0 | 500 | 500 | 0.5 | Standard |
| 2 | | | | | Sample 1 |

### 2.3 Preparation of Internal Standard Working Solution (Standard Working Solution)

AST-2660-D8 stock solution (50 μg/ml of AST-2660-D8 methanol solution): an appropriate amount of AST-2660-D8 reference substance was taken, added with an appropriate amount of methanol, diluted, and mixed thoroughly to obtain 50 μg/ml of solution. A 20 μL of internal standard stock solution of AST-2660-D8 was taken, added with 9980 μL methanol, diluted and mixed thoroughly to obtain 100 ng/ml of internal standard working solution.

### 2.4 Preparation of Quality Control Samples

AST-2660 quality control stock solution (1.0 mg/ml solution in methanol): an appropriate amount of AST-2660 reference substance was taken, added with an appropriate amount of methanol, diluted and mixed thoroughly to obtain 1.0 mg/ml of solution. 100 μL of AST-2660 QC stock solution and 9990 μL of methanol were taken to obtain 10.0 μg/ml of quality control working solution;

The normal pooled human plasma containing anticoagulant (K₂EDTA) was used as a diluent, and was diluted according to the following table to prepare quality control samples with different concentrations.

TABLE 6
Preparation of quality control sample

| Source | | | | | |
|---|---|---|---|---|---|
| | | Taken | Dilute | Quality Control Sample | |
| | Concentration, | volume | Volume | Concentration, | Quality Control |
| Source ID | ng/ml | μL | μL | ng/ml | Sample ID |
| AST-2660 Quality | 1000000 | 15 | 9985 | 1500 | Dilute QC |
| Control Stock Solution | | | | | |
| AST-2660 Quality | 10000 | 30 | 1970 | 150 | QC4 (high QC) |
| Control Working Solution | | | | | |
| QC4 | 150 | 600 | 900 | 60 | QC3 (medium QC) |
| QC4 | 150 | 100 | 900 | 15 | QC2 (Geometric |
| | | | | | mean value QC) |
| QC2 | 15 | 100 | 900 | 1.5 | QC1 (low QC) |
| QC1 | 1.5 | 300 | 600 | 0.5 | LLOQ QC (lower |
| | | | | | limit of |
| | | | | | quantification QC) |

### 3. Pretreatment of the Samples

The steps for extracting samples using protein precipitation method:
1. Confirming the labeling and sequence of standard curve samples, quality control samples, and plasma samples;
2. Placing all samples on a Multi-Tube vortexer for vortexing uniformly after thawing;
3. Taking 100 μl from each sample and adding them to a 96-well plate;
4. In addition to the blank sample, adding 20 μl of AST-2660-D8 quality control working solution deuterated internal standard (i.e., 100 ng/ml of AST-2660-D8 methanol solution); adding 20 μl of methanol to the blank sample;
5. Adding 500 μl of methanol;
6. Vortexing the plate at a medium speed for 3 minutes;
7. Centrifuging the 96-well plate at 2143 rcf (centrifugal force) for 10 minutes;
8. Transferring 450 μl of the supernatant to a new 96-well plate;
9. Drying the supernatant with a 96-well Termovap sample concentrator;
10. Redissolving with 150 μl of methanol;
11. Sonicating the plate for 30 second;
12. Centrifuging the plate at 4° C. and 2143 rcf (centrifugal force) for 3 minutes;
13. Transferring 120 μl of the supernatant to a new 96-well plate.
   4. Experimental results

### 4.1 Standard Curve

Parameters of AST-2660 standard curve in human plasma were as follows: slope: 0.063846, intercept: −0.003788, correlation coefficient 0.9939, then the relationship function y=f (x)=0.063846x−0.003788, where y represents the ratio of the peak area of metabolite II to that of internal standard compound, x represents the concentration of metabolite II in the standard working solution, LLOQ (the lower limit of quantification): 0.5 ng/ml, ULOQ (the upper limit of quantification): 200 ng/ml. As can be seen that the linear relationship was good in the linear range of 0.5200 ng/ml.

### 4.2 Accuracy and Precision Test Results of Quality Control Samples

Accuracy and precision are defined as follows:
Accuracy represents relative error (RE).
RE=[(mean value -nominal value)/nominal value]×100
Precision represents coefficient of variation (CV).
CV=(standard deviation/mean value)×100.

The accuracy and precision test results were shown in Table 7. It can be seen from Table 7 that the intra-assay and inter-assay precisions were both less than 8.3%, and the intra-assay and inter-assay accuracies were within ±8.7. The analytical criteria for accuracy and precision were as follows: for LLOQ QC samples, the intra-assay and inter-assay accuracy (RE) must be within ±20.0%, and intra-assay and inter-assay CV must be not greater than 20.0%. The intra-assay and inter-assay accuracy (RE) must be within ±15.0% for low, geometric mean, medium, high, and diluted QC (if applicable) samples; intra-assay and inter-assay precision (CV) must be not greater than 15.0% at each QC concentration level. Therefore, the intra-assay and inter-assay precisions and accuracies of the quality control samples met the requirements. The precision (%CV) of the internal standard AST-2660-D8 was less than or equal to 40.0%, which met the requirements.

TABLE 7
The intra-assay and inter-assay precision and accuracy results for quality
control samples

| AST-2660 | | | Intra-assay | Inter-assay | |
|---|---|---|---|---|---|
| Intra-assay and | LLOQQC | 0.500 ng/ml | ≤8.0% | 8.3% | Each |
| inter-assay | QC1 | 1.50 ng/ml | ≤7.9% | 8.1% | concentration |
| precision of quality | QC3 | 60.0 ng/ml | ≤3.7% | 5.4% | level met the |
| control in the three | QC4 | 150 ng/ml | ≤5.5% | 5.3% | acceptable |
| assay batches with | | | | | requirements |
| acceptable accuracy | | | | | |
| and precision | | | | | |
| analysis (% CV) | | | | | |
| AST-2660 | | | Intra-assay | Inter-assay | |
| Intra-assay and | LLOQQC | 0.500 ng/ml | −5.8% to 8.4% | 0.6% | Each |
| inter-assay accuracy | QC1 | 1.50 ng/ml | −8.7% to 3.3% | −3.3% | concentration |
| of quality control in | QC3 | 60.0 ng/ml | −4.3% to 5.8% | 0.3% | level met the |
| the three assay | QC4 | 150 ng/ml | −1.3% to 0.7% | 4.7% | acceptable |
| batches with | | | | | requirements |
| acceptable accuracy | | | | | |
| precision | | | | | |
| and precision | | | | | |
| analysis (% RE) | | | | | |

### 4.3 The Test Results of Extraction Recovery of AST-2660 and the Internal Standard AST-2660-D8

TABLE 8
The test results of extraction recovery of AST-2660 and the
internal standard AST-2660-D8

| | | | | |
|---|---|---|---|---|
| AST-2660 | QC1 | 1.50 ng/ml | 42.4% | Meeting the |
| Mean precision (%) | QC3 | 60.0 ng/ml | 41.9% | acceptable |
| for extraction | QC4 | 150 ng/ml | 42.3% | requirements |

| | | | |
|---|---|---|---|
| recovery | | CV ≤13.4% for | |
| | | each concentration | |
| AST-2660-D8 | 100.0 ng/ml | 34.4% | Meeting the |
| Mean precision (%) | | CV ≤8.2% | acceptable |
| for extraction | | | requirements |
| recovery | | | |

Note:
% recovery = (mean value before extraction/mean value after extraction) × 100
CV = (SD/Mean value) × 100

It can be seen from Table 8 that the CVs of the extraction recovery of AST-2660 and the internal standard AST-2660-D8 were both less than 15.0%. Analytical criteria for extraction recovery: for post-extraction spiked samples, the CV of response measured at each concentration level must be no greater than 15.0%. Therefore, the extraction recoveries of AST-2660 and the internal standard AST-2660-D8 met the requirements.

### 4.4 Test Results of Matrix Effect

TABLE 9
Test results of matrix effect

| | | | | |
|---|---|---|---|---|
| AST-2660 | LLOQQC | 0.500 ng/ml | At least two thirds of the | Meeting the |
| Precision of the | QC4 | 150 ng/ml | QC repeat samples have a | acceptable |
| intra-assay matrix (%) | | | RE which must be within | requirements |
| | | | ±20.0% (LLOQQC), or | |
| | | | within ±15.0% (QC4). | |
| AST-2660 | QC1 | 1.50 ng/ml | 0.95 | No standard |
| Matrix effect | QC4 | 150 ng/ml | 0.95 | limit |
| (mean matrix factor) | | | | |
| AST-2660 | QC1 | 1.50 ng/ml | 1.06, CV: 6.1% | Meeting the |
| Matrix effect (mean | QC4 | 150 ng/ml | 1.06, CV: 5.5% | acceptable |
| normalized matrix | | | | requirements |
| factor) | | | | |

According to the results in Table 9, it can be seen that the inter-assay matrix accuracy and precision (CV) of the matrix effect of AST-2660 were both less than 15%, which met the requirements.

### 4.5 Stability

TABLE 10
Stability results of AST-2660 working solution and AST-2660-D8
(internal standard) working solution

| | | | |
|---|---|---|---|
| AST-2660 | 10 μg/ml of AST-2660 | RE: −8.1% | Meeting the |
| working solution | methanol solution | CV ≤5.5% | acceptable |
| can be stable | (comparing the peak | | requirements |
| for 30 hours at | area between stock | | |
| room temperature | and fresh solutions) | | |
| (% difference) | | | |
| AST-2660 | 10 μg/ml of AST-2660 | RE: 0.4% | Meeting the |
| working solution | methanol solution | CV ≤1.6% | acceptable |
| was stable | (comparing the peak | | requirements |
| for 26 days | area between stock | | |
| at −70° C. | and fresh solutions) | | |
| (% difference) | | | |
| AST-2660-D8 | 100 ng/ml of | RE: 0.9% | Meeting the |
| working solution | AST-2660-D8 | CV ≤1.4% | acceptable |
| was stable | methanol solution | | requirements |
| for 26 days | (comparing the peak | | |
| at −70° C. | area between stock | | |
| (% difference) | and fresh solutions) | | |

It can be seen from Table 10 that the accuracy of the stability of the AST-2660 working solution and the internal standard AST-2660-D8 working solution was within ±8.1%, and the precision was less than 5.5%. Stability analysis criteria: the difference between the storage stable solution and the freshly prepared solution must be within ±10.0%, and the CV of each replicate experiment must not be greater than 10.0%. Therefore, both AST-2660 and AST-2660-D8 (internal standard) working solutions had good stability and met the requirements under various storage conditions.

The liquid chromatography-tandem mass spectrometry method established in this example for detecting AST-2660 in human plasma met the analysis requirements of biological sample: the sample processing method was simple and convenient; and this method had high sensitivity, precision, and accuracy.

### Example 5 Detection of the Content of AST-2660 in Actual Human Plasma

The detection method established in example 4 was used to detect the content of AST-2660 in the human plasma to be tested.

The standard operating procedure (SOP) for detection established after the methodology and validation according to example 4 was as follows:

### Step 1. Formulation of Solution

Matrix: the mixed normal human plasma containing anticoagulant (K₂ EDTA)
a: the internal standard working solution: AST-2660-D8 was taken, added with methanol, and diluted to prepare a solution containing about 100 ng per 1 ml.
b: the solution to be tested (no internal standard compound was added to the solution to be tested at this time): it was obtained by taking a blood sample to be tested.
c: the standard working solution (no internal standard compound was added to the standard working solution at this time): an appropriate amount of AST-2660 was taken and accurately weighed, dissolved with methanol, and diluted to prepare a solution containing about 1.0 mg per 1 ml, which was used as the standard working stock solution. An appropriate amount of the standard working stock solution was taken, added with the matrix and diluted to prepare standard working solutions with different concentrations containing about 200 ng, 160 ng, 100 ng, 50 ng, 10 ng, 2.0 ng, 1.0 ng and 0.5 ng per 1 ml, respectively. (The solution was stored at −70° C.)
d: the quality control sample solution: an appropriate amount of AST-2660 was taken and accurately weighed, dissolved with methanol, and diluted to prepare a solution containing about 10 μg per 1 ml, which was used as the quality control working stock solution. An appropriate amount of the quality control working stock solution was taken, added with matrix to prepare quality control working solutions with different concentrations containing about 150 ng, 60 ng, 15 ng, 1.5 ng and 0.5 ng per 1 ml. (The solution was stored at −70° C.)

### Step 2. Extraction of Sample

The solution to be tested, the standard working solution and the quality control sample solution were thawed at room temperature and mixed uniformly. 100 μl of the above solution was respectively taken, added with 20 μl of the internal standard and 500 μl of methanol, and vortexed for 3 minutes to mix uniformly, and then centrifuged for 10 minutes at 2143 rcf. 450 μl of the supernatant was taken and dried, and 150 μl of methanol was added for redissolution, and sonicated. Then the plates were centrifuged for 3 minutes at 4° C. It was obtained by taking 200 μl of supernatant.

100 μl of the blank blood was taken, added with 20 μl of methanol and extracted with the same method to obtain the blank sample.

100 μl of the blank blood was taken, added with 20 μl of the internal standard working solution and extracted with the same method to obtain a zero-concentration sample.

After sample extraction and the addition of internal standard, the solution was injected into LC-MS/MS for detection in step 4.

### Step 3. Setting up Chromatography-Mass Spectrometry Test Conditions

Determination was performed using liquid chromatography-tandem mass spectrometry (LC-MS/MS), and the following instrument test conditions were set up:

Liquid phase conditions: A SHARC 1, 3 μm, 2.1*50 mm or chromatograph column with equivalent performance was used; the mobile phase was a methanol solution comprising low content of ammonium acetate; the mobile phase B was acetonitrile; the gradient elution was performed according to the following table, column temperature: 20° C.; injection volume: 5 μl.

TABLE 11
The gradient elution conditions for testing with
the liquid chromatograph in Example 5

| Time | Flow Rate | % A | % B |
|---|---|---|---|
| Initial | 0.8 | 15 | 85 |
| 1.5 | 0.8 | 50 | 50 |
| 2.0 | 0.8 | 90 | 10 |
| 2.5 | 0.8 | 15 | 85 |

Mass spectrometric conditions: electrospray ion source with negative ion scanning mode; spray potential: −4500 V; ion source temperature: 500° C.; collision energy (CE): −22 eV; declustering potential (DP): −55V; entrance potential (EP): −10V; collision chamber exit potential (CXP): −16V; dwell time: 100 ms; high purity nitrogen was used for all gases; AST-2660 ions pairs: m/z 147.0→m/z 62.9; the internal standard AST-2660-D8 ion pairs: m/z 155.0→m/z 62.9.

### Step 4. Determination

The AST-2660 standard working solution, blank sample, zero concentration sample, sample solution to be tested and quality control sample solution with different concentrations after extraction were respectively taken and injected into LC-MS/MS for detection.

Acceptance criteria: the recovered concentration of the standard working solution, the accuracy of the quality control working solution and the peak residue of AST-2660 and the internal standard in the blank sample should meet the requirements in Chinese Pharmacopoeia (2020 edition), Vol. 4, 9012.

The prepared standard working solutions of metabolites II with different concentrations were absorbed and injected into the LC-MS/MS system for detection to obtain a relationship function y=f (x), wherein y represents the ratio of the peak area of the metabolite II to that of the internal standard compound, and x represents the concentration of the metabolite II in the standard working solutions.

Calculation results: the relationship function y=f (x) of the ratio of the peak area of the AST-2660 to that of the internal standard was obtained from AST-2660 standard working solutions with different concentrations. The ratio of the peak area of the AST-2660 to that of the internal standard was determined from the solution to be tested after extraction, and substituted into the relationship function y=f (x) to calculate the concentration of the metabolite II in the solution to be tested.

The relationship function was used to determine and calculate the concentration of the metabolite II in the solution to be tested with unknown concentration. The solution to be tested added with the internal standard compound with known content was absorbed and injected into the LC-MS/MS system for detection. The ratio y of the peak area of the metabolite II to that of the internal standard compound was determined and substituted into the function y=f (x) to obtain the concentration x of the metabolite II in the solution to be tested.

As an option, the order of the above SOP related operation steps was slighted changed to obtain the following operation SOP:

A biological sample solution to be tested was added with a quantitative internal standard compound and taken as a solution to be tested after extraction treatment;

A series of solutions of metabolite II with different concentrations were obtained by diluting a metabolite II reference substance, added with the quantitative internal standard compound and taken as a standard working solution after extraction treatment; the series of standard working solutions were absorbed, respectively, injected into an LC-MS/MS system for detection to obtain the peak area of the metabolite II and the internal standard compounds, the ratio of the peak area of the metabolite II to that of the internal standard compounds was taken as an ordinate and the concentration of the metabolite II was taken as an abscissa to draw a standard curve and calculate a regression equation;

The solution to be tested was absorbed, and injected into the LC-MS/MS system for detection; the ratio of the peak area of the metabolite II to that of the deuterated compound I in the solution to be tested was determined, substituted into the regression equation to obtain the content of the metabolite II in the biological sample solution to be tested.

The solutions with the same concentration were prepared by using containers with the same volume according to the habits of laboratory operators using the above changed SOP. This operation only needs to ensure that the volume of the solution added was the same, and the obtained standard working solution was still with the same concentration.

FIGS. 7 to 10 are some typical spectra of the detection process of plasma samples.

FIG. 7 is typical LC-MS/MS spectra of AST-2660 and the internal standard AST-2660-D8 in blank human plasma extracts.

FIG. 8 is typical LC-MS/MS spectra of AST-2660 and the internal standard AST-2660-D8 in zero concentration of plasma sample extracts.

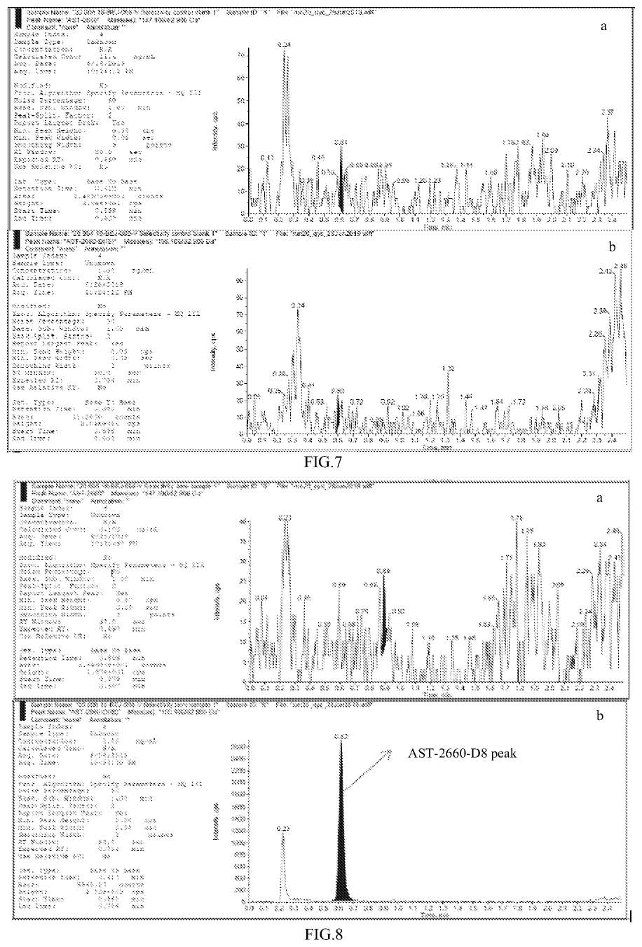

FIG. 9 is typical LC-MS/MS spectra of AST-2660 and the internal standard AST-2660-D8 in standard sample solution of human plasma extracts (0.50 ng/ml).

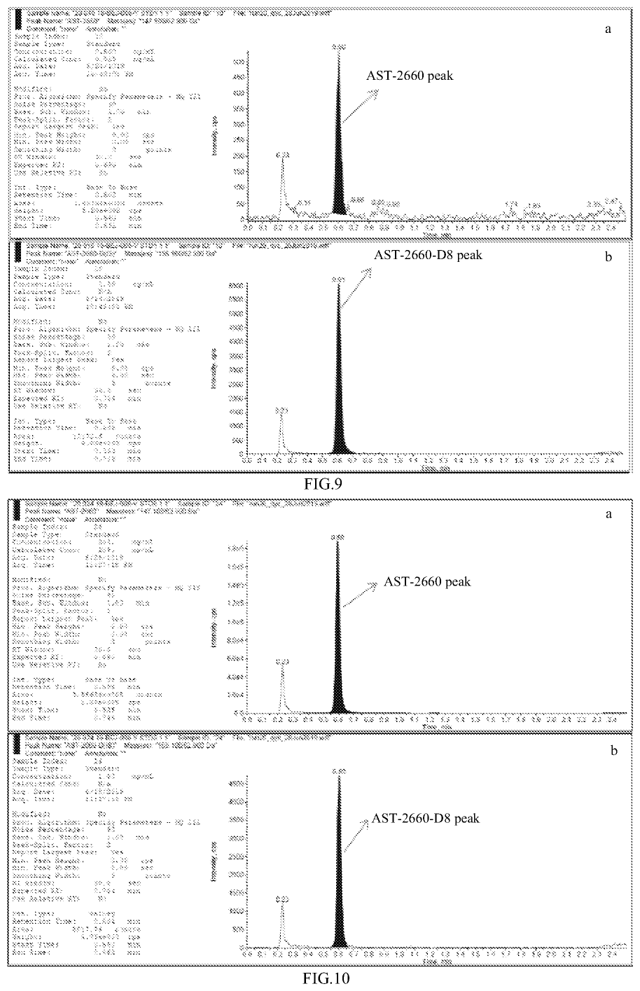

FIG. 10 is typical LC-MS/MS spectra of AST-2660 and the internal standard AST-2660-D8 in standard sample solution of human plasma extracts (200 ng/ml).

Some of the samples were detected using the operating procedures for the detection of AST-2660 content in human plasma provided in this example. The results were shown in Tables 12-16 below.

TABLE 12
Stability study data of AST-2660 in human plasma at
−20° C. and −70° C. for one month

| Stability study data of AST-2660 | | Stability study data of AST-2660 | |
|---|---|---|---|
| in human plasma at | | in human plasma at | |
| −20° C. for one month | | −70° C. for one month | |
| | 28 days, | | 28 days, |
| Analysis batch 20 | −20° C. | Analysis batch 20 | −70° C. |
| QC1 | 1.01 | QC1 | 1.52 |
| 1.50 ng/ml | 1.03 | 1.50 ng/ml | 1.53 |
| | 1.14 | | 1.59 |
| | 1.25 | | 1.49 |
| Mean value | 1.11 | Mean value | 1.53 |
| SD | 0.113 | SD | 0.04 |
| CV (%) | 10.0 | CV (%) | 2.7 |
| RE (%) | −26.2 | RE (%) | 2.2 |
| n | 4 | n | 4 |
| QC4 | 147 | QC4 | 142 |
| 150 ng/ml | 141 | 150 ng/ml | 150 |
| | 149 | | 142 |
| | 145 | | 145 |
| Mean value | 146 | Mean value | 145 |
| SD | 3.43 | SD | 4 |
| CV (%) | 2.3 | CV (%) | 2.6 |
| RE (%) | −3.0 | RE (%) | −3.5 |
| n | 4 | n | 4 |
| DilQC | 975 | DilQC | 1380 |
| (10-fold dilution) | 1060 | (10-fold dilution) | 1390 |
| 1500 ng/ml | 1020 | 1500 ng/ml | 1410 |
| | 993 | | 1450 |
| Mean value | 1012 | Mean value | 1408 |
| SD | 37.0 | SD | 31 |
| CV (%) | 3.7 | CV (%) | 2.2 |
| RE (%) | −32.5 | RE (%) | −6.2 |
| n | 4 | n | 4 |

Obviously, the human plasma containing AST-2660 had almost no reduction in AST-2660 content after 28 days of storage at −70° C., whereas it was reduced significantly at −20° C. Therefore, the human plasma samples containing AST-2660 should be stored at −70° C. as much as possible, under such condition the samples had no changes after 28 days of storage.

TABLE 13
Freeze/thaw stability study data of AST-2660 in
human plasma at −20° C. and −70° C.
AST-2660 concentration (ng/ml)

| | 5 cycles | | 5 cycles |
|---|---|---|---|
| Analysis batch 20 | at −20° C.^{a} | Analysis batch 20 | at −70° C.^{a} |
| QC1 | 1.14 | QC1 | 1.47 |
| 1.50 ng/ml | 1.06 | 1.50 ng/ml | 1.51 |
| | 1.13 | | 1.69 |
| | 1.18 | | 1.72 |
| Mean value | 1.13 | Mean value | 1.60 |
| SD | 0.05 | SD | 0.13 |
| CV (%) | 4.4 | CV (%) | 7.9 |
| RE (%) | −24.8 | RE (%) | 6.5 |
| n | 4 | n | 4 |
| QC4 | 136 | QC4 | 145 |
| 150 ng/ml | 138 | 150 ng/ml | 148 |
| | 152 | | 154 |
| | 132 | | 148 |
| Mean value | 140 | Mean value | 149 |
| SD | 9 | SD | 4 |
| CV (%) | 6.2 | CV (%) | 2.5 |
| RE (%) | −7.0 | RE (%) | −0.8 |
| n | 4 | n | 4 |
| DilQC | 1310 | DilQC | 1650 |
| (10-fold dilution) | 1250 | (10-fold dilution) | 1500 |
| 1500 ng/ml | 1310 | 1500 ng/ml | 1510 |
| | 1280 | | 1500 |
| Mean value | 1288 | Mean value | 1540 |
| SD | 29 | SD | 73 |
| CV (%) | 2.2 | CV (%) | 4.8 |
| RE (%) | −14.2 | RE (%) | 2.7 |
| n | 4 | n | 4 |

^{a}Freeze-thaw cycle stability samples were first frozen at nominal temperature of −20° C. and −70° C. for at least 24 hours and then thawed at room temperature. Samples were frozen for at least 12 hours for subsequent cycles.

Obviously, the human plasma containing AST-2660 had almost no reduction in AST-2660 content during the freeze-thaw process from −70° C. to room temperature, while it was reduced significantly during the freeze-thaw process from −20° C. to room temperature; that is, according to the data in Table 12, it can be seen that the sharp temperature changes of the human plasma samples stored at −70° C. from the storage condition to room temperature for the experimental process did not affect the stability of AST-2660 in human plasma samples.

TABLE 14
Stability study data on AST-2660-D8 solution stored at −70° C.

| | | | Peak area (AST-2660-D8) | |
|---|---|---|---|---|
| Peak area (AST-2660-D8) | | | 100 ng/ml of | |
| 1 mg/ml of methanol solution | | | methanol solution | |
| | Fresh | Stock solution | Fresh | Working |
| | stock | stored | stock | solution stored |
| | solution | at −70° C., | solution | at −70° C., |
| Solution time | t = 0 | t = 26 days | t = 0 | t = 26 days |
| Peak area | 574450 | 539154 | 3253860 | 3289570 |
| | 589227 | 532283 | 3323720 | 3332520 |
| | 535059 | 520321 | 3204960 | 3294750 |
| | 530296 | 550350 | 3285390 | 3307750 |
| | 537317 | 532469 | 3314390 | 3306110 |
| | 523322 | 549478 | 3310460 | 3335380 |
| Mean value | 548278.5 | 537342.5 | 3282130 | 3311013 |
| CV (%) | 4.9 | 2.1 | 1.4 | 0.6 |
| n | 6 | 6 | 6 | 6 |
| Deviation % | NA | −2.0 | NA | 0.9 |
| over fresh | | | | |
| stock solution | | | | |

Obviously, it can be known from the data in Table 14 that the methanol solution of AST-2660-D8 has strong stability after being stored for 26 days under the same conditions as AST-2660 at −70° C.

TABLE 15
Stability study data of human plasma samples after
AST-2660 was treated at 4° C.

| Analysis | AST-2660 Concentration | | |
|---|---|---|---|
| batch 13, | PSS_QC1, | PSS_QC3, | PSS_QC4, |
| analysis date | 1.5 ng/ml | 60 ng/ml | 150 ng/ml |
| t = 54 hours^{a} | 1.68 | 63.3 | 171 |
| | 1.70 | 59.9 | 171 |
| | 1.63 | 60.7 | 166 |
| | 1.76 | 60.7 | 173 |
| | 1.69 | 62.3 | 166 |
| | 1.66 | 66.4 | 162 |
| Mean value | 1.69 | 62.2 | 168 |
| SD | 0.04 | 2.39 | 4.17 |
| % CV | 2.6 | 3.8 | 2.5 |
| % Dev | 12.4 | 3.7 | 12.1 |
| n | 6 | 6 | 6 |

Obviously, it can be known from the data in Table 15 that the content of the methanol solution of AST-2660 was stable after stored for 54 hours under conventional freezing conditions (a freezer commonly used in laboratories).

TABLE 16
The experimental table stability study data of AST-2660
in human plasma at room temperature
AST-2660 concentration

| Analysis batch 20 | 0 hour | 4 hours | 24 hours |
|---|---|---|---|
| QC1 | 1.32 | 1.31 | 1.28 |
| 1.50 ng/ml | 1.38 | 1.34 | 1.38 |
| | 1.55 | 1.42 | 1.27 |
| | 1.44 | 1.34 | 1.33 |
| Mean value | 1.42 | 1.35 | 1.32 |
| SD | 0.10 | 0.05 | 0.05 |
| CV (%) | 6.90 | 3.49 | 3.85 |
| RE (%) | −5.2 | −9.8 | −12.3 |
| n | 4 | 4 | 4 |
| QC4 | 130 | 130 | 117 |
| 150 ng/ml | 142 | 141 | 128 |
| | 135 | 136 | 124 |
| | 137 | 145 | 129 |
| Mean value | 136 | 138 | 125 |
| SD | 5.0 | 6.5 | 5.4 |
| CV (%) | 3.7 | 4.7 | 4.4 |
| RE (%) | −9.3 | −8.0 | −17.0 |
| n | 4 | 4 | 4 |
| DilQC | 1610 | 1500 | 1380 |
| (10-fold | 1770 | 1710 | 1500 |
| dilution) | 1700 | 1600 | 1480 |
| 1500 ng/ml | 1640 | 1560 | 1460 |
| Mean value | 1680 | 1593 | 1455 |
| SD | 70.7 | 88.5 | 52.6 |
| CV (%) | 4.2 | 5.6 | 3.6 |
| RE (%) | 12.0 | 6.2 | −3.0 |
| n | 4 | 4 | 4 |

Obviously, according to the data in Table 16, the human plasma samples containing AST-2660 are not stable at room temperature. With the prolongation of the storage time, the content of AST-2660 in human plasma samples has been decreasing, which suggests that during the collection of human plasma samples in the relevant clinical patients, the collected plasma samples should be immediately stored in the above-mentioned experimentally verified low temperature environment: storage at −70° C. is the safest, and storage at −20° C. is also acceptable, and storage in the conventional refrigerator (4° C. to 0° C.) if the storage conditions are limited and should be transferred to the above-mentioned low temperature environment within 4 hours. During the transportation of samples to the DMPK sample testing center laboratory, the whole process of cold chain logistics (the temperature should be monitored during the whole process) should be used, wherein temperature should be selected to be below −20° C. or using dry ice for insulation.

According to the above experimental results, it can be known that:
(1) Human plasma samples containing AST-2660 should be immediately stored in the above-mentioned experimentally verified low temperature environment after collection: storage at −70° C. is the safest, and storage at −20° C. is also possible, and in a conventional refrigerator (4° C. to 0° C.) if the storage conditions are limited and should be transferred to the above low temperature environment within 4 hours. During the transportation of samples to the DMPK sample testing center laboratory, the whole process of cold chain logistics (the temperature should be monitored during the whole process) should be used, wherein the temperature should be selected to be below −20 ° C. or using dry ice for insulation.
(2) The sample should be stored at −70° C. or lower of temperature conditions, and it was stable under this condition for 28 days. Moreover, it may be stable for a longer time according to the changing trend.
(3) During the process of taking out the stored samples to room temperature, that is, the sharp temperature changes of the samples in human plasma stored at −70° C. from the storage conditions to room temperature for the experimental process did not affect the stability of AST-2660 in human plasma samples. They should be stored in a conventional refrigerator (4° C. to 0° C.) after being taken out, and the storage time in a conventional refrigerator should not be longer than 4 hours. If they are stored at room temperature, the content of AST-2660 will decrease and thus they cannot be used.
(4) The content of the methanol solution of AST-2660-D8 will not change after being stored at −70° C. for 26 days, and it has strong stability. Moreover, it may be stable for a longer time according to the changing trend.

Therefore, in the above operation SOP for blood samples, the blood samples should be stored in an environment below −20° C., preferably in an environment at −70° C. within 4 hours after collection and can be stored for 28 days at −70° C.; if the blood samples were treated according to the above-mentioned extraction, they should be refrigerated at the temperature of 4° C. or below and an injection detection should be completed within 54 hours in an environment at room temperature in laboratory; the results detected in compliance with these storage temperatures and times were reliable; otherwise, the results will be untrue and unreliable owing to changes in AST-2660 in the sample during storage.

### Example 6 Establishment and Verification of the Detection Method of AST-2660 in Human Urine

In this example, the establishment steps of the detection method of AST-2660 in human urine were basically the same as those in Example 4, and the differences between them were only in that the matrix was different (human plasma in Example 4, human urine in this example) and the sample extraction steps were slightly different. The mixed normal human (no drug administration) urine containing the additive Na₂HPO₄·12H₂O was used as diluent and matrix.

### 1. Pretreatment of the Samples

The steps for extracting samples using protein precipitation method:
1. Confirming the labeling and sequence of standard samples, quality control samples, and plasma samples;
2. Placing all samples on a Multi-Tube vortexer for vortexing uniformly after thawing;
3. Taking 100 μl from each sample and adding them to a 96-well plate;
4. In addition to the blank sample, adding 20 μl of AST-2660-D8 quality control working solution (i.e., 100 ng/ml of AST-2660-D8 methanol solution); adding 20 μl of methanol to the blank sample;
5. Adding 500 μl of methanol;
6. Vortexing the plate at a medium speed for 3 minutes;
7. Centrifuging the 96-well plate at 2143 rcf (centrifugal force) for 10 minutes;
8. Transferring 450 μl of the supernatant to a new 96-well plate;
9. Centrifuging the 96-well plate at 2143 rcf (centrifugal force) for 10 minutes;
10. Transferring 300 μl of the supernatant to a new 96-well plate.

### 2. Experimental Results

### 2.1 Standard Curve

Parameters of AST-2660 standard curve in human urine were as follows: slope: 0.001400, intercept: 0.000016, correlation coefficient 0.9982, then the relationship function y=f (x)=0.001400x+0.000016, where y represents the ratio of the peak area of metabolite II to that of internal standard compound, x represents the concentration of metabolite II in the standard working solution, LLOQ (the lower limit of quantification): 0.5 ng/ml, ULOQ (the upper limit of quantification): 200 ng/ml. As can be seen that the linear relationship was good in the linear range of 0.5200 ng/ml.

### 2.2 Accuracy and Precision Test Results of Quality Control Samples

Accuracy and precision are defined as follows:
Accuracy represents relative error (RE).
RE=[(mean value-nominal value)/nominal value]×100
Precision represents coefficient of variation (CV).
CV=(standard deviation/mean value)×100.

The accuracy and precision test results were shown in Table 17. It can be seen from Table 17 that the intra-assay and inter-assay precisions were both less than 15.5%, and the intra-assay and inter-assay accuracies were within ±11.4. The analytical criteria for accuracy and precision were as follows: for LLOQ QC samples, the intra-assay and inter-assay accuracy (RE) must be within ±20.0%, and intra-assay and inter-assay CV must be not greater than 20.0%. The intra-assay and inter-assay accuracy (RE) must be within ±15.0% for low, geometric mean, medium, high, and diluted QC (if applicable) samples; intra-assay and inter-assay precision (CV) must be not greater than 15.0% at each QC concentration level. Therefore, the intra-assay and inter-assay precisions and accuracies of the quality control samples met the requirements. The precision (%CV) of the internal standard AST-2660-D8 was less than or equal to 13.4%, which met the requirements.

TABLE 17
The intra-assay and inter-assay precision and accuracy results for quality
control samples

| AST-2660 | | | Intra-assay | Inter-assay | |
|---|---|---|---|---|---|
| Intra-assay and | LLOQQC | 0.500 ng/ml | ≤15.5% | 12.3% | Each |
| inter-assay | QC1 | 1.50 ng/ml | ≤10.8% | 8.1% | concentration |
| precision of | QC3 | 60.0 ng/ml | ≤6.3% | 3.8% | level met the |
| quality control in | QC4 | 150 ng/ml | ≤4.1% | 3.0% | acceptable |
| the three assay | | | | | requirements |
| batches with | | | | | |
| acceptable | | | | | |
| accuracy and | | | | | |
| precision analysis | | | | | |
| (% CV) | | | | | |
| AST-2660 | | | Intra-assay | Inter-assay | |
| Intra-assay and | LLOQQC | 0.500 ng/ml | −4.8% to 11.4% | 1.4% | Each |
| inter-assay | QC1 | 1.50 ng/ml | 2.0% to 4.7% | 3.3% | concentration |
| accuracy of | QC3 | 60.0 ng/ml | 6.3% to 11.4% | 7.0% | level met the |
| quality control in | QC4 | 150 ng/ml | 4.7% to 10.0% | 9.3% | acceptable |
| the three assay | | | | | requirements |
| batches with | | | | | |
| acceptable | | | | | |
| accuracy and | | | | | |
| precision analysis | | | | | |
| (% RE) | | | | | |

### 2.3 Test Results of Matrix Effect

TABLE 18
Test results of matrix effect

| AST-2660 | LLOQQC | 0.500 ng/ml | At least two thirds of the | Meeting the |
|---|---|---|---|---|
| Precision of the | QC4 | 150 ng/ml | QC repeat samples have a | acceptable |
| intra-assay matrix | | | RE which must be within | requirements. |
| (%) | | | ±20.0% (LLOQQC), or | |
| | | | within ±15.0% (QC4). | |
| AST-2660 | QC1 | 1.50 ng/ml | 0.82, CV %: 31.3% | No standard limit |
| Matrix effect | QC4 | 150 ng/ml | 0.69, CV %: 33.6% | |
| (mean matrix factor) | | | | |
| AST-2660 | QC1 | 1.50 ng/ml | 1.08, CV %: 10.0% | Meeting the |
| Matrix effect | QC4 | 150 ng/ml | 0.972, CV %: 9.5% | acceptable |

| | |
|---|---|
| (internal | requirements. |
| standard-normalized | |
| matrix factor) | |

According to the results in Table 18, it can be seen that the inter-assay matrix accuracy and precision (CV) of the matrix effect of AST-2660 were both less than 15%, which met the requirements.

### 2.4 Stability

TABLE 19
Stability results of AST-2660 working solution

| | | | |
|---|---|---|---|
| The experimental table | Accuracy and precision | CV: ≤8.8% | Meeting the |
| stability of AST-2660 | at three concentration | RE: −8.5% to 4.5% | acceptable |
| in human urine at room | levels (1.5 ng/ml, | | requirements |
| temperature for 4 hours | 150 ng/ml and 1500 ng/ml) | | |
| The freezing/thawing | Accuracy and precision | CV: ≤11.5% | Meeting the |
| stability of AST-2660 | at three concentration | RE: −11.8% to 12.5% | acceptable |
| at −70° C. for up to 3 | levels (1.5 ng/ml, | | requirements |
| and cycles | 150 ng/ml and 1500 ng/ml) | | |
| The stability of | Accuracy and precision | CV: ≤11.3% | Meeting the |
| AST-2660 at −70° C. | at three concentration | RE: −1.2% to −13.7% | acceptable |
| for 34 days. | levels (1.5 ng/ml, 150 | | requirements |
| | ng/ml and 1500 ng/ml) | | |

It can be seen from Table 19 that the accuracy of the stability of AST-2660 working solution was within ±11.8%, and the precision was less than 11.5%. Stability analysis criteria: the difference between the storage stability solution and the freshly prepared solution must be within ±10.0%, and the CV of the each replicate experiment must not be greater than 15.0%. Therefore, AST-2660 working solution had good stability and met the requirements under various storage conditions.

The liquid chromatography-tandem mass spectrometry method established in this example for detecting AST-2660 in human urine met the analysis requirements of biological sample: the sample processing method is simple and convenient; and this method had high sensitivity, precision, and accuracy.

### Example 7 Detection of the Content of AST-2660 in Actual Human Urine

The detection method established in example 6 was used to detect the content of AST-2660 in the human urine to be tested.

The standard operating procedure (SOP) for detection established after the methodology and validation according to example 6 was as follows:

### Step 1. Formulation of Solution

Matrix: the mixed normal human urine containing an additive Na₂HPO₄·12H₂O.
a: the internal standard working solution: AST-2660-D8 was taken, dissolved with methanol, and diluted to prepare a solution containing about 100 ng per 1 ml.
b: the solution to be tested (no internal standard compound was added to the solution to be tested at this time): it was obtained by taking a blood sample to be tested.
c: the standard working solution (no internal standard compound was added to the standard working solution at this time): an appropriate amount of AST-2660 was taken and accurately weighed, dissolved with methanol and diluted to prepare a solution containing about 1.0 mg per 1 ml, which was used as the standard working stock solution. An appropriate amount of the standard working stock solution was taken, added with the matrix and diluted to prepare standard working solutions with different concentrations containing about 200 ng, 160 ng, 100 ng, 50 ng, 10 ng, 2.0 ng, 1.0 ng and 0.5 ng per 1 ml, respectively. (The solution was stored at −70° C.)
d: the quality control sample solution: an appropriate amount of AST-2660 was taken and accurately weighed, dissolved with methanol, and diluted to prepare a solution containing about 10 μg per 1 ml, which was used as the quality control working stock solution. An appropriate amount of the quality control working stock solution was taken, and added with the matrix to prepare quality control working solutions with different concentrations containing about 150 ng, 60 ng, 15 ng, 1.5 ng and 0.5 ng per 1 ml. (The solution was stored at −70° C.)

### Step 2. Extraction of Sample

The solution to be tested, the standard working solution and the quality control sample solution were thawed at room temperature and mixed uniformly. 100 μl of the above solution was respectively taken, added with 20 μl of the internal standard and 500 μl of methanol, and vortexed for 3 minutes to mix uniformly, and then centrifuged for 30 minutes at 2143 rcf. 450 μl of supernatant was taken, and then centrifuged for 10 minutes in a 96-well plate at 2143 rcf. It was obtained by taking 300 μl of supernatant.

100 μl of the blank human urine was taken, added with 20 μl of methanol and extracted with the same method to obtain the blank sample.

100 μl of the blank human urine was taken, added with 20 μl of the internal standard working solution and extracted with the same method to obtain the zero-concentration sample.

After sample extraction and the addition of internal standard, the solution was injected into LC-MS/MS for detection in step 4.

### Step 3. Setting up Chromatography-Mass Spectrometry Test Conditions

Determination was performed using liquid chromatography-tandem mass spectrometry (LC-MS/MS), and the following instrument test conditions were set up:

Liquid phase conditions: A SHARC 1, 3 μm, 2.1*50 mm or chromatograph column with equivalent performance was used; methanol solution containing low content of ammonium acetate was used; mobile phase B was acetonitrile; the gradient elution was performed according to the following table; column temperature: 20° C.; injection volume: 5 μl.

TABLE 20
The gradient elution conditions for testing with the
liquid chromatograph in Example 7

| Time | Flow Rate | % A | % B |
|---|---|---|---|
| Initial | 0.8 | 15 | 85 |
| 1.5 | 0.8 | 50 | 50 |
| 2.0 | 0.8 | 90 | 10 |
| 2.5 | 0.8 | 15 | 85 |

Mass spectrometric conditions: electrospray ion source with negative ion scanning mode; spray potential: −4500 V; ion source temperature: 500° C.; collision energy (CE): −22 eV; declustering potential (DP): −55V; entrance potential (EP): −10V; collision chamber exit potential (CXP): −16V; dwell time: 100 ms; high purity nitrogen was used for all gases; AST-2660 ions pairs: m/z 147.0→m/z 62.9; the internal standard AST-2660-D8 ion pairs: m/z 155.0→m/z 62.9.

### Step 4. Determination

The AST-2660 standard working solution, blank sample, zero concentration sample, solution to be tested and quality control working solution with different concentrations after extraction were respectively taken and injected into LC-MS/MS for detection.

Acceptance criteria: the recovered concentration of the standard working solution, and the accuracy of the quality control working solution and the peak residue of AST-2660 and the internal standard in the blank sample should meet the requirements in Chinese Pharmacopoeia (2020 edition), Vol. 4, 9012.

The prepared standard working solutions of metabolites II with different concentrations were absorbed and injected into the LC-MS/MS system for detection to obtain a relationship function y=f (x), wherein y represents the ratio of the peak area of the metabolite II to that of the internal standard compound, and x represents the concentration of the metabolite II in the standard working solutions;

Calculation results: the relationship function y=f (x) of the ratio of the peak area of AST-2660 to that of the internal standard was obtained from AST-2660 standard working solutions with different concentrations. The ratio of the peak area of AST-2660 to that of the internal standard was determined from the solution to be tested after extraction, and substituted into the relationship function y=f (x) to calculate the concentration of the metabolite II in the solution to be tested.

The relationship function was used to determine and calculate the concentration of the metabolite II in the solution to be tested with unknown concentration. The solution to be tested added with the internal standard compound with known content was absorbed and injected into the LC-MS/MS system for detection. The ratio y of the peak area of the metabolite II to that of the internal standard compound was determined and substituted into the function y=f (x) to obtain the concentration x of the metabolite II in the solution to be tested.

As an option, the order of the above SOP related operation steps was slighted changed to obtain the following operation SOP:

A biological sample solution to be tested was added with a quantitative internal standard compound and taken as a solution to be tested after extraction treatment;

A series of solutions of metabolite II with different concentrations were obtained by diluting a metabolite II reference substance, added with the quantitative internal standard compound and taken as a standard working solution after extraction treatment; the series of standard working solutions were absorbed, respectively, injected into an LC-MS/MS system for detection to obtain the peak area of the metabolite II and the internal standard compounds, the ratio of the peak area of the metabolite II to that of the internal standard compounds was taken as an ordinate and the concentration of the metabolite II was taken as an abscissa to draw a standard curve and calculate a regression equation;

The solution to be tested was absorbed, and injected into the LC-MS/MS system for detection; the ratio of the peak area of the metabolite II to that of the deuterated compound I in the solution to be tested was determined, substituted into the regression equation to obtain the content of the metabolite II in the biological sample solution to be tested.

The solutions with the same concentration were prepared by using containers with the same volume according to the habits of laboratory operators using the above changed SOP. This operation only needs to ensure that the volume of the added solution was the same, and the obtained standard working solution was still with the same concentration.

FIGS. 11 to 14 are some typical spectra of the detection process of urine samples.

FIG. 11 is typical LC-MS/MS spectra of AST-2660 and the internal standard AST-2660-D8 in blank human urine extracts.

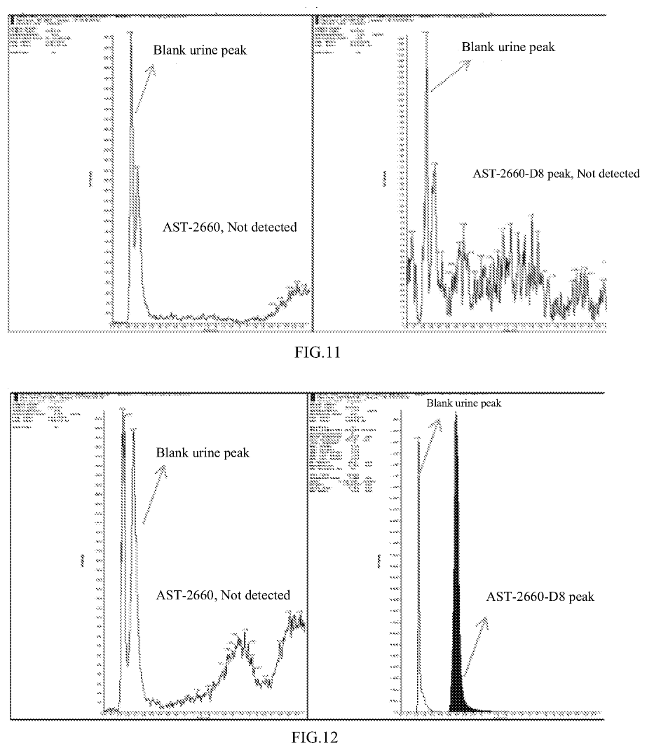

FIG. 12 is typical LC-MS/MS spectra of AST-2660 and the internal standard AST-2660-D8 in zero concentration of urine sample extracts.

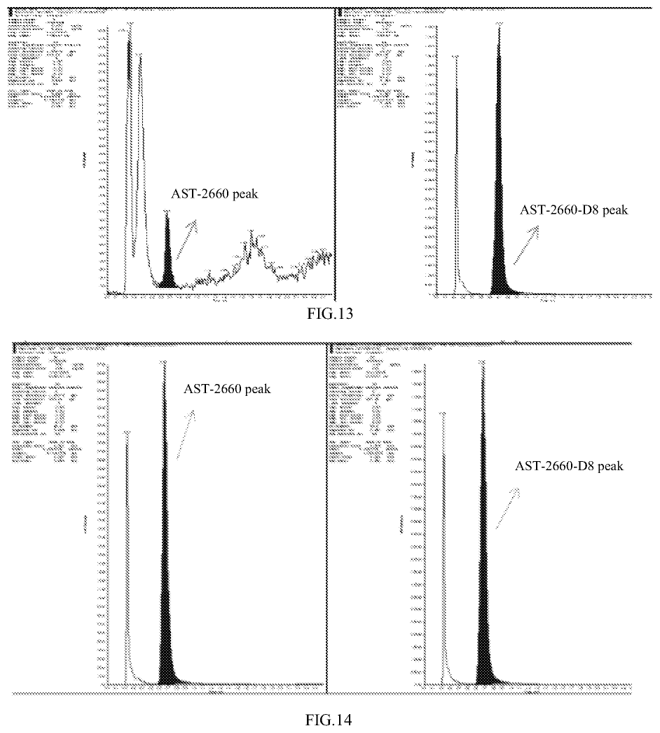

FIG. 13 is typical LC-MS/MS spectra of AST-2660 and the internal standard AST-2660-D8 in standard sample solution of human urine extracts (0.50 ng/ml).

FIG. 14 is typical LC-MS/MS spectra of AST-2660 and the internal standard AST-2660-D8 in standard sample solution of human urine extracts (200 ng/ml).

Some of the samples were detected using the operating procedures for the detection of AST-2660 content in human urine provided in this example. The results were shown in Tables 21-24 below.

TABLE 21
Stability study data of AST-2660 in human urine at
−20° C. and −70° C. for one month

| Stability study data of | | Stability study data of | |
|---|---|---|---|
| AST-2660 in human urine | | AST-2660 in human urine | |
| at −20° C. for one month | | at −70° C. for one month | |
| | 32 days at | | 32 days at |
| Analysis batch 12 | −20° C. | Analysis batch 13 | −70° C. |
| QC1 | <LLOQ (0.500) | QC1 | 1.53 |
| 1.50 ng/ml | <LLOQ (0.500) | 1.50 ng/ml (This | 1.97 |
| | <LLOQ (0.500) | set of data was | 1.72 |
| | <LLOQ (0.500) | actually tested on | 1.60 |
| | | day 34) | |
| Mean value | NA | Mean value | 1.71 |
| SD | NA | SD | 0.193 |
| CV (%) | NA | CV (%) | 11.3 |
| RE (%) | NA | RE (%) | 13.7 |
| n | 4 | n | 4 |
| QC4 | 13.1 | QC4 | 155 |
| 150 ng/ml | 12.4 | 150 ng/ml | 159 |
| | 12.9 | | 161 |
| | 15.2 | | 168 |
| Mean value | 13.4 | Mean value | 161 |
| SD | 1.24 | SD | 5.44 |
| CV (%) | 9.2 | CV (%) | 3.4 |
| RE (%) | −91.1 | RE (%) | 7.2 |
| n | 4 | n | 4 |
| DilQC | 6.87 | DilQC | 1570 |
| (10-fold dilution) | 7.70 | (10-fold dilution) | 1400 |
| 1500 ng/ml | 7.73 | 1500 ng/ml | 1470 |
| | 6.60 | | 1490 |
| Mean value | 7.23 | Mean value | 1483 |
| SD | 0.577 | SD | 69.9 |
| CV (%) | 8.0 | CV (%) | 4.7 |
| RE (%) | −99.5 | RE (%) | −1.2 |
| n | 4 | n | 4 |

Obviously, the human urine containing AST-2660 had almost no reduction in AST-2660 content after 32 days of storage at −70° C., whereas it was reduced by nearly 90% at −20° C. Therefore, the human urine samples containing AST-2660 must be stored at −70° C., under such conditions the samples stored for 32 days were still stable.

TABLE 22
Freeze/thaw stability study data of AST-2660 in human
urine at −20° C. and −70° C.
AST-2660 concentration (ng/ml)

| Analysis | 5 cycles at | Analysis | 3 cycles at | 5 cycles at |
|---|---|---|---|---|
| batch 13 | −20° C.^{a} | batch 13 | −70° C.^{a} | −70° C^{a.} |
| QC1 | <LLOQ (0.500) | QC1 | 1.47 | 1.68 |
| 1.50 ng/ml | <LLOQ (0.500) | 1.50 ng/ml | 1.51 | 1.52 |
| | <LLOQ (0.500) | | 1.69 | 2.14 |
| | <LLOQ (0.500) | | 1.72 | 1.58 |
| Mean value | NA | Mean value | 1.60 | 1.73 |
| SD | NA | SD | 0.13 | 0.281 |
| CV (%) | NA | CV (%) | 7.9 | 16.3 |
| RE (%) | NA | RE (%) | 6.5 | 15.3 |
| n | 4 | n | 4 | 4 |
| QC4 | 12.2 | QC4 | 145 | 172 |
| 150 ng/ml | 13.0 | 150 ng/ml | 148 | 172 |
| | 12.3 | | 154 | 169 |
| | 12.5 | | 148 | 178 |
| Mean value | 13 | Mean value | 149 | 173 |
| SD | 0.36 | SD | 4 | 3.77 |
| CV (%) | 2.8 | CV (%) | 2.5 | 2.2 |
| RE (%) | −91.7 | RE (%) | −0.8 | 15.2 |
| n | 4 | n | 4 | 4 |
| DilQC | <LLOQ (5.00) | DilQC | 1650 | 1490 |
| (10-fold | <LLOQ (5.00) | (10-fold | 1500 | 1500 |
| dilution) | <LLOQ (5.00) | dilution) | 1510 | 1500 |
| 1500 ng/ml | <LLOQ (5.00) | 1500 ng/ml | 1500 | 1540 |
| Mean value | NA | Mean value | 1540 | 1508 |
| SD | NA | SD | 73 | 22.2 |
| CV (%) | NA | CV (%) | 4.8 | 1.5 |
| RE (%) | NA | RE (%) | 2.7 | 0.5 |
| n | 4 | n | 4 | 4 |

^{a}Freeze-thaw cycle stability samples were first frozen at nominal temperatures of −20° C. and −70° C. for at least 24 hours and then thawed at room temperature. Samples were frozen for at least 12 hours for subsequent cycles.

Obviously, the human urine containing AST-2660 had almost no reduction in AST-2660 content during the freeze-thaw process from −70° C. to room temperature, while it was reduced by nearly 90% during the freeze-thaw process from −20° C. to room temperature; that is, according to the data in Table 22, it can be seen that the sharp temperature changes of the samples in human plasma stored at −70° C. from the storage condition to room temperature for the experimental process did not affect the stability of AST-2660 in human plasma samples.

TABLE 23
Stability of human urine sample treated at room
temperature (the change of AST-2660 content)

| | Concentration | | |
|---|---|---|---|
| Analysis | PSS_QC1 | PSS_QC3 | PSS_QC4 |
| batch 13 | 1.5 ng/ml | 60 ng/ml | 150 ng/ml |
| t = 94 hours | 1.36 | 57.2 | 144 |
| | 1.33 | 56.6 | 150 |
| | 1.37 | 59.1 | 149 |
| | 1.44 | 59.1 | 149 |
| | 1.46 | 58.9 | 147 |
| | 1.32 | 60.1 | 154 |
| Mean value | 1.38 | 58.5 | 149 |
| SD | 0.0576 | 1.32 | 3.31 |
| CV (%) | 4.2 | 2.3 | 2.2 |
| RE (%) | −8.0 | −2.5 | −0.8 |
| n | 6 | 6 | 6 |

TABLE 24
The experimental table stability study data of AST-2660
in human urine at room temperature
AST-2660 concentration

| Analysis batch 20 | 0 hour | 4 hours | 24 hours |
|---|---|---|---|
| QC1 | 1.27 | 1.59 | 1.61 |
| 1.50 ng/ml | 1.37 | 1.36 | 1.87 |
| | 1.41 | 1.32 | 2.05 |
| | 1.44 | 1.51 | 2.07 |
| Mean value | 1.37 | 1.45 | 1.90 |
| SD | 0.0741 | 0.127 | 0.213 |
| CV (%) | 5.4 | 8.8 | 11.2 |
| RE (%) | −8.5 | −3.7 | 26.7 |
| n | 4 | 4 | 4 |
| QC4 | 141 | 156 | 149 |
| 150 ng/ml | 144 | 154 | 154 |
| | 142 | 159 | 149 |
| | 146 | 158 | 153 |
| Mean value | 143 | 157 | 151 |
| SD | 2.22 | 2.22 | 2.63 |
| CV (%) | 1.5 | 1.4 | 1.7 |
| RE (%) | −4.5 | 4.5 | 0.8 |
| n | 4 | 4 | 4 |
| DilQC | 1350 | 1390 | 1300 |
| (10-fold | 1430 | 1410 | 1300 |
| dilution) | 1400 | 1430 | 1310 |
| 1500 ng/ml | 1480 | 1430 | 1300 |
| Mean value | 1415 | 1415 | 1303 |
| SD | 54.5 | 19.1 | 5.00 |
| CV (%) | 3.8 | 1.4 | 0.4 |
| RE (%) | −5.7 | −5.7 | −13.2 |
| n | 4 | 4 | 4 |

As can be seen from Table 23, the treated human urine samples containing AST-2660 were stable for 94 hours at room temperature.

As can be seen from Table 24, the untreated human urine samples containing AST-2660 were stable for 24 hours at room temperature. According to the above experimental results, it can be known that:
(1) Human urine samples containing AST-2660 should be stored in the above experimentally validated low environment within 24 hours (at the latest) after collection: stored at −70° C. The samples should be kept as low temperature as possible (room temperature or lower) when they were sent to the DMPK sample testing center laboratory;
(2) The samples should be stored at −70° C. or lower of temperature conditions, and it was stable under this condition for 32 days. Moreover, it may be stable for a longer time according to the changing trend;
(3) The treated human urine samples containing AST-2660 were stable for 94 hours at room temperature or lower;
(4) During the process of taking out the stored samples to room temperature, that is, the sharp temperature changes of the samples in human urine stored at −70° C. from the storage conditions to room temperature for the experimental process did not affect the stability of AST-2660 in human urine samples. It was allowed that the sample should be placed in a conventional refrigerator or at room temperature after being taken out, and it was stable for up to 24 hours at room temperature.
(5) For the human urine samples, they should be stored at −70° C. within 24 hours, preferably within 4 hours, after collection; if treated, the injection detection should be completed within 94 hours at room temperature.

Therefore, in the above operation SOP for urine samples, the urine samples should be stored at −70° C. within 24 hours, preferably within 4 hours, after collection and can be stored for 32 days at −70° C.; if treated, the injection detection should be completed within 94 hours at room temperature or below; the results detected in compliance with these storage temperatures and times were reliable, otherwise, the results will be untrue and unreliable owing to changes in AST-2660 in the sample during storage.

1. A deuterated compound I having a structure as shown in Formula (I): 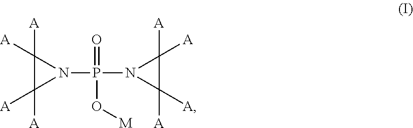
wherein A is H or D, and at least one of eight As is D;
M is H or an alkali metal, an alkaline earth metal, or an ammonium radical.

2. The deuterated compound I according to claim 1, wherein at least three of the eight As are D, preferably the number of D is 4 or 8, more preferably M is Na, K, Li or an ammonium radical.

3. (canceled)

4. (canceled)

5. The deuterated compound I according to claim 1, wherein the deuterated compound I is a compound having a structure as shown in Formula (I-1) or (I-2):

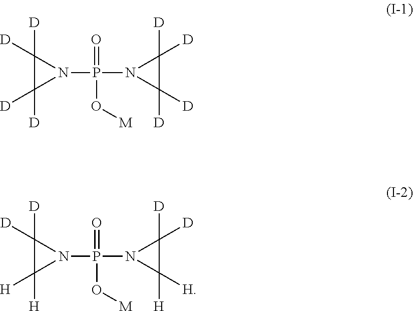

6. The deuterated compound I according to claim 1, wherein the deuterated compound I is selected from compounds having the following structures:

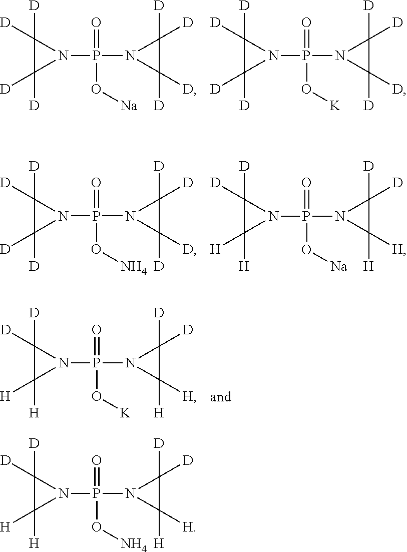

7. A method for preparing a deuterated compound I, comprising the steps of: 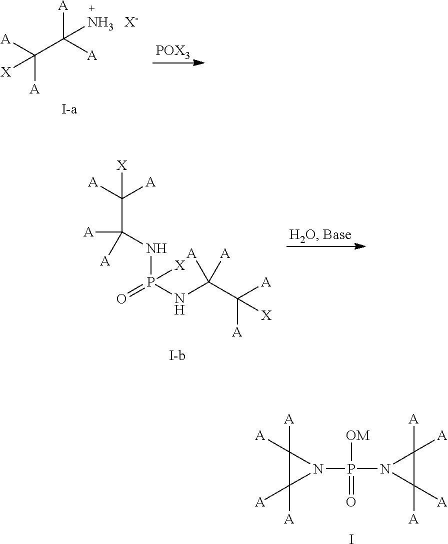
reacting compound I-a with phosphorus oxyhalide PDX₃ to obtain compound I-b;
hydrolyzing compound I-b in an aqueous solution with or without a base to correspondingly obtain the deuterated compound I;
wherein compound I-a is deuterated 2-halogenated ethylamine or an inorganic acid salt thereof; A is H or D; and at least one of four As of compound I-a is D; and at least one of eight As of compound I-b and compound I is D;
the base in the hydrolysis reaction is selected from MOH, wherein M is an alkali metal, an alkaline earth metal or an ammonium radical; MH, wherein M is an alkali metal; MOR, wherein R is an alkyl group with 1-4 carbon atoms, and M is an alkali metal, carbonate or bicarbonate of alkali metal;
X is halogen.

8. The method according to claim 7, wherein compound I-a and the phosphorus oxyhalide PDX3 are dissolved in an organic solvent to lower the temperature, and an organic base solution is dropwise added to obtain the compound I-b;
preferably, the temperature is lowered to −78 to −20° C.; and/or preferably, the organic solvent is one or a mixture of two or more of dichloromethane, chloroform, chlorobenzene, 1,2-dichloroethane, ethyl acetate, n-hexane or cyclohexane and tetrahydrofuran; and/or
preferably, the organic base is one or a mixture of two or more of methylamine, ethylamine, propylamine, isopropylamine, N,N-diethylamine, triethylamine, n-butylamine, isobutylamine, 4-dimethylaminopyridine, N,N-diisopropylethylamine, 1,8-diazabicyclo[5.4.0]undec-7-ene, N,N,N′,N′-tetramethylethylenediamine, tetramethylguanidine, pyridine, N-methyldicyclohexylamine or dicyclohexylamine; and/or
the reaction of compound I-a with phosphorus oxyhalide PDX3 is performed under an atmosphere, wherein the atmosphere is one of air, nitrogen or argon; preferably, the atmosphere is one of nitrogen or argon; more preferably, the atmosphere is nitrogen.

9. A method for measuring the content of the deuterated compound I according to claim 1 by using a ³¹P-NMR method; preferably, a method for measuring the content of the deuterated compound I in a solution containing the deuterated compound I by using a ³¹P-NMR method; or by using a liquid chromatography, wherein the liquid chromatography conditions are as follows:
a hydrogen acceptor type stationary phase chromatography column is used;
mobile phase A is methanol solution of ammonium acetate, and mobile phase B is acetonitrile;
mobile phases A and B are used for gradient elution, which gradually increased from 15% by volume ratio to 90% by volume ratio of mobile phase A, and then gradually decreased to 15% by volume ratio of mobile phase A.

10. A method for measuring the content of the deuterated compound I according to claim 1, comprising the steps of:
detecting ³¹P-NMR of the deuterated compound I and the phosphorus-containing compound with known content to obtain their spectra; and
substituting the content of the phosphorus-containing compound with known content to calculate and obtain the content of the deuterated compound I, based on the peak area ratio of the chemical shift characteristic peaks of the deuterated compound Ito the phosphorus-containing compound in the ³¹P-NMR spectra.

11. The method according to claim 10, wherein
the phosphorus-containing compound is preferably a compound containing one phosphorus atom, more preferably is hexamethylphosphoric triamide;
the deuterated compound I and the phosphorus-containing compound with known content are added to the solvent and tested for their ³¹P-NMR spectra; preferably, the deuterated compound I and the phosphorus-containing compound with known content are added to water and tested for their ³¹P-NMR spectra after they have been dissolved.

12.-16. (canceled)

17. A method for measuring the content of the metabolite in a biological sample, comprising the steps of:
preparing a solution to be tested containing an internal standard compound with known concentration for injection analysis by LC-MS/MS;
preparation of a standard working solution: preparing a series of standard working solutions containing an internal standard compound with known concentration and a metabolite II with known concentration, wherein the concentration of the internal standard compound in the series of standard working solutions is consistent and the same as the concentration of the internal standard compound in the solution to be tested, and the concentration of the metabolite II in the series of standard working solutions is different;
determining a relationship function by liquid chromatography-tandem mass spectrometry (LC-MS/MS): absorbing the prepared standard working solutions of metabolite II with different concentrations, and injecting them into the LC-MS/MS system for detection to obtain the relationship function y=f (x), wherein y represents the ratio of the peak area of the metabolite II to that of the internal standard compound, and x represents the concentration of the metabolite II in the standard working solutions;
determining and calculating the concentration of the metabolite II in the solution to be tested with unknown concentration by using the relationship function: absorbing the solution to be tested added with the internal standard compound with known content, injecting it into the LC-MS/MS system for detection to obtain the ratio y of the peak area of the metabolite II to that of the internal standard compound, substituting it into the function y=f (x) to obtain the concentration x of the metabolite II in the solution to be tested;
wherein the solution to be tested is prepared from the biological sample with or without treatment,
wherein the internal standard compound is a deuterated compound I, which has a structure as shown in a Formula (I): 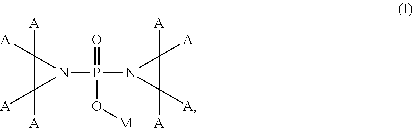
A is H or D, and at least one of eight As is D;
M is H or an alkali metal, an alkaline earth metal, or an ammonium radical;
wherein the metabolite II has a structure as shown in the formula (II): 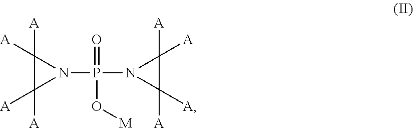
A is H;
M is H or an alkali metal, an alkaline earth metal, or an ammonium radical;
preferably, the deuterated compound I is selected from 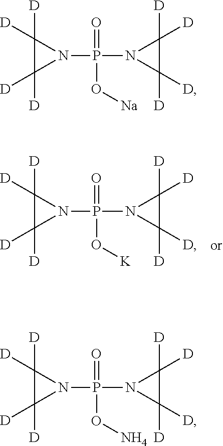
preferably, the metabolite II is selected from 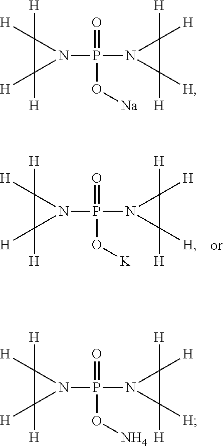
preferably, the metabolite II is a metabolite II of an AKR1C3-activated DNA alkylating agent prodrug or a hypoxia-activated DNA alkylating agent prodrug;
preferably, the conditions for liquid chromatography in liquid chromatography-tandem mass spectrometry are as follows:
a hydrogen acceptor type stationary phase chromatography column is used;
mobile phase A is methanol solution of ammonium acetate, and mobile phase B is acetonitrile;
mobile phases A and B are used for gradient elution: gradually increasing from 15% by volume ratio to 90% by volume ratio of mobile phase A, and then gradually decreasing to 15% by volume ratio of mobile phase A;
the mass spectrometry conditions: electrospray ion source;
in negative ion scanning mode the monitoring ion pair of the metabolite II is: m/z 147.0→m/z 62.9;
the monitoring ion pair of the deuterated compound I is: m/z (147.0+number of deuteration)→m/z 62.9;
or
in positive ion scanning mode
the monitoring ion pair of the metabolite II is: m/z 149.0→m/z 64.9;
the monitoring ion pair of the deuterated compound I is: m/z (149.0+number of deuteration)→m/z 64.9.

18. A method for measuring the content of the metabolite in a biological sample, comprising the steps of:
adding a quantitative internal standard compound to a biological sample solution to be tested and taking it as a solution to be tested after extraction treatment;
diluting a metabolite II reference substance to obtain a series of standard solutions of metabolite II with different concentrations, adding the quantitative internal standard compound and taking it as a standard working solution after extraction treatment, absorbing the series of standard working solutions, respectively injecting them into an LC-MS/MS system for detection to obtain the peak area of the metabolite II and the internal standard compounds, taking the ratio of the peak area of the metabolite II to that of the internal standard compounds as an ordinate and taking the concentration of the metabolite II as an abscissa to draw a standard curve and calculate a regression equation;
absorbing the solution to be tested, injecting it into the LC-MS/MS system for detection to obtain the ratio of the peak area of the metabolite II to that of the internal standard compound in the solution to be tested, substituting it into the regression equation to obtain the content of the metabolite II in the solution to be tested;
wherein the internal standard is a deuterated compound I, which has a structure as shown in a Formula (I): 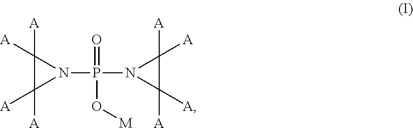
A is H or D, and at least one of eight As is D;
M is H or an alkali metal, an alkaline earth metal, or an ammonium radical;
wherein the metabolite II has a structure as shown in the formula (II): 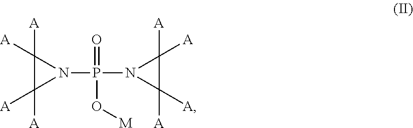
A is H;
M is H or an alkali metal, an alkaline earth metal, or an ammonium radical;
preferably, the deuterated compound I is selected from 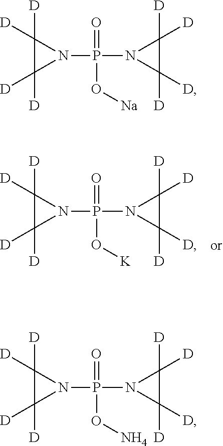
preferably, the metabolite II is selected from 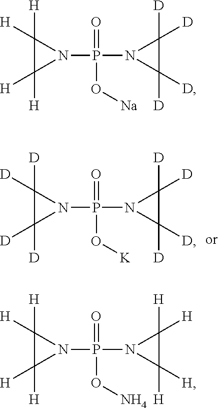
preferably, the metabolite II is a metabolite II of an AKR1C3-activated DNA alkylating agent prodrug or a hypoxia-activated DNA alkylating agent prodrug;
preferably the conditions for liquid chromatography in liquid chromatography-tandem mass spectrometry are as follows:
a hydrogen acceptor type stationary phase chromatography column is used;
mobile phase A is methanol solution of ammonium acetate, and mobile phase B is acetonitrile;
mobile phases A and B are used for gradient elution: gradually increasing from 15% by volume ratio to 90% by volume ratio of mobile phase A, and then gradually decreasing to 15% by volume ratio of mobile phase A;
the mass spectrometry conditions: electrospray ion source;
in negative ion scanning mode
the monitoring ion pair of the metabolite II is: m/z 147.0→m/z 62.9;
the monitoring ion pair of the deuterated compound I is: m/z (147.0+number of deuteration)→m/z 62.9;
or
in positive ion scanning mode
the monitoring ion pair of the metabolite II is: m/z 149.0→m/z 64.9;
the monitoring ion pair of the deuterated compound I is: m/z (149.0+number of deuteration)→m/z 64.9.

19. (canceled)

20. The method according to claim 17, wherein
in the preparation of the solution to be tested containing the deuterated compound I with known content, the deuterated compound I is preferably firstly added into the biological sample solution and then the extraction operation is performed;
correspondingly, in the preparation of the standard working solution, the deuterated compound I is firstly added into a matrix solution containing metabolites II with known different concentrations and then the extraction operation is performed.

21. The method according to claim 18, wherein the biological sample is a urine sample or a plasma sample, and correspondingly, when the urine sample is measured, the corresponding matrix solution is the urine of a patient with an additive and without administration; when the blood sample is measured, the corresponding matrix solution is the plasma of a patient with an anticoagulant and without administration,. preferably, the operation process for the addition of the deuterated compound and extraction is as follows: the solution to be tested and the standard work solution are added into the solution of the deuterated compound I, methanol is added and mixed uniformly, and a supernatant is obtained by centrifugation;
wherein the additive is Na₂HPO₄ or K₂HPO₄ and the anticoagulant is K₂EDTA or Na₂EDTA.

22. (canceled)

23. The method according to claim 21, wherein
for the blood samples, they should be stored in an environment below −20° C., preferably in an environment at −70° C. within 4 hours after collection and can be stored for 28 days at −70° C.;
if treated, they should be refrigerated at 4° C. or below and an injection detection should be completed within 54 hours;
for the urine samples, they should be stored at −70° C. within 24 hours, preferably within 4 hours, after collection and can be stored for 32 days at −70° C.; if treated, the injection detection should be completed within 94 hours at room temperature or below.

24. The method according to claim 18, wherein
in the preparation of the solution to be tested containing the deuterated compound I with known content, the deuterated compound I is preferably firstly added into the biological sample solution and then the extraction operation is performed;
correspondingly, in the preparation of the standard working solution, the deuterated compound I is firstly added into a matrix solution containing metabolites II with known different concentrations and then the extraction operation is performed.

25. The method according to claim 20, wherein the biological sample is a urine sample or a plasma sample, and correspondingly, when the urine sample is measured, the corresponding matrix solution is the urine of a patient with an additive and without administration; when the blood sample is measured, the corresponding matrix solution is the plasma of a patient with an anticoagulant and without administration.

26. The method according to claim 17, wherein the AKR1C3-activated DNA alkylating agent prodrug is selected from the compounds having the following structures as shown in Formulae 1-5: 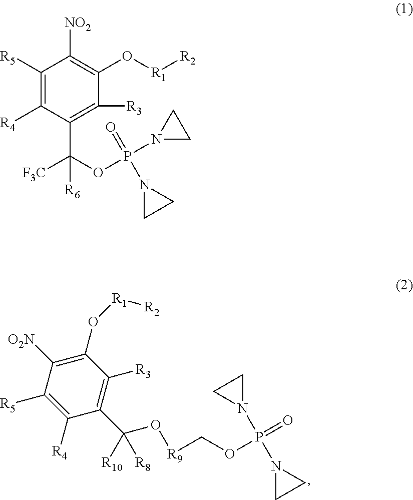
wherein the definitions of R₁, R₂, R₃, R₄, R₅, R₈, R₉, and R₁₀ are as described in the claims of Patent Application PCT/CN2020/089692 with Publication No. WO2020228685A1;
or 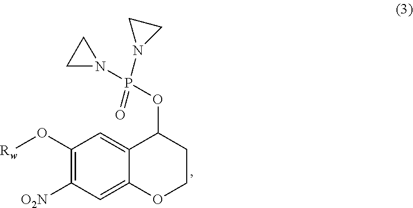
wherein the definition of Rw is as described in the claims of Patent Application PCT/CN2020/120281 with Publication No. WO2021068952A1;
or 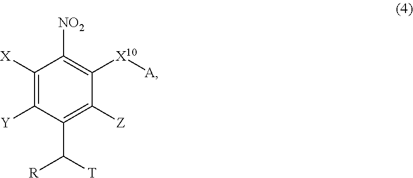
wherein the definitions of X, Y, Z, R, A and X¹⁰ are as described in the claims of Patent Application PCT/US2016/021581 with Publication No. WO2016145092A1 (corresponding to Chinese Patent Application No. 2016800150788 with Publication No. CN107530556A), and T is 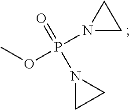
or 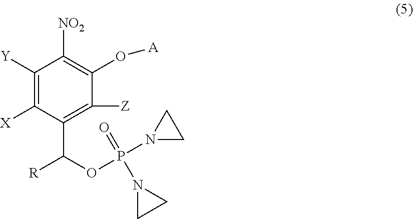
wherein:
A is a substituted or unsubstituted C₆-C₁₀ aryl, biaryl or a substituted biaryl, 5-15 membered heteroaryl, or —N═CR¹R², wherein the substituents are selected from the group consisting of halogeno, —CN, —NO₂, —O—(CH₂)—O—, —CO₂H and salts thereof, —OR¹⁰⁰, —CO₂R¹⁰⁰, —CONR¹⁰¹R¹⁰², —NR¹⁰⁰R¹⁰², —NR¹⁰⁰SO₂R¹⁰⁰, —SO₂R¹⁰⁰, —SO₂NR¹⁰¹R¹⁰², C₁-C₆ alkyl, and C₃-C₁₀ heterocyclyl;
wherein R¹⁰⁰, R¹⁰¹ and R¹⁰² are each independently hydrogen, C₁-C₈ alkyl, or C₆-C₁₂ aryl; or R¹⁰¹ and R¹⁰² together with the nitrogen atom to which they are attached to form a 5-7 membered heterocycle;
wherein the alkyl group and the aryl group are each substituted by 1-3 halogen groups or 1-3 C₁-C₆ alkyl groups;
R¹ and R² are each independently phenyl or methyl;
X, Y and Z are each independently hydrogen or halogeno; and
R is hydrogen or C1-C6 alkyl or halogen-substituted alkyl.

27. The method according to claim 26, wherein the hypoxia-activated DNA alkylating agent prodrug is selected from the group consisting of compounds having a structure as shown in the following structural Formulae 6-12: 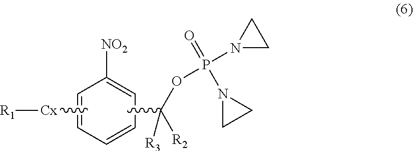
wherein the definitions of R₁, R₂, R₃ and Cx are as described in the claims of Patent Application PCT/CN2020/114519 with Publication No. WO2021120717A1;
or 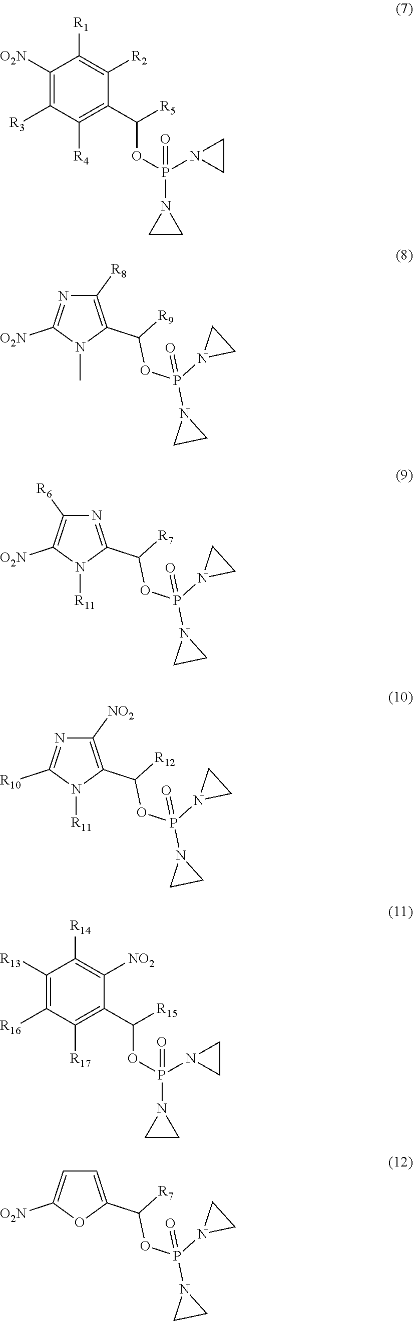
wherein the definitions of R₁, R₂, R₃, R₄, R₅, R₆, R₇, R₈, R₉, R₁₀, R₁₁, R₁₂, R₁₃, R₁₄, R₁₅, R₁₆ and R₁₇ are as described in the claims of Patent Application PCT/US2016/039092 with Publication No. WO2016210175A1 (corresponding to Chinese Patent Application No. 2016800368985 with Publication No. CN108024974A).

28. The method according to claim 18, wherein the AKR1C3-activated DNA alkylating agent prodrug is selected from the compounds having the following structures as shown in Formulae 1-5: 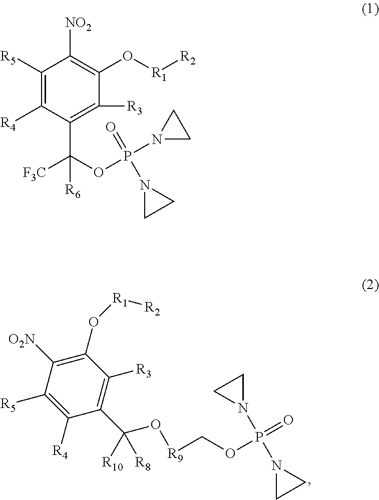
wherein the definitions of R₁, R₂, R₃, R₄, R₅, R₈, R₉, and R₁₀ are as described in the claims of Patent Application PCT/CN2020/089692 with Publication No. WO2020228685A1;
or 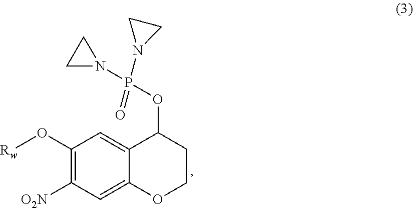
wherein the definition of Rw is as described in the claims of Patent Application PCT/CN2020/120281 with Publication No. WO2021068952A1;
or 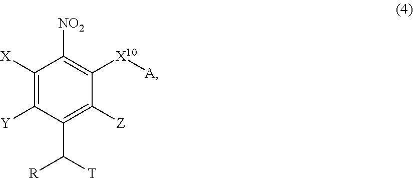
wherein the definitions of X, Y, Z, R, A and X¹⁰ are as described in the claims of Patent Application PCT/US2016/021581 with Publication No. WO2016145092A1 (corresponding to Chinese Patent Application No. 2016800150788 with Publication No. CN107530556A), and T is 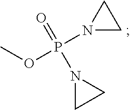
or 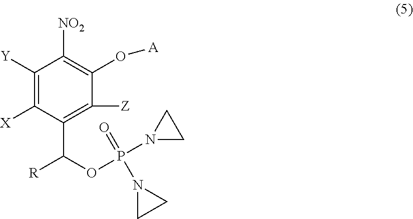
wherein:
A is a substituted or unsubstituted C₆-C₁₀ aryl, biaryl or a substituted biaryl, 5-15 membered heteroaryl, or —N═CR¹R², wherein the substituents are selected from the group consisting of halogeno, —CN, —NO₂, —O—(CH₂)—O—, —CO₂H and salts thereof, —OR¹⁰⁰, —CO₂R¹⁰⁰, —CONR¹⁰¹R¹⁰², —NR¹⁰¹R¹⁰², —NR¹⁰⁰SO₂R¹⁰⁰, —SO₂R¹⁰⁰, —SO₂NR¹⁰¹R¹⁰², C₁-C₆ alkyl, and C₃-C₁₀ heterocyclyl;
wherein R¹⁰⁰, R¹⁰¹ and R¹⁰² are each independently hydrogen, C₁-C₈ alkyl, or C₆-C₁₂ aryl; or R¹⁰¹ and R¹⁰² together with the nitrogen atom to which they are attached to form a 5-7 membered heterocycle;
wherein the alkyl group and the aryl group are each substituted by 1-3 halogen groups or 1-3 C₁-C₆ alkyl groups;
R¹ and R² are each independently phenyl or methyl;
X, Y and Z are each independently hydrogen or halogeno; and
R is hydrogen or C₁-C₆ alkyl or halogen-substituted alkyl.

29. The method according to claim 28, wherein the hypoxia-activated DNA alkylating agent prodrug is selected from the group consisting of compounds having a structure as shown in the following structural Formulae 6-12: 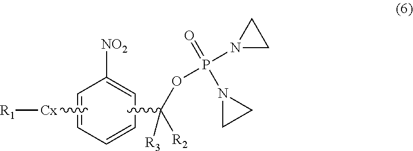
wherein the definitions of R₁, R₂, R₃ and Cx are as described in the claims of Patent Application PCT/CN2020/114519 with Publication No. WO2021120717A1;
or 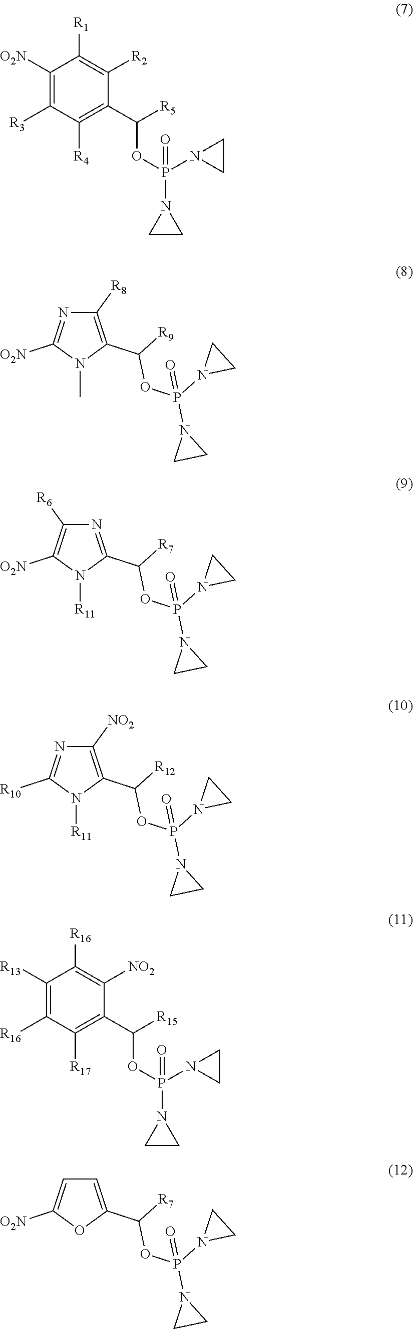
wherein the definitions of R₁, R₂, R₃, R₄, R₅, R₆, R₇, R₈, R₉, R₁₀, R₁₁, R₁₂, R₁₃, R₁₄, R₁₅, R₁₆ and R₁₇ are as described in the claims of Patent Application PCT/US2016/039092 with Publication No. WO2016210175A1 (corresponding to Chinese Patent Application No. 2016800368985 with Publication No. CN108024974A).
